(19) United States
(12) Patent Application Publication
(10) Pub. No.: US 2015/0365703 A1
(43) Pub. Date: Dec. 17, 2015

(54) SYSTEM AND METHOD FOR HIGHLY CONTENT ADAPTIVE QUALITY RESTORATION FILTERING FOR VIDEO CODING

(71) Applicants: Atul PURI, Redmond, WA (US); Daniel SOCEK, Miami, FL (US); Neelesh N. GOKHALE, Seattle, WA (US)

(72) Inventors: Atul PURI, Redmond, WA (US); Daniel SOCEK, Miami, FL (US); Neelesh N. GOKHALE, Seattle, WA (US)

(21) Appl. No.: 14/304,391

(22) Filed: Jun. 13, 2014

(51) Int. Cl. H04N 19/85; H04N 19/176; H04N 19/172; H04N 19/51; G06K 9/62; G06T 5/00

(52) U.S. Cl. CPC H04N 19/85; G06K 9/6267; G06T 5/001; H04N 19/172; H04N 19/51; H04N 19/176

(57) ABSTRACT

Techniques related to highly content adaptive quality restoration filtering for video coding.

### BACKGROUND

Due to ever increasing video resolutions, and rising expectations for high quality video images, a high demand exists for efficient image data compression of video while using limited bitrate or bandwidth required for coding with existing video coding standards such as H.264 or H.265/HEVC (High Efficiency Video Coding) standard. The aforementioned standards use expanded forms of traditional approaches to address the insufficient compression/quality problem, but the results are still limited.

One specific area that can use improvement is the quality of the reconstructed signal. Once a video signal (associated with frames of a video sequence) is reconstructed by de-quantization and inverse transform in a prediction loop at the encoder for example, commonly used devices to clean the reconstructed signal may include in-loop filtering such as a deblocking filter (DBF), a sample adaptive offset (SAO) filter, and an adaptive loop filter (ALF) that uses a wiener filter to compute filter coefficients. The HEVC standard incorporated SAO in the standard but does not generally incorporate ALF due to a number of reasons including difficulty in getting ALF to robustly provide consistent gains, and some of the functions of ALF can be achieved by SAO at a lower complexity. Even when ALF is used, the ALF does not provide superior matching of the reconstructed image to the original video image. This often results in a relatively lower quality prediction signal, which in turn generates a relatively large prediction error bit cost that occupies more of the bandwidth than would be needed with more efficient coding.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Furthermore, where considered appropriate, reference labels have been repeated among the figures to indicate corresponding or analogous elements. In the figures:

FIG. 1 is an illustrative diagram of an encoder for a video coding system;

FIG. 2 is an illustrative diagram of a decoder for a video coding system;

FIG. 3 is a flow chart showing an adaptive quality restoration filtering process for video coding;

FIG. 4 is a flow chart showing an example general process for adaptive quality restoration filtering;

FIGS. 5A-5H is a flow chart showing a process for adaptive quality restoration filtering for video coding at an encoder and for use without a code book;

FIG. 6 is a diagram of an adaptive quality restoration filter shape with an arrangement of filter coefficients;

FIG. 7 is a diagram of an example frame divided into regions;

FIG. 8 is a table to explain region-based and block-based iterations by merging regions for adaptive quality filtering;

FIG. 9 is a diagram of a frame divided into regions for a first block-region alternative combination for adaptive quality restoration filtering;

FIG. 10 is a diagram of another frame divided into regions for a second block-region alternative combination for adaptive quality restoration filtering;

FIG. 11 is a table of block classifications to be used with the second block-region alternative combination;

FIG. 12 is a diagram of another frame divided into regions for a third block-region alternative combination for adaptive quality restoration filtering;

FIG. 13 is a table of block classifications to be used with the third block-region alternative combination;

FIG. 14 is a diagram of another frame divided into regions for a fifth block-region alternative combination for adaptive quality restoration filtering;

FIG. 15 is a table of block classifications to be used with the fifth block-region alternative combination;

FIG. 16 is a table of block classifications to be used with a seventh block-region alternative combination;

FIGS. 17A-17L are variable length coding tables to explain encoding of filter coefficients with the adaptive quality restoration filtering herein;

FIGS. 18A-18B is a flow chart showing an adaptive quality restoration filtering process for a decoder and without the use of a code book;

FIGS. 19A-19H is a detailed flow chart showing an adaptive quality restoration filter process for use at an encoder and with the use of a code book;

FIGS. 20A-20B is a detailed flow chart showing an adaptive quality restoration filter process for use at a decoder and with the use of a code book;

FIG. 21 is an illustrative diagram of an example system in operation for providing a content adaptive quality restoration filter process;

FIG. 22 is an illustrative diagram of an example system;

FIG. 23 is an illustrative diagram of another example system; and

FIG. 24 illustrates another example device, all arranged in accordance with at least some implementations of the present disclosure.

### DETAILED DESCRIPTION

One or more implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Furthermore, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. In another form, a non-transitory article, such as a non-transitory computer readable medium, may be used with any of the examples mentioned above or other examples except that it does not include a transitory signal per se. It does include those elements other than a signal per se that may hold data temporarily in a “transitory” fashion such as RAM and so forth.

References in the specification to “one implementation”, “an implementation”, “an example implementation”, etc., indicate that the implementation described may include a particular feature, structure, or characteristic, but every implementation may not necessarily include the particular feature, structure, or characteristic. Moreover, such phrases are not necessarily referring to the same implementation. Furthermore, when a particular feature, structure, or characteristic is described in connection with an implementation, it is submitted that it is within the knowledge of one skilled in the art to effect such feature, structure, or characteristic in connection with other implementations whether or not explicitly described herein.

Systems, articles, and methods are described below related to highly content adaptive quality restoration filtering for video coding.

As mentioned above, one way to improve video coding is by extending HEVC and similar video coding standards to improve the quality of the reconstructed signal which in turn can help improve the quality of the prediction signal to achieve overall higher compression efficiency. Specifically, if decoded video quality can be improved further due to matched filtering in a coding loop, the improvement will not only improve reconstructed visual quality but also will have a feedback effect in improving quality of the prediction signal reducing the prediction error bit cost, thus improving the video compression efficiency/quality even further. In other words, the overall video compression efficiency in interframe video coding and the compression gains may be improved by filtering reconstructed video to try to better match the pixel data of the reconstructed video with input video to reduce the amount of residual data that must be coded.

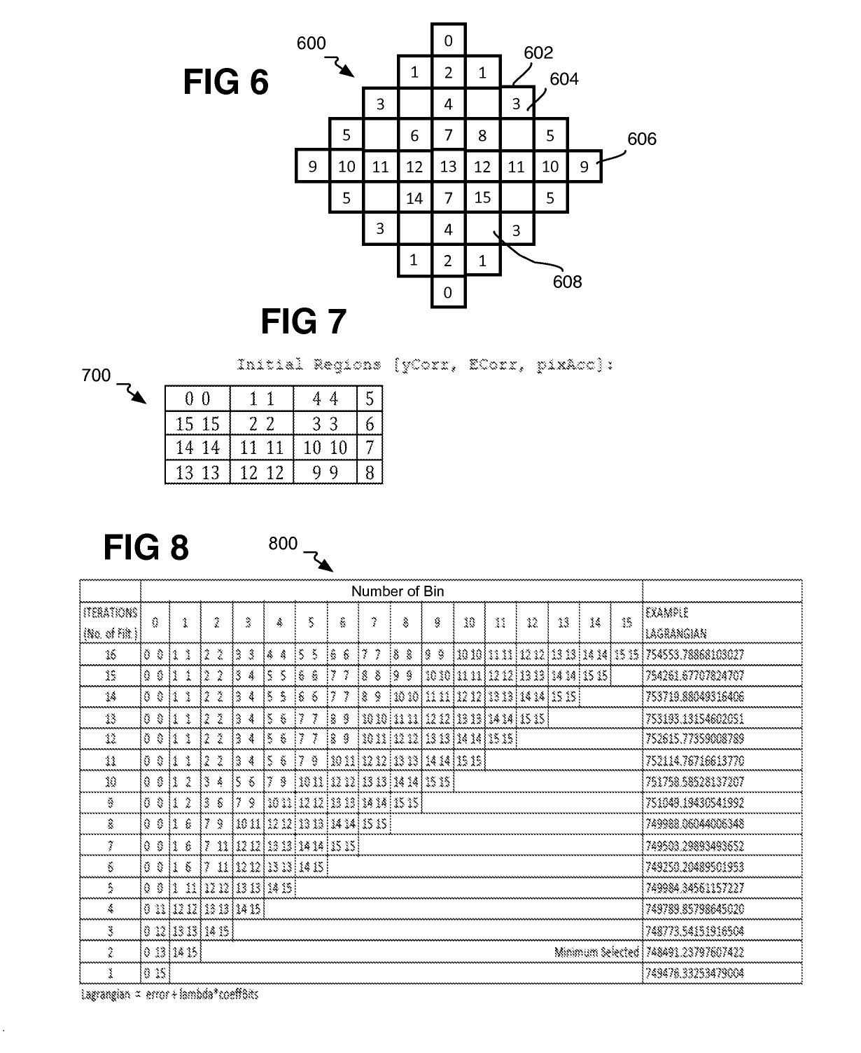

The Adaptive Quality Restoration (AQR) filtering approach described herein can provide better results than a HEVC HM7.1 approach since it uses a more effective filter shape that covers a larger filtering area without significant increase in complexity usually associated with use of large filtering shapes. Herein, depending on the context, the filter or the filter shape may refer to a pattern of filter coefficients (FIG. 6) that is placed over a pixel location (at the center of the filter shape for example) to modify the pixel values at that location. In one form, a filter (with fixed coefficient values) may only be used in a region or portion of a frame such that a frame may have a number of filters all with the same pattern but with different coefficient values in certain regions. By one example, the filter shape is made larger by the use of holes such that pixel locations within the filter shape have no coefficient value so that the outer dimensions of the pattern remain relatively large. Such filters may have both symmetric and non-symmetric coefficients as described below to reduce the number of different coefficients that are needed for the filter as well.

Another way to improve the efficiency of the AQR filter is to provide an adaptive filter that is adjustable depending on the content of the frames. Thus, in one form the filter coefficients are calculated independently for each frame and for different areas of the same frame referred to as local adaptation rather than having fixed filter coefficients for one or more entire frames. Two ways to determine filter coefficients based on local adaptation is by a region-based method and a block based method explained in greater detail below. Generally, in the region based method, a different filter is provided for each of a number of physically mapped regions forming a frame. A region may be sufficiently large to include a number of LCUs. Different iterations may be tested for minimum rate distortion where regions are combined, or more accurately share a filter. The region-based method, while very efficient bandwidth-wise, also can be too imprecise such that relatively large prediction errors may still be developed.

By another form, the block based-method provides a number of block classifications where each class indicates the amount of pixel value gradation within the block. A block may be as small as 4×4 or 8×8 pixels. As with the region-based method, iterations where blocks of different classes share the same filter are tested to determine which iteration is the best to use. The block-based method can be much more accurate than the region-based method but also much more bit-expensive. As of yet, no solution has been determined to balance these two methods until now. Herein, this disclosure presents a combination of region and block based methods to attempt to retain the best advantages of both methods. Thus, alternative block-region (BR) combinations or arrangements are tested for one or more frames to determine the best block-region combination for use as explained in detail below. By one form, the AQR filter approach combines the best of region and block filtering approaches into a single algorithm that may scale in range from being fully block adaptive to fully region adaptive, as well as providing combinations of block and regions as might be necessary for coding of some types of content. Thus, with this combination for region and block methods, the AQR filter is described as providing a highly content adaptive solution.

The AQR filtering approach herein also introduces efficient coding of filter coefficients associated with the slightly larger filter shape to attempt to ensure that the gains from the filter shape outweigh any additional cost of coding the filter shape. Assuming each frame of a video sequence may have up to sixteen different filters (though it can be much lower), each with ten filter coefficients to code, coding all of these filter coefficients may become bit-expensive so that efficient encoding is necessary. One way to improve the compression gains in these cases, by one approach, the AQR filter also uses an efficient encoding process that maintains high compression gains that easily offset the loss caused by coding multiple different filter coefficients for each frame. This is accomplished by providing optional, multiple variable length coding (VLC) tables where the code is shorter the more often a value is used as the filter coefficient value.

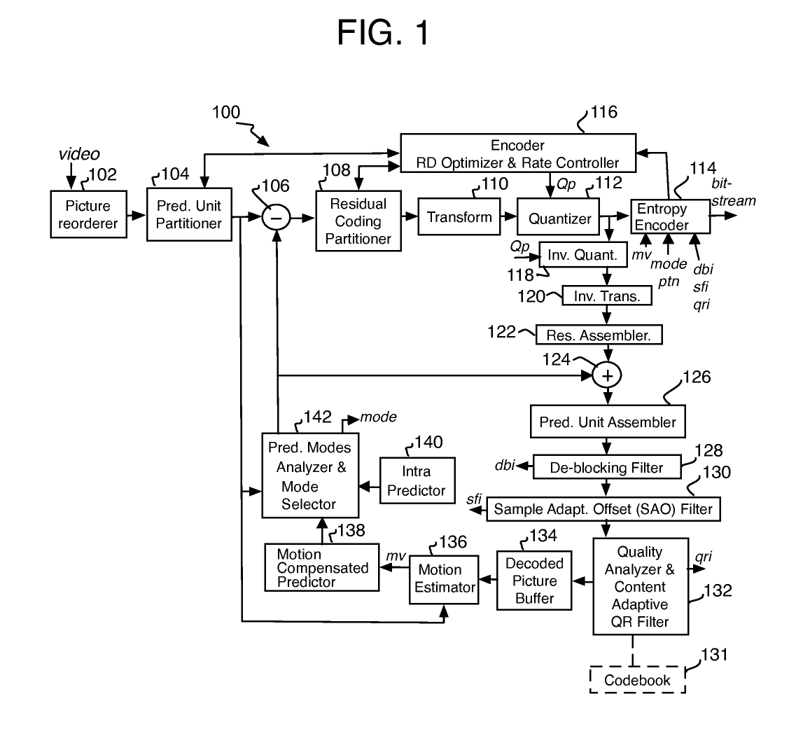

Now in more detail and while referring to FIG. 1, an example video coding system 100 is arranged with at least some implementations of the present disclosure to perform adaptive quality restoration filtering. In various implementations, video coding system 100 may be configured to undertake video coding and/or implement video codecs according to one or more standards mentioned above. Further, in various forms, video coding system 100 may be implemented as part of an image processor, video processor, and/or media processor and may undertake inter prediction, intra prediction, predictive coding, and/or residual prediction. In various implementations, system 100 may undertake video compression and decompression and/or implement video codecs according to one or more standards or specifications, such as, for example, the High Efficiency Video Coding (HEVC) standard (see ISO/IEC JTC/SC29/WG11 and ITU-T SG16 WP3, “High efficiency video coding (HEVC) text specification draft 8” (JCTVC-J1003 d7), July 2012), and HEVC HM 7.1. Although system 100 and/or other systems, schemes or processes may be described herein in the context of the HEVC standard, the present disclosure is not necessarily always limited to any particular video encoding standard or specification or extensions thereof.

As used herein, the term “coder” may refer to an encoder and/or a decoder. Similarly, as used herein, the term “coding” may refer to encoding via an encoder and/or decoding via a decoder. A coder, encoder, or decoder may have components of both an encoder and decoder.

In some examples, video coding system 100 may include additional items that have not been shown in FIG. 1 for the sake of clarity. For example, video coding system 100 may include a processor, a radio frequency-type (RF) transceiver, a display, and/or an antenna. Further, video coding system 100 may include additional items such as a speaker, a microphone, an accelerometer, memory, a router, network interface logic, and so forth, that have not been shown in FIG. 1 for the sake of clarity.

For the example video coding system 100, the system may be an encoder where current video information in the form of data related to a sequence of video frames may be received for compression. The system 100 may partition each frame into smaller more manageable units, and then compare the frames to a prediction. If a difference or residual is determined between an original frame and prediction, that resulting residual is transformed and quantized, and then entropy encoded and transmitted in a bitstream out to decoders. To perform these operations, the system 100 may include a picture reorderer 102, a prediction unit partitioner 104, a differencer 106, a residual partitioner 108, a transform unit 110, a quantizer 112, an entropy encoder 114, and a rate distortion optimizer (RDO) and/or rate controller 116 communicating and/or managing the different units. The controller 116 manages many aspects of encoding including rate distortion or scene characteristics based locally adaptive selection of right motion partition sizes, right coding partition size, best choice of prediction reference types, and best selection of modes as well as managing overall bitrate in case CBR (Constant Bit Rate) coding is enabled.

The output of the quantizer 112 may also be provided to a decoding loop 150 provided at the encoder to generate the same prediction as would be generated at the decoder. Thus, the decoding loop 150 uses de-quantization and inverse transform units 118 and 120 to reconstruct the frames, and residual assembler 122, adder 124, and prediction unit assembler 126 to reconstruct the units used within each frame. The decoding loop 150 then provides filters to increase the quality of the reconstructed images to better match the corresponding original frame. This may include a deblocking filter 128, a sample adaptive offset (SAO) filter 130, the adaptive quality restoration (AQR) filter 132 (and which is the subject of the details provided below), a decoded picture buffer 134, a motion estimation module 136, a motion compensation module 138, and an intra-frame prediction module 140. Both the motion compensation module 138 and intra-frame prediction module 140 provide predictions to a selector 142 that selects the best prediction mode for a particular frame. As shown in FIG. 1, the prediction output of the selector 142 in the form of a prediction frame or parts of a frame is then provided both to the subtractor 106 to generate a residual, and in the decoding loop to the adder 124 to add the prediction to the residual from the inverse quantization to reconstruct a frame.

More specifically, the video data in the form of frames may be provided to the picture reorderer 102. The reorderer 102 places frames in an input video sequence in the order in which they need to be coded. For example, reference frames are coded before the frame for which they are a reference. The picture reorderer may also assign frames a classification such as I-frame (intra coded), P-frame (inter-coded from a previous reference frame), and B-frame (bi-directional frame which can be coded from a previous frame, subsequent frame, or both). In each case, an entire frame may be classified the same or may have slices classified differently (thus, an I-frame may include I slices), and so forth. In I slices, spatial prediction is used, and in one form, only from data in the frame itself. In P slices, temporal (rather than spatial) prediction may be undertaken by estimating motion between frames. In B slices, two motion vectors, representing two motion estimates per partition unit (PU) (explained below) may be used for temporal prediction or motion estimation. In other words, for example, a B slice may be predicted from slices on frames from either the past, the future, or both relative to the B slice. In addition, motion may be estimated from multiple pictures occurring either in the past or in the future with regard to display order. In various implementations, motion may be estimated at the various coding unit (CU) or PU levels corresponding to the sizes mentioned above.

Specifically, when an HEVC standard is being used, the prediction partitioner unit 104 may divide the frames into prediction units. This may include using coding units (CU) (also called large coding units (LCU)). For this standard, a current frame may be partitioned for compression by coding partitioner 107 by division into one or more slices of coding tree blocks (e.g., 64×64 luma samples with corresponding chroma samples). Each coding tree block may also be divided into coding units (CU) in quad-tree split scheme. Further, each leaf CU on the quad-tree may be divided into partition units (PU) for motion-compensated prediction. In various implementations in accordance with the present disclosure, CUs may have various sizes including, but not limited to 64×64, 32×32, 16×16, and 8×8, while for a 2N×2N CU, the corresponding PUs may also have various sizes including, but not limited to, 2N×2N, 2N×N, N×2N, N×N, 2N×0.5N, 2N×1.5N, 0.5N×2N, and 1.5N×2N. It should be noted, however, that the foregoing are only example CU partition and PU partition shapes and sizes, the present disclosure not being limited to any particular CU partition and PU partition shapes and/or sizes.

As used herein, the term “block” may refer to a CU, or to a PU of video data for HEVC and the like, or otherwise a 4×4 or 8×8 or other shaped block. By some alternatives, this may include considering the block as a division of a macroblock of video or pixel data for H.264/AVC and the like, unless defined otherwise.

Also in video coding system 100, the current video frame divided into LCU, CU, and/or PU units may be provided to the motion estimation module or estimator 136. System 100 may process the current frame in the designated units of an image in raster scan order. When video coding system 100 is operated in inter-prediction mode, motion estimation module 136 may generate a motion vector in response to the current video frame and a reference video frame. The motion compensation module 138 may then use the reference video frame and the motion vector provided by motion estimation module 136 to generate a predicted frame.

The predicted frame may then be subtracted at subtractor 106 from the current frame, and the resulting residual is provided to the residual coding partitioner 108. Coding partitioner 108 may partition the residual into one or more geometric slices and or blocks, and by one form dividing CUs further into transform units (TU) for compression, and the result may be provided to a transform module 110. The relevant block or unit is transformed into coefficients using variable block size discrete cosine transform (VBS DCT) and/or 4×4 discrete sine transform (DST) to name a few examples. Using the quantization parameter (Qp) set by the controller 116, the quantizer 112 then uses lossy compression on the coefficients. The generated set of quantized transform coefficients may be reordered and entropy coded by entropy coding module 114 to generate a portion of a compressed bitstream (for example, a Network Abstraction Layer (NAL) bitstream) provided by video coding system 100. In various implementations, a bitstream provided by video coding system 100 may include entropy-encoded coefficients in addition to side information used to decode each block (e.g., prediction modes, quantization parameters, motion vector information, partition information, in-loop filtering information (deblocking info. (dbi), SAO filter info. (sfi), and AQR filter info. (qri)), and so forth), and may be provided to other systems and/or devices as described herein for transmission or storage.

The output of the quantization module 112 also may be provided to de-quantization unit 118 and inverse transform module 120. De-quantization unit 118 and inverse transform module 120 may implement the inverse of the operations undertaken by transform unit 110 and quantization module 112. A residual assembler unit 122 may then reconstruct the residual CUs from the TUs. The output of the residual assembler unit 122 then may be combined at adder 124 with the predicted frame to generate a rough reconstructed frame. A prediction unit assembler 126 then reconstructs the frame CUs from the PUs, and the LCUs from the CUs to complete the frame reconstruction.

The quality of the reconstructed frame is then made more precise by running the frame through the deblocking filter 128, the sample adaptive offset (SAO) filter 130, and quality analyzer and content adaptive quality restoration (AQR) filter 132 (referred to herein as the AQR filter). The deblocking filter 124 smooths block edges to remove visible blockiness that might be introduced while coding. The SAO filter 130 provides offsets to add to pixel values in order to adjust incorrect intensity shifts. The AQR filter 132 uses one or more sets or patterns of filter coefficients that when applied to decoded pixels of frames, slices, and/or blocks results in modifying them to be much closer to the corresponding pixels of the original frame, slice, and/or block data thereby providing a more accurate, higher quality decoded frame. This frame when used in coding loop for prediction next time around, produces a lower prediction error for coding of the subsequent frame, further improving its coding efficiency; this process repeats for each frame. By one form, the Quality Analyzer & AQR filter 132 analyzes decoded and original frames to compute coefficients for the AQR filter that create the best results, and the encoded coefficients are placed in the bitstream as qri (AQR information). The qri also may include filter block and/or region on/off maps, block and/or region merge maps, and so forth that may be needed by a decoder to reproduce and use the AQR filter. The AQR filter 132 may optionally use a codebook 131 to place shorter codebook indices in the bitstream rather than individual coefficient values. The decoder may have the same codebook to decode the indices to obtain coefficient value. The AQR filter is described in greater detail below.

The filtered frames are then provided to a decoded picture buffer 134 where the frames may be used as reference frames to construct a corresponding prediction frame for motion compensation as explained above. When video coding system 100 is operated in intra-prediction mode, intra-frame prediction module 140 may use the reconstructed frame to undertake intra-prediction schemes that will not to be described in greater detail herein.

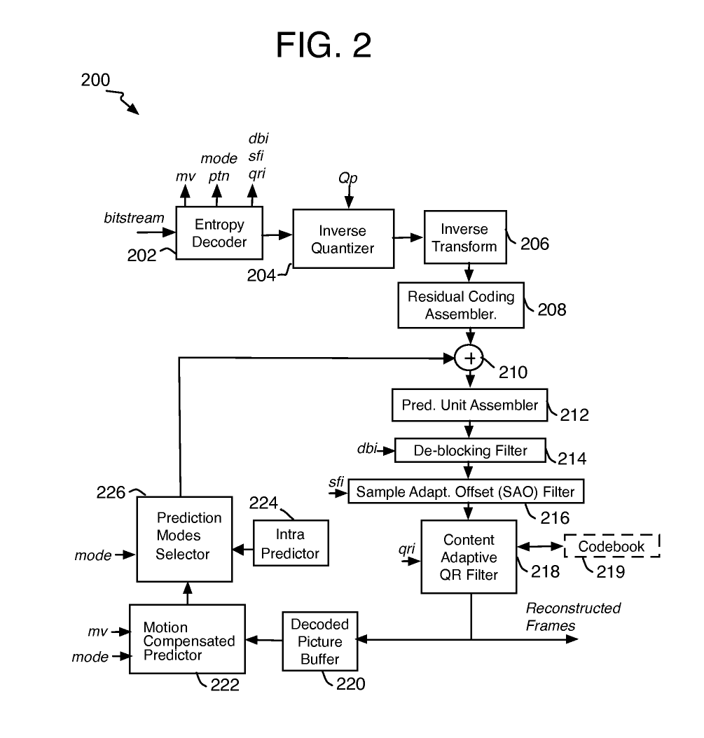

Referring to FIG. 2, a system 200 may have, or may be, a decoder, and may receive coded video data in the form of bitstream 202. The system 200 may process the bitstream with an entropy decoding module 204 to extract the pixel data and quantized residual coefficients as well as the motion vectors, prediction modes, partitions, quantization parameters, filter information (dbi, sfi, qri), and so forth. The system 200 may then use an inverse quantization module 204 and inverse transform module 206 to reconstruct the residual pixel data. The system 200 may then use a residual coding assembler 208, an adder 210 to add the residual to the predicted frame, and a prediction unit assembler 212. The system 200 also may decode the resulting data using a decoding loop employing, depending on the coding mode indicated in syntax of bitstream 202 and implemented via prediction mode selector (which also may be referred to as a syntax control module) 226, either a first path including an intra prediction module 224 or a second path including a deblocking filtering module 214, a sample adaptive offset filtering module 216, and a content adaptive quality restoration (AQR) module 218. The AQR filter 216 may use the coefficients from the encoder to reconstruct a filter pattern or shape, and then use the filter to modify the pixel values. Optionally, the bitstream may carry indices used to access a codebook 219 to obtain selected filter (coefficient-sets) from the codebook that correspond to AQR filter coefficient values. This second path may then include a decoded picture buffer to store the reconstructed and filtered frames for use as reference frames as well as send off the reconstructed frames for display or storage for later viewing. A motion compensated predictor 222 retrieves reconstructed frames from the decoded picture buffer 220 as well as motion vectors from the bitstream to reconstruct a predicted frame. A prediction modes selector sets the correct mode for each frame. The functionality of modules described herein for systems 100 and 200, except for the AQR filters 132 and 218 described in detail below, are well recognized in the art and will not be described in any greater detail herein.

For one example implementation, alternative block-region combinations are generated to determine the best combination to use, and in turn the best (or least) number of filters to use for a frame as follows.

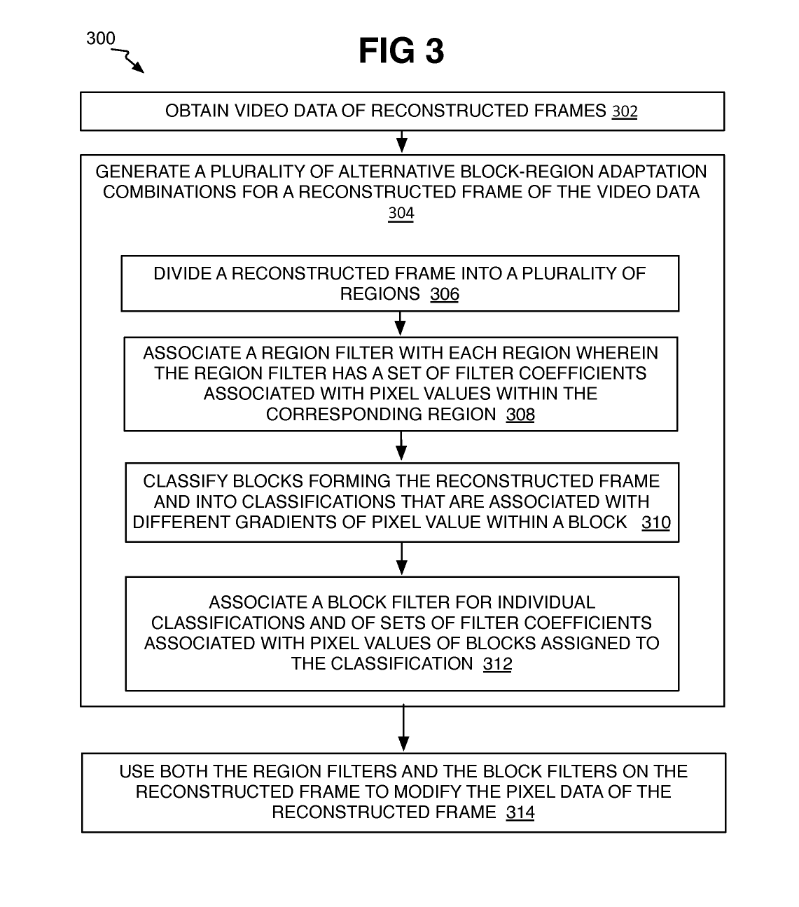

Referring to FIG. 3, a flow chart illustrates an example process 300, arranged in accordance with at least some implementations of the present disclosure. In general, process 300 may provide a computer-implemented method for highly content adaptive quality restoration for video coding as mentioned above. In the illustrated implementation, process 300 may include one or more operations, functions or actions as illustrated by one or more of operations 302 to 310 numbered evenly. By way of non-limiting example, process 300 will be described herein with reference to operations discussed with respect to FIGS. 1-2, above and may be discussed with regard to example systems 100, 200 or 2200 discussed below.

The process 300 may comprise “obtain video data of reconstructed frames” 302, and particularly via a decoding loop with de-quantization and in-loop filtering including the AQR filter by one example.

The process 300 also may comprise “generate a plurality of alternative block-region adaptation combinations for a reconstructed frame of the video data” 304. In other words, in order to generate block-region (BR) based combinations that provide a significant reduction in prediction residuals while minimizing resulting reduction in compression gains (or in other words, minimizing resulting rate distortion), it has been found that combining blocks of certain block classifications with certain region arrangements as described below generate the best results. By one example, regions are numerically labeled with a filter number in an order on the frame to generally minimize a jump in pixel value from region to adjacent region. The regions are also arranged to share a filter as mentioned below. FIG. 10 shows such an example arrangement of 16 regions with region filters numbered 0 to 11 on a frame 1000. Also, by example block-region combination 1000, only block activity classes 4 and 5 (classifications 12-15 of 16 classifications) may be combined with this region arrangement of FIG. 10 to form an advantageous combination that ultimately forms a more accurate reconstructed frame to reduce the residual between original and reconstructed frame while minimizing resulting rate distortion. This is described in greater detail below.

Thus, the block-region (BR) combination generation operation may include “divide a reconstructed frame into a plurality of regions” 306, and by on example 16 regions although other amounts be used. This operation also may include “associate a region filter with each region wherein the region filter has a set of filter coefficients associated with pixel values within the corresponding region” 308. Thus, by one form, each filter has coefficient values associated with pixel values in the region to which the filter is assigned. Also, this includes the situation where a single filter may be associated with multiple regions as explained below, and as long as a region is assigned a filter. This is referred to as merging the regions (where a single filter is shared among the merged regions), even though the regions may still be referred to or numbered separately.

The process 300 also may comprise “classify blocks forming the reconstructed frame and into classifications that are associated with different gradients of pixel value within a block” 310. This comprises determining, for individual blocks in the frame, a classification for the block among a plurality of classifications which indicate the amount of gradient of pixel values within the block. By one form there are 16 classifications, and by example frame 1000 mentioned above, only four of the classifications are used for this frame.

The process 300 also may comprise “associate a block filter for individual classifications and of sets of filter coefficients associated with pixel values of blocks assigned to the classification” 312. As with the region filters and regions, there may be a block filter associated with each block classification, and a single filter may be shared or associated with multiple classifications as explained below.

Process 300 also my include “use both the region filters and block filters on the reconstructed frame to modify the pixel data of the reconstructed frame” 314, and particularly to select the alternative BR combination (or iteration thereof considering different ways to merge the regions and block classifications) that results in the lowest rate distortion. The block filters and/or region filters of the selected BR combination (or iteration of the BR combination) may then be used to modify the pixel values of the reconstructed frame whether for prediction or other analysis purposes by the encoder, or for display of the frame or picture by a decoder for example.

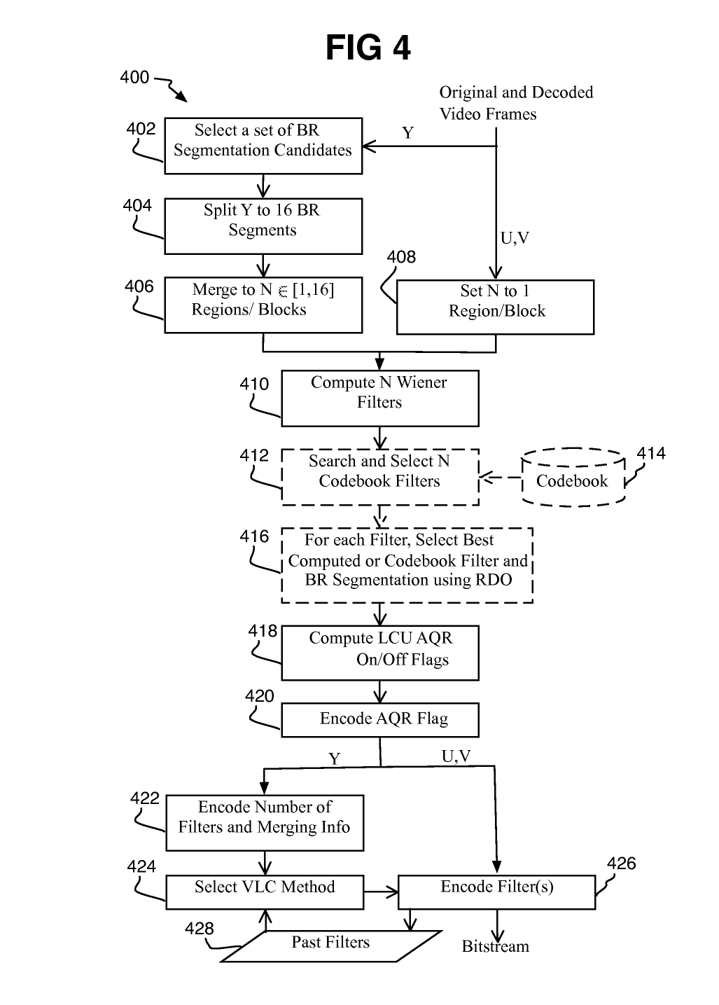

Referring now to FIG. 4, a flow chart illustrates an example encoding process 400, arranged in accordance with at least some implementations of the present disclosure. In general, process 400 may provide another computer-implemented method for highly content adaptive quality restoration filtering for video coding. In the illustrated implementation, process 400 may include one or more operations, functions or actions as illustrated by one or more of operations 402 to 428 numbered evenly. By way of non-limiting example, process 400 will be described herein with reference to operations discussed with respect to FIGS. 1-3 and 5-17, and may be discussed with reference to example systems 100, 200 and/or 2200 discussed below.

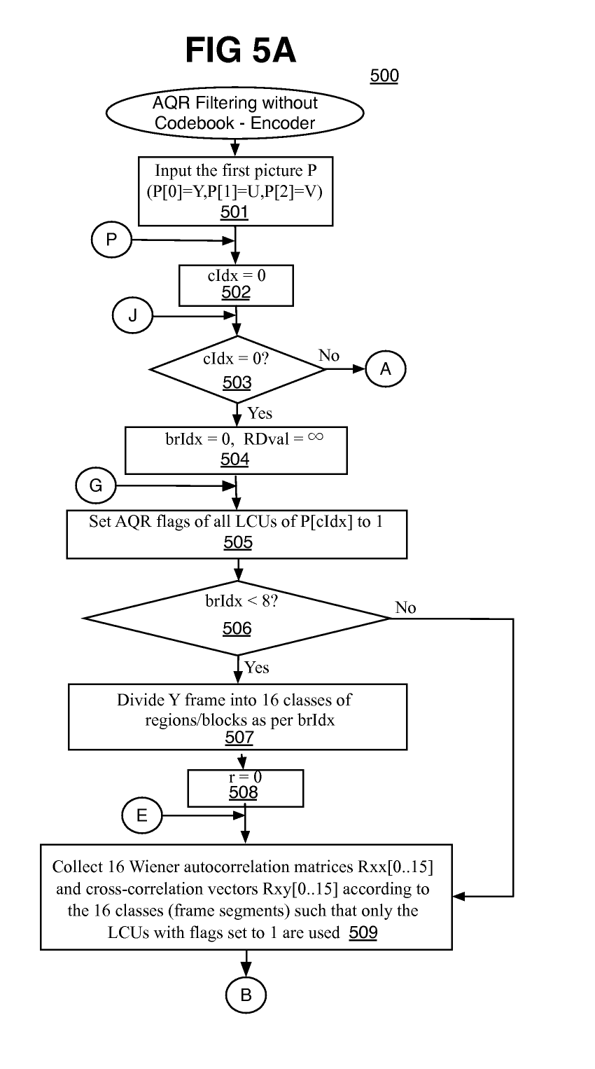

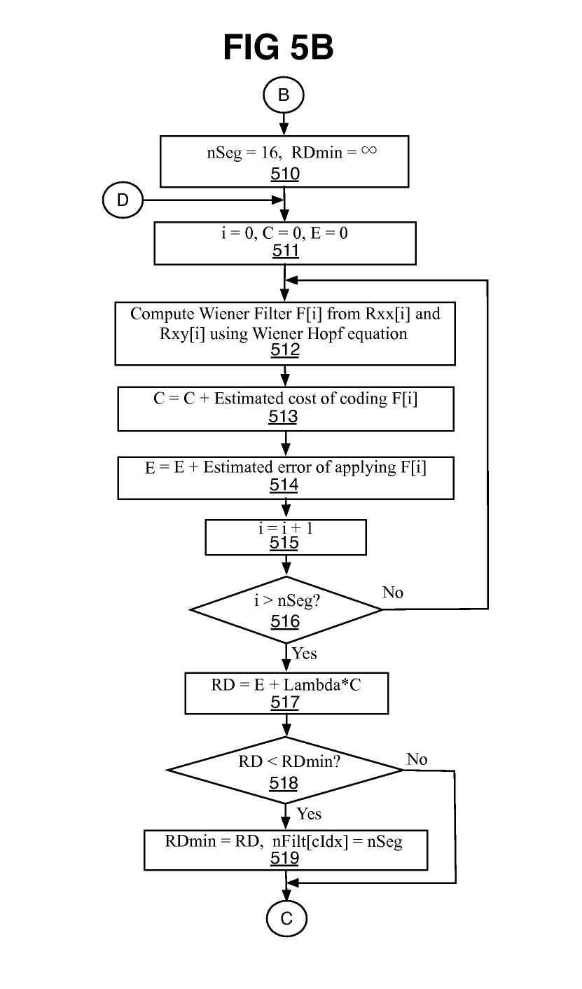

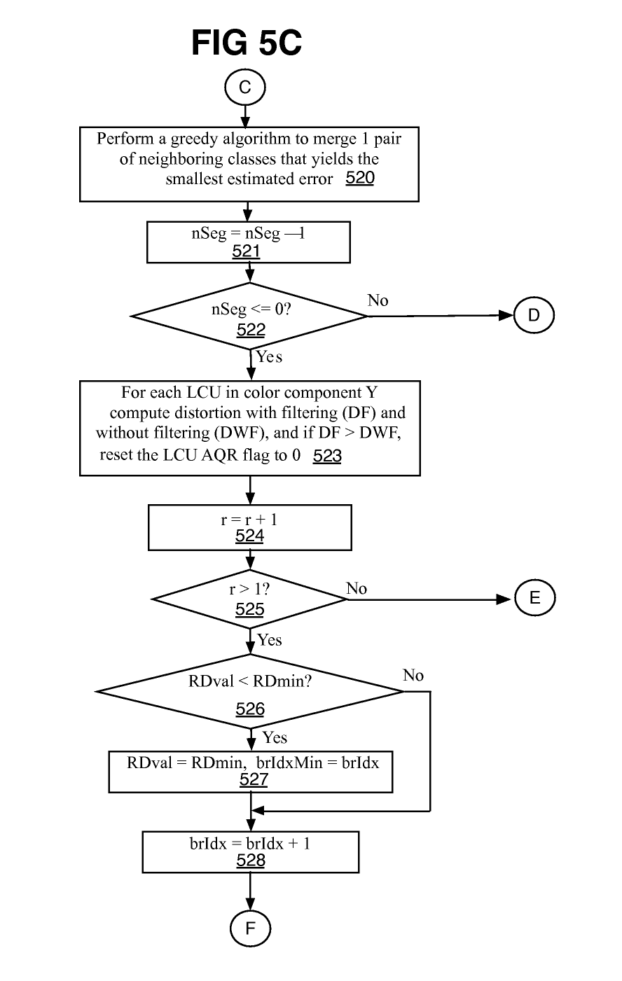

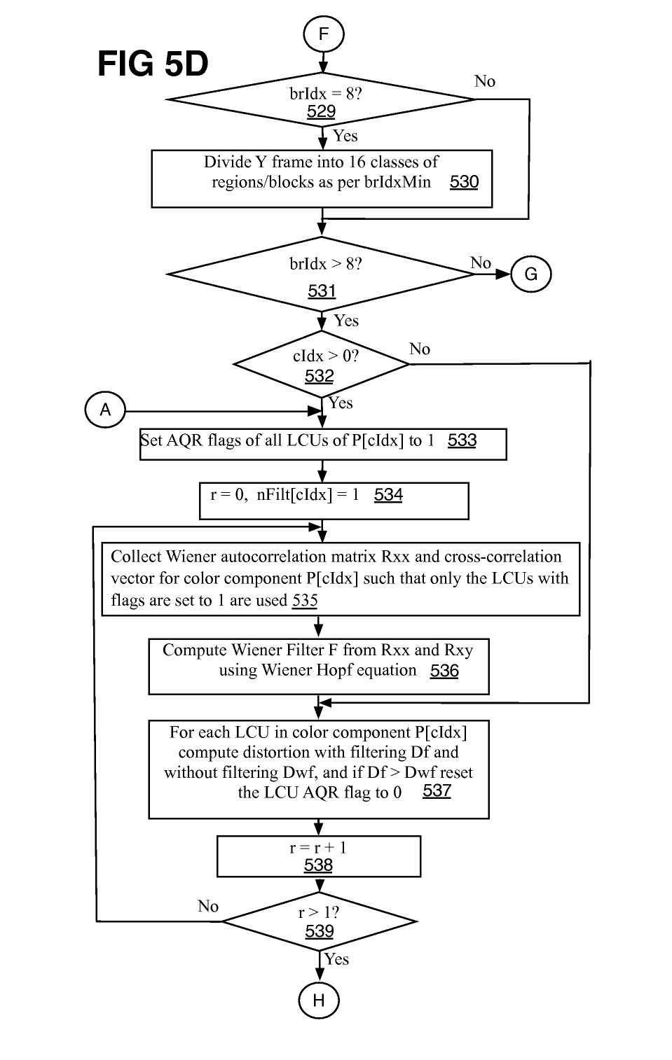

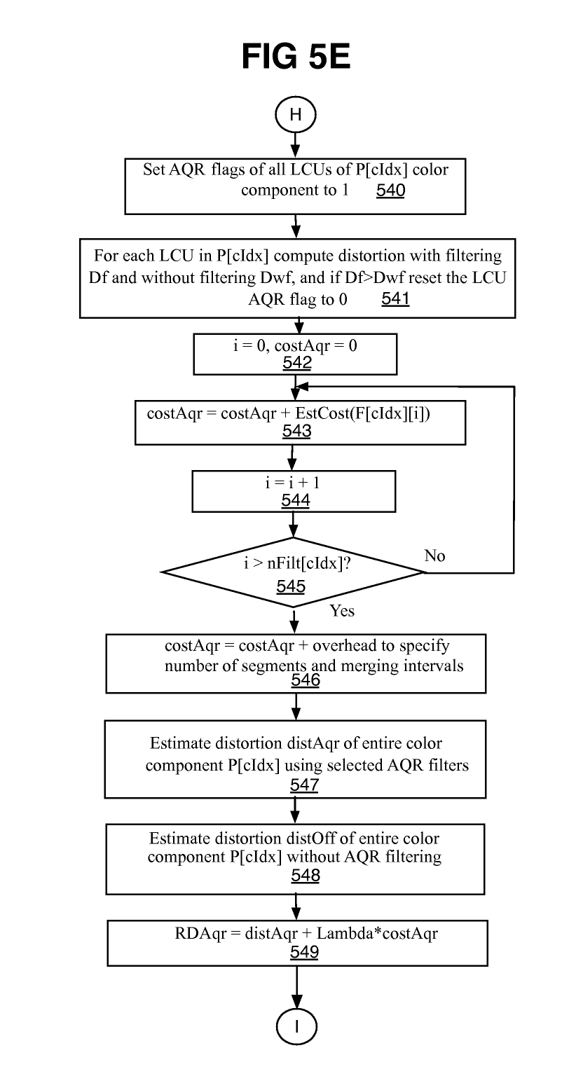

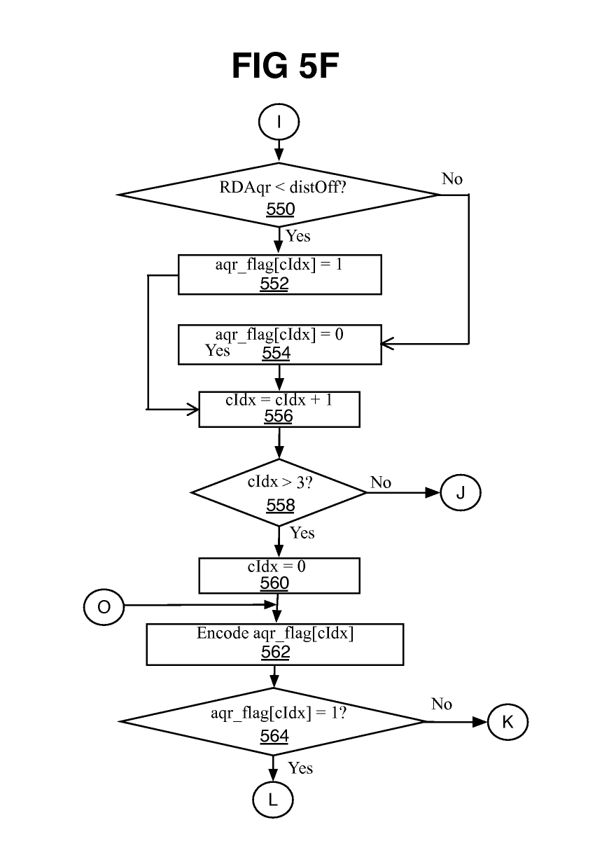

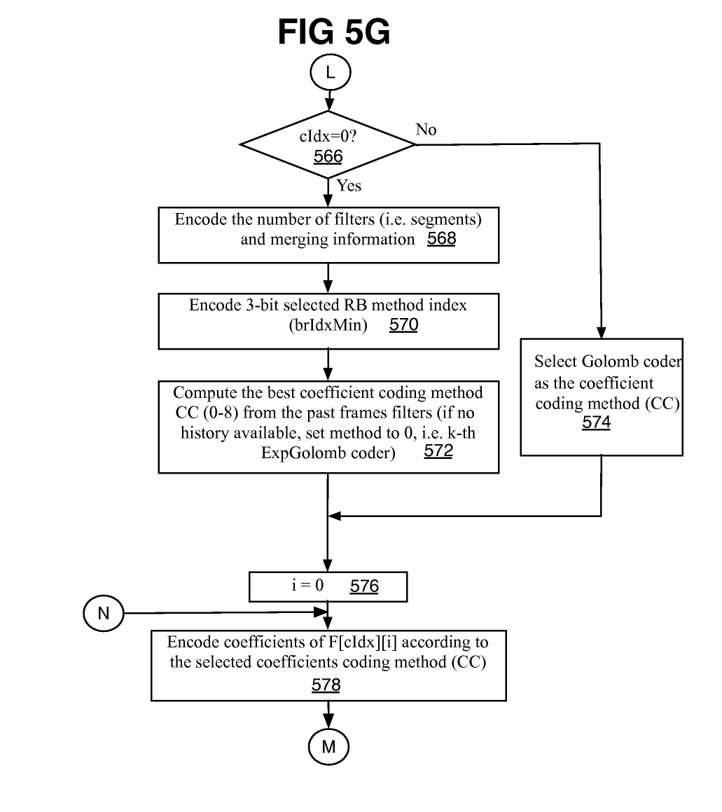

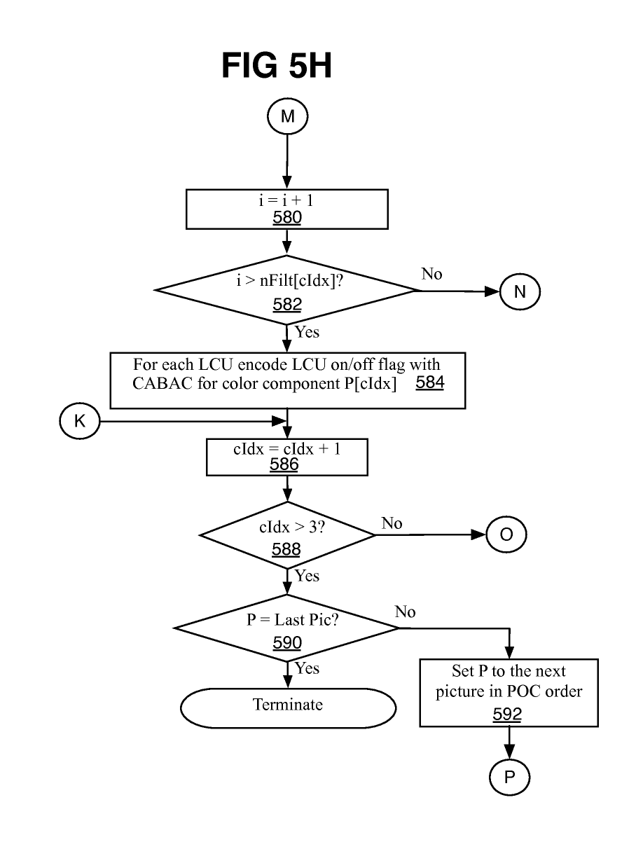

The process 400 may first include receiving an original video (or data therefore) and in one form reconstructed frames in a decoding loop, and then using the luma or Y pixel data to “select a set of BR Segmentation Candidates” 402. This derivation/selection of the candidate may be based on lowest distortion, least number of bits, best rate distortion tradeoff, best matching to current frame image (activity or objects) or so forth. For the process shown in FIG. 4, once the best BR segmentation candidate is established, best filter(s) corresponding to each region or block in BR is computed by comparing the current decoded Y frame with the current original Y frame. This filter computation for instance may for example use wiener filtering or not, specific filter shape, specific arrangement of symmetrical or nonsymmetrical coefficients in this filter shape, specific precision of each filter coefficient in this shape, and so forth. Selection of this filter may also depend on best content adaptation, best rate distortion tradeoff or others. In the alternative process 500 described below (FIG. 5), there is no initial selection of the best BR combination from given candidates, and all of the BR combinations are tested for rate distortion tradeoffs to determine the best BR segmentation arrangement.

Thereafter, the Y frame is split into a certain amount of regions, and block classes, and in one example, this may be to 16 segments (each segment may be a region, or block class) 404 although other amounts may be used. The BR segments (regions, or block classes) are then merged 406 to N filters, or more specifically, it is determined which regions, or block classes are to share a filter, which in turn indicates how many filters N will be used on the frame. This may be 1 to 16 filters. By one approach, 16 different iterations are tested where each iteration has one additional merger until each iteration with one to sixteen filters are tested.

Regions can merge with neighboring regions along the Peano or Hilbert scan or other space filling curve scan that converts 2D space to 1D space while keeping maximum correlation. Likewise, a block class can merge with a neighboring block class based on a combination of activity classes (where 6 levels are defined herein), and in for the active classes, additionally based on orientation (horizontal, vertical, or none) as described below. In each iteration or iteration of merging, a new set of wiener filters are computed for the resulting reduced number of regions and/or block classes, and Rate/Distortion tradeoff (RD) value is computed for each iteration, and in one case, until all merging possibilities are exhausted including merging of the last remaining region and block classes. The merging solution that offers the least RD value from the 16 iterations is deemed to be the winning BR segmentation solution for the luma (Y) frame to be filtered; this process is repeated for every coded frame. The calculation of rate R (bits) involves adding up bit cost of coding of coefficients of a filter times number of filters depending on the merging iteration. The distortion D can be computed as absolute value of difference signal of decoded frame and the filtered decoded frame; an alternate formulation may use square of error of this difference signal.

For U and V, the U and V values are processed per usual with only one filter for each color component for an entire frame. N is set to 1 (408).

The process 400 may then include computing 410 N Wiener filters, described in detail below, and is a computation to derive the filter coefficients for each of the filters that are to be used. The process 400 then may optionally include search and select 412 N codebook filters from a codebook 414 (or 131 as mentioned earlier). The codebook includes filters (sets of filter coefficients for example) obtained in test cases using test video sequences with various characteristics (sharpness, contrast, motion, and so forth) and having the same filter shape and size as that used herein although the codebook may have multiple filter shapes and sizes to choose from. By one approach, each filter may correspond to a single 8-bit binary code eliminating the need to transmit the 16 coefficients for the present example filter pattern 600 herein. Stored codebook filters may be selected for potential use by comparing the codebook filter coefficients to frame pixel data where the filter will be used (the corresponding region for example) using sum of absolute differences (SAD) and/or mean square error (MSE) methods for example. For each filter selected, both the computed filter and the filter from the codebook are both analyzed using rate distortion optimization (RDO) analysis, and the filter with the lower rate distortion is selected 416 for use. However, each filter is then compared on an LCU by LCU basis (or other block basis) to determine if the rate distortion is better than not using an AQR filter at all. An on/off flag is computed 418 depending on the selection of whether to use an AQR filter or not. An adaptive quality restoration (AQR) flag (aqr_cbook_flag) is set when the codebook option is available, and is not set when the codebook is not an option (and in this case the AQR filter BR frames are used, or not).

Process 400 then may include an operation to encode 420 the AQR flag (as well as the aqr_cbook_aqr flag), and for the luma Y component, the number of filters as well as the merging information is encoded 422. A variable length coding (VLC) method is selected 424 based on past filters 428 to then encode the filters for all three components (Y, U, V). The VLC method uses alternative tables of binary VLCs for encoding the filter coefficients and by having the shortest codes used for the most frequent coefficient values in order to maintain or reduce compression gains despite encoding multiple AQR filters for a single frame.

Referring to FIGS. 5A-5H, now in even more detail, a flow chart illustrates an example process 500, arranged in accordance with at least some implementations of the present disclosure. In general, process 500 may provide a computer-implemented method for highly content adaptive quality restoration for video coding as mentioned above. In the illustrated implementation, process 500 may include one or more operations, functions or actions as illustrated by one or more of operations 501 to 592 numbered as shown on FIGS. 5A-5H. By way of non-limiting example, process 500 will be described herein with reference to operations discussed with respect to FIGS. 1-2 and 6-17 and may be discussed with regard to example systems 100, 200 or 2200 discussed below.

Process 500 is directed to a process of AQR filtering without a codebook and for an encoder. By one approach, a first picture (frame or image) P[cIdx] is input 501 where the components index cIdx are designated as 0=luma Y, 1, =chroma U, and 2=chroma V. Various ones of the operations 503 to 558 are repeated for each component. Once the analysis and coding is complete for each component, then the process will encode the collected data, and then moves to the next frame or picture until the last frame in the sequence is reached (operations 590 and 592).

The process 500 may include checking 503 the component index cIdx to see if it is zero. If so, the luma Y values are to be analyzed. If not, the process continues with chroma U or V analysis at operation 533. Continuing with the Y values, a block-region (BR) combination counter index brIdx is set (504) to 0, and a rate distortion value Dval is set to infinity. The AQR flags of all LCUs of the current frame of Y values P[cIdx] is set 505 to one. Each flag will indicate whether rate distortion is better with or without using the AQR filter. A check 506 is made to determine whether the maximum number of BR combinations has been reached, here whether BrIdx is less than eight (referring to eight available alternative BR combinations). If so, the Y frame is divided 507 into 16 regions and block classifications, and assigned a filter number individually or to be shared, according to the current BR combination being analyzed. The selected BR combination is an initial block classification and region arrangement for a Y frame that is then subsequently modified to optimize (or more accurately by one example, minimize) rate distortion as explained below.

Specifically, in order to understand BR combinations, the filter shape, block-based adaptation and region-based adaptation should be understood first. While referring to FIG. 6, a filter 600 here refers to a set of filter coefficients arranged in a specific pattern, and that may be used to analyze each region and block in a frame. A more advanced filter 600 is used which is able to cover a larger area around the filtered pixel (center pixel C13) and generally is able to further reduce the error (prediction residual). In the illustrated example, the filter 600 is a subset of a 9×9 area of a frame with 33-taps (coefficients or samples) here formed in a diamond shape. The filter 600 may be formed of a 9×9 cross, a 3×3 rectangle (where the rectangle corners are added to the cross), and diagonals connecting the corners of the diamond and forming the outer edges of the diamond. Each square 602 with a number is a tap or coefficient location 604 and that corresponds to pixel location as the filter is overlaid and traversed across a frame of pixel data. As mentioned there are 33 taps. The taps are partially symmetric, and in one form described as point symmetric about the center point. In other words, coefficients (or taps) C0, C2, C4, and C7 are vertically symmetric about center point C13, coefficients C9 to C12 are horizontally symmetric about point C13, and diagonal edge coefficients C1, C3, and C5 are diagonally symmetric about point 13, and each of these three coefficients are used four times as shown. The symmetric locations have the same coefficient values (for example, both C5's have the same value) so that only one of the symmetric values needs to be coded. The filter 600 also may be partially non-symmetric at least at the rectangle corners C6, C8, C14, and C15 and center C13. Thus, for this example, the filter only has sixteen unique coefficients to be coded with 33 taps.

The filter shape also is enlarged by placing holes within the pattern. A hole here generally is referred to as a square or pixel location or space 608 without a coefficient but that has adjacent coefficients on all four sides of the space (above, below, to the right, and to the left). Using a full square or diamond of 9×9 coefficients for example may be much more accurate but the bit load cost is too great. Other known patterns that simply use the cross and small rectangle are too small and are often inaccurate. The enlargement with holes and symmetric and non-symmetric coefficients provides a compromise that factors in a relatively large number of coefficients to obtain an accurate pixel value for the center pixel value at the C13 location.

By one form, the center C13 has a positive value of 0 to 511 (in luma or chroma value), but other examples may exist, such as 0 to 1023. The non-center coefficients may have positive and negative values from −256 to 255. This is discussed in greater detail below with regard to encoding of the filter coefficients.

Referring to FIG. 10, as mentioned, region-based adaptation (RA) is one form of local adaptation. With Region-based adaptation, a frame is partitioned into multiple non-overlapping regions, and at least originally, one local filter was applied to each region. Herein, regions are combined to determine which regions, if any, can share the same filter. RA utilizes the high correlation between neighboring pixels to make an assumption that filter coefficients of neighboring pixels, in neighboring regions, are similar and can be shared to save the filter coefficient rates. This adaptation is suitable for one picture with apparent structure and repetitive patterns in one local region. For example, one picture is composed of blue sky in the upper part, gray buildings in the middle part, and green grass in the lower part. The regions may generally track the content in the picture but the priority is to form regions that are the same size. Thus, in one example, a frame 1000 is divided into regions, and here 16 regions for example, that are roughly the same in size. The regions may be sized an exact multiples of LCUs so that the LCUs boundaries also form the boundaries of the regions. By one form, when it is not possible to have all regions the same size, an end row or column of regions may have slightly less or more area than the other regions. Otherwise, the regions may slightly differ in size due to content in the image for example. Many alternatives exist.

On example frame 1000, the regions are ordered so that one region relative to the physically adjacent numerically numbered region does not have too large of a jump in pixel values such as might occur by numbering the regions in raster-like order from the end of one frame row to the start of the next row. Thus, in this case, frame 1000 shows one example ordering of the initial 16 regions in a 2D image. This can be viewed as a particular space-filling curve which maps 4×4 2D data into a 16 point 1D data following numerically through the frame in this example. It will be understood that the frame may be divided up into many different numbers of regions.

Also on frame 1000, depending on the context, the numbers in the regions may be filter numbers, and the duplication of numbers within the frames (such as two filter 5s as shown) indicates that two regions share a filter (filter 5) and these regions are considered combined or merged. Specifically, while in RA each region can have one filter, depending on a bit budget, sometimes neighboring regions should share a filter for efficiency when the separate filters would not be significantly different. On the encoder side, a region merging algorithm can find the best grouping of regions by trying different versions of merging neighbors based on an RDO process described below. In one extreme, all regions share one filter; in the other extreme, each region has its own filter. The mapping of the filters for transmission to a decoder is described below as well.

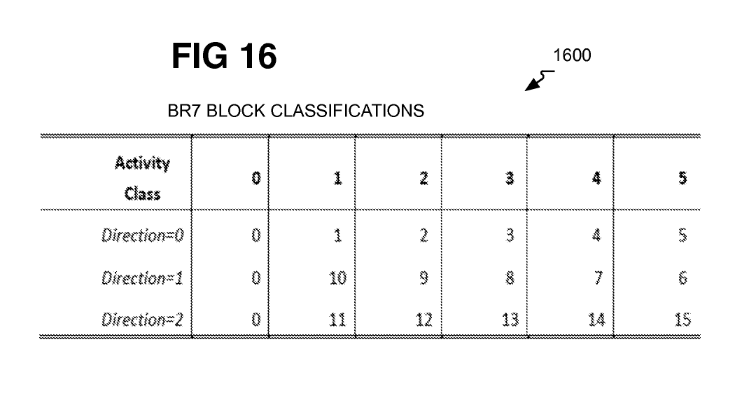

Referring to FIG. 16, in block-based adaptation, the block adaptive mode classifies 4×4 blocks into 16 classifications according to local orientation and iteration using Laplacian block activity and direction information. In other words, Laplacian equations are used to determine the pixel value gradient (for whichever cIdx component (here luma Y)) within a block and the direction of the gradation. As shown in table 1600, the amount of gradation within the 16 classifications is grouped into six activity classes (0 to 5) and direction where direction=0 is horizontal, direction=1 is vertical and direction=2 refers to no dominant direction.

Laplacian activity and direction information is computed using pixels within each 4×4 blocks as follows.

$$\begin{matrix}Ver ( i , j ) = abs ( 2 t ( i , j ) - t ( i , j - 1 ) - t ( i , j + 1 ) ) & ( 1 ) \\ Hor ( i , j ) = abs ( 2 t ( i , j ) - t ( i - 1 , j ) - t ( i + 1 , j ) ) & ( 2 ) \\ {H}_{4 \times 4} = {\sum }_{j = 1}^{2} {\sum }_{i = 1}^{2} Hor ( i , j ) & ( 3 ) \\ {V}_{4 \times 4} = {\sum }_{j = 1}^{2} {\sum }_{i = 1}^{2} Ver ( i , j ) & ( 4 )\end{matrix}$$

where (i, j) are the pixels within the block. Then, a 2-D Laplacian activity is computed by adding V_{4×4} and H_{4×4}, and quantizing that output into six activity classes (i.e., 0-5). As mentioned, direction is classified into one of three categories: no direction (0), horizontal direction (1), and vertical direction (2) as follows.

If H_{4×4}≧2V_{4×4}, direction is 1.

If V_{4×4}≧2H_{4×4}, direction is 2.

Otherwise, direction is 0.

Based on the 2-D Laplacian activity class and direction, the block based class is derived by using Table 1600, which results in 16 classes in BA (note that the classification is 0 for 0 activity class regardless of direction). These equations may apply to a number of different block sizes as well such as 8×8 blocks, or other blocks by one example, as long as the blocks are smaller than the regions by one form.

Referring to FIGS. 7-8, now that regions and block classifications are understood, the block-region based alternative combinations can be explained. For Luma, one goal of the blocks-regions (BR) method is to partition a picture into multiple non-overlapping segments (which can be a region or a block classification) and for each segment, one filter is applied such that the rate distortion (RD) is minimal. Starting with 16 segments (16 filters for 16 regions for example), a greedy algorithm decreases the number of segments (and filters) down to one, thereby finding the sub-optimal number of segments (i.e. filters) for the picture. In other words, a number of region variations (or iterations) are formed by combining two of the regions to share a filter with each iteration so that the first region iteration has all 16 filters, then the next iteration has a merger forming 15 filters, then the next iteration keeps the previous merger and adds another one for a total of 14 filters, and so on. The best region iteration is the one with the lowest rate distortion. FIGS. 7-8 provide one example of the region iteration process and is described in greater detail below along with the explanation of process 500.

This same procedure also may be applied to the block classifications where block iterations 16 to 1 are tested where each iteration has different merger of classifications where two or more classifications may share the same filter until a single filter is shared by all of the classifications, and a block iteration with the least rate distortion may be selected for use. The different region iterations are then used to combine with certain block classifications to form the final BR combination arrangement that may be used for coding.

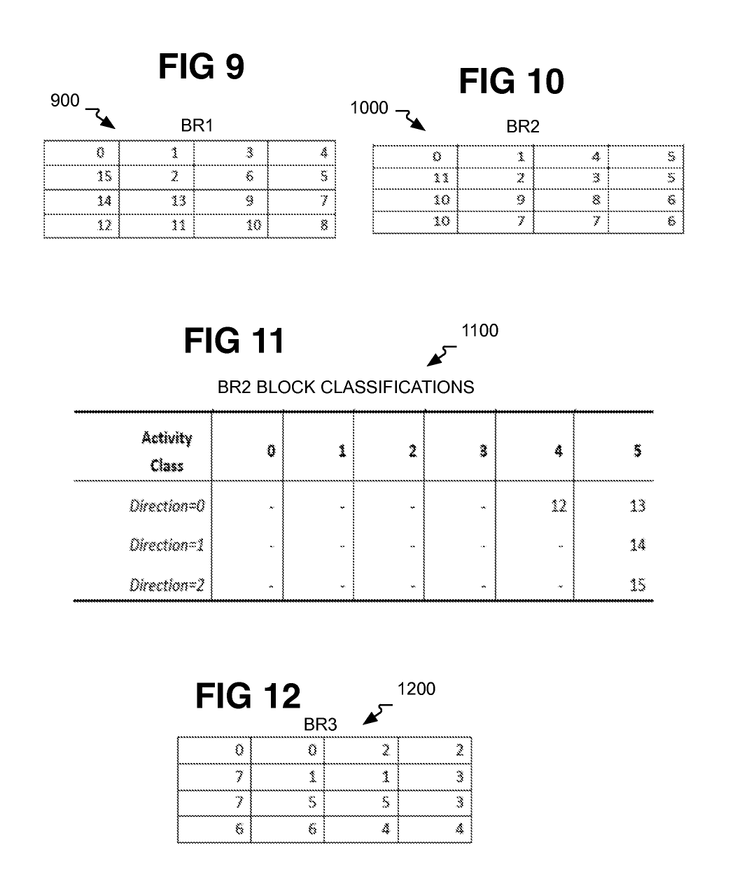

Referring to FIGS. 9-16, the illustrated example provides eight different alternative BR combinations that each provide a different arrangement of regions. These BR combinations provide the initial arrangement for regions and block classifications that are modified by merging regions and block classifications to share filters to determine a block-region arrangement with a minimum rate distortion for use among all of the BR combinations and iterations. The following are the initial BR combinations.

A video frame 900 (FIG. 9) with a first BR combination (BR1) uses 16 regions numbered 0 to 15 with one different filter for each region, and where the regions are numbered. The regions, and in turn the region filters, are numbered in an order so that the difference in pixel values between neighboring regions may be minimized as discussed above. In this BR combination, frame 900 is segmented into regions only (no block classes are used). Further, for this BR combination, the final number of regions used for a frame will not necessarily be 16 (the number 16 only represents the maximum number of regions possible), but in fact may be any number between 1 and 16 due to merging, and may vary from frame-to-frame, bitrate-to-bitrate, and from content-to-content.

A second combination (BR2) (FIG. 10) uses a region arrangement as mentioned above, and on a frame 1000 with 16 regions except here the 5, 6, 7, and 10 regions are merged so that only 12 region filters are used and numbered 0 to 11. Referring to FIG. 11, four block classifications (12-15) are used for frame 1000 as shown on table 1100. The block data is used to fill openings formed in the region data forming frame 1000. In other words, the region data at the location of the block data is replaced by the block data. By one example, the blocks are 4×4, such as blocks 1002 with one of the block classifications such as block classification 14 shown in random locations for exemplary purposes. While complete adjacent continuous regions may form a frame, frame 1000 shows this case where the regions have holes or openings, such as say 4×4 openings, as blocks of chosen classes are removed from these regions (or more accurately removed from the region calculations), such that the blocks 1002 that fill these openings are considered separately for filter computations. Also, by one form, the BR combinations each may have a total of the number of regions plus the number of block classifications that is equal to a fixed number, such as 16, and this is the same for each of the BR combinations in this example. The total number 16 (12 regions and 4 block classes) offers a reasonable tradeoff between desired flexibility in partitioning of a frame, the complexity it incurs as a number of merging iterations become larger, and the extra bit cost vs quality gains benefits. Further, this BR combination, the final number of regions and block classes used for a frame will not necessarily be respectively 12 and 4, and that these numbers only represent the largest number respectively of regions or block classes possible.

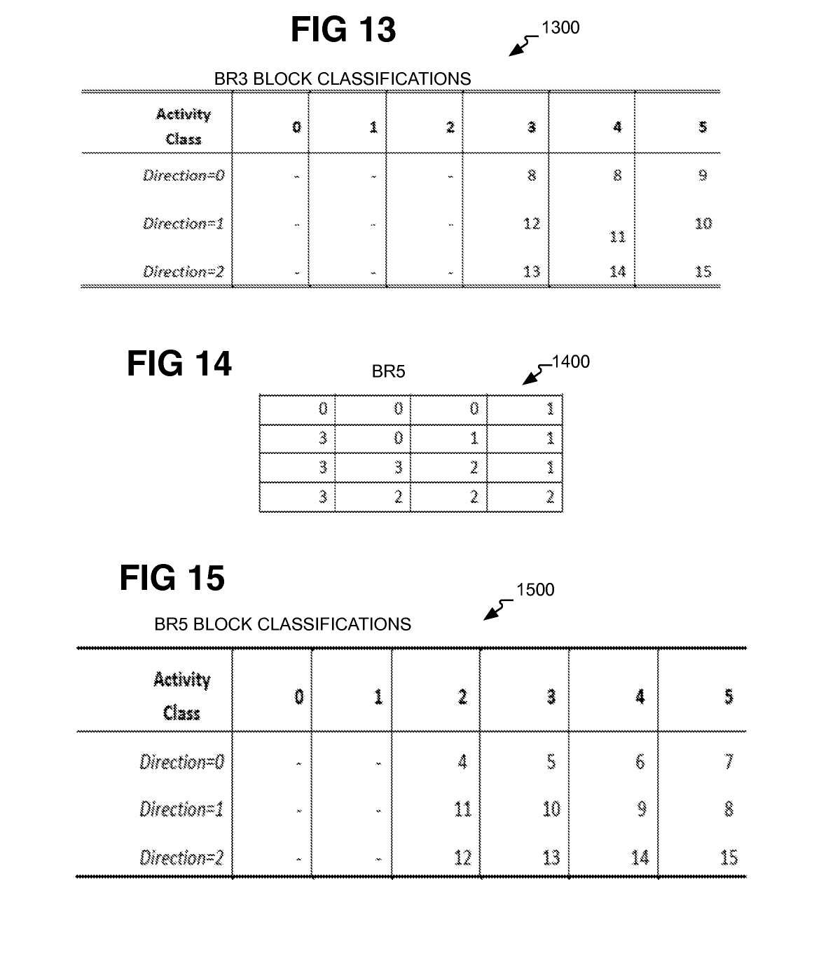

Referring to FIGS. 12-13, a third BR combination (BR3) has a frame 1200 with 16 regions where each of the regions is merged with one other region so that only eight different region filters (0 to 7) are used. In this case, referring to table 1300, only eight block classifications are used for frame 1200, this time in the three most active activity classes 3-5. Here one of the classifications has been merged so that activity classes 3 and 4 share filter/classification 8 for direction=0 as shown on table 1300. Thus, the block filters (or classifications used) are 8 to 15 for nine classifications (rather than 7 to 15). As mentioned, the regions are not solid areas but areas with openings, where openings represent cut outs of blocks of certain classes. Also, eight regions (filters) plus eight block classes (filters) totals 16 for BR3. As indicated earlier, the final number of regions and block classes may not be 8 and 8, but rather for each of regions or block classes, it may be a different number between 1 and 8.

A fourth BR combination (BR4) is the same as BR3 except that 8×8 blocks are used instead of 4×4 blocks. It will be understood that other options exist for the size of block that may be used as may found to be efficient. Otherwise, the earlier features regarding regions not being solid but rather with cutouts or openings, and the number of regions and block classes being maximum allowed values, still applies.

Referring to FIGS. 14-15, a fifth BR combination (BR5) is presented with a frame 1400 with 16 regions where only four different region filters are used (0 to 3). Each region filter is shared by four regions, and the regions/filters are numbered to maintain the numerical ordering to avoid large pixel value jumps region to region as mentioned above. Also in this BR combination, 12 block classifications (4 to 15) in activity classes 2-5 (omitting the lower activity classes 0-1) are used as shown on table 1500. Further as discussed, regions may not be solid but have holes or openings cut out of them of the size of blocks that correspond to the classes of blocks considered. Also as discussed, the final number of regions and block classes may not be 4 and 12, rather these numbers indicate the maximum possible regions or block classes so actual number of regions may be between 1 and 4, and actual number of bock classes between 1 and 12.

A sixth BR combination (BR6) is the same as BR5 except that 8×8 blocks are used instead of 4×4 blocks. It will be appreciated other block sizes may be used for any of the examples herein as well. As mentioned earlier, regions may not be solid but rather have cutouts that form openings or holes, and the number of regions and block classes are maximum allowed values.

Referring to FIG. 16, in a seventh BR combination (BR7), regions are not used, and only the block classifications are used, and in one form classifications 0 to 15 classified in activity classes 0 to 5 are used and as shown in table 1600. The final number of block classes very well may be less than 16 due to merging as indicated earlier. As mentioned above, activity class 0 is the same for all directions 0-2, and the remaining classifications are numbered in a traversing manner as shown on Table 1600.

In an eighth BR combination (BR8), the BR combination is the same as BR7 except that 8×8 blocks are used instead of 4×4 blocks. As earlier, block classes here may only be the maximum number of block classes that are permitted for this BR combination.

It will be understood that while these alternative BR combinations are found to be most efficient, many other combinations may be used whether more or less than eight combinations, and combinations with different region and block arrangements as that described herein. For instance, if the content is less complex (for instance head and shoulder video conferencing type of content), to reduce computational complexity and reduce overhead, less than 8 combinations may be used. Further, if the content includes combinations of large amounts of detailed and flat regions, and higher bitrates can be tolerated, larger than 8 combinations may be desirable.

Returning to process 500 now, “divide the Y frame into 16 classes of regions/blocks as per brIdx” 507 refers to establishing the BR combination being analyzed by dividing the frame into the 16 regions, establishing the region filters according to the BR combination arrangement being analyzed, and establishing the block classifications to be used with the BR combination according to the initial BR combination parameters. By the illustrated example, these are the BR combination arrangements provided by frames/tables 900 to 1600 (FIGS. 9 to 16).

A two-pass counter r is set (508) to zero to provide an initial pass where all LCUs are included in the calculation to establish filter coefficient values, while a subsequent pass will compute revised filter coefficient values by more accurately omitting those LCUs that are less rate distortive without filtering (and therefore, better off without the filtering). The process 500 then includes collecting (509) 16 Wiener autocorrelation matrices Rₓₓ [0 . . . 15] and cross-correlation vectors Rₓ, [0 . . . 15] according to the 16 classes (frame segments or regions) such that only the LCUs with flags set to 1 are used. On the first pass, all LCUs of the Y (or U or V) frame are set to 1 (operation 505).

With regard to the matrices being established for the Wiener filter, according to the basic theory of adaptive filtering, cross-correlation and autocorrelation matrices are accumulated, from which the optimal Wiener filter can be computed by solving the Wiener Hopf equation as follows.

Let x(n) be the input signal (the pixel data of the reconstructed frame before filtering), y(n) be the output (the pixel data of the reconstructed frame after filtering), d(n) be the original frame data, h(n) represent filter coefficients, and n is the location of a sample in one dimensional space (this formulation was originally intended for one dimensional signals, while images are two dimensional so the equations are a generalization although the concepts still apply). Then, the filter output is:

$$y ( n ) = {\sum }_{k = 0}^{N - 1} h ( k ) x ( n - k ) \qquad ( 5 )$$

the error signal is:

e(n)=d(n)−y(n) (6)

the mean Square Error:

J=E[e²(n)] (7)

In vector form:

$$\begin{matrix}x ( n ) = [ \begin{matrix}x ( n ) \\ x ( n - 1 ) \\ ⋮ \\ x ( n - N + 1 )\end{matrix} ] \\ and & ( 8 ) \\ h = [ \begin{matrix}h ( 0 ) \\ h ( 1 ) \\ ⋮ \\ h ( N - 1 )\end{matrix} ] & ( 9 ) \\ y ( n ) = {h}^{T} x ( n ) = {x ( n )}^{T} h & ( 10 ) \\ \begin{matrix}E [ {e}^{2} ( n ) ] = E [ {( d ( n ) - y ( n ) )}^{2} ] & \\ = E [ {d}^{2} ( n ) ] - 2 E [ d ( n ) {x ( n )}^{T} ] h + & ( 12 ) \\ {h}^{T} E [ x ( n ) {x ( n )}^{T} ] h & \\ = {P}_{d} - 2 {R}_{dx}^{T} h + {h}^{T} {R}_{xx} h & ( 13 ) \end{matrix} & ( 11 )\end{matrix}$$

where, P_{d} is a scalar, and Crosscorrelation row vector is:

R_{dx}=E[d(n)x(n)^{T}] (14)

Autocorrelation matrix:

Rₓₓ=E[x(n)x(n)^{T}] (15)

Each matrix is derived from a collection of samples (again while intended for 1 dimensional signals, in generalized case for 2D images, a collection of samples may mean a slice, a frame, a region, or a block class). To find the minimum error, the derivative is taken and set to zero as follows:

$$\frac{\partial E [ {e}^{2} ( n ) ]}{\partial h ( k )} = - 2 {R}_{dx}^{T} + 2 {R}_{xx} h = 0 \qquad ( 16 )$$

Solving for h, the Wiener Hopf equation is as follows:

h=Rₓₓ⁻¹R_{dx} (17)

The Wiener Hopf equation determines optimum filter coefficients in mean square error, and the resulting filter may be called the ‘wiener’ filter. In the above equation, h is the vector of filter coefficients, Rₓₓ is the autocorrelation matrix (or block data of reference frame) and R_{dx} is a cross-correlation matrix/row vector (between the source frame and reference frame block data).

Here, the operation of forming and collecting the Wiener matrices refers to having one set of matrices (Rₓₓ and R_{dx}) for each of the 16 potential regions (or segments or bins) for filter F[i].

Thereafter, nSeg is set (510) to 16 to count down the 16 segments (or regions) or bins, and a rate distortion minimum (RDmin) is set to infinity. A segment counter i is set (511) to 0, a total estimated cost C is set to 0, and a total estimated error E is set to 0. Then, process 500 includes compute 512 Wiener filter F[i] from Rxx[i] and Rxy[i] using Wiener Hopf equation (as explained above). This will set the filter coefficients for the Filter F[i] for the particular nSeg being analyzed.

Once the filter coefficients are set, the process 500 continues with adding 513 the estimated cost of coding F[i] to C. Thus, the total bits and the bits needed to encode the filter coefficients are counted and totaled, and added to C. Similarly, the estimated error of applying F[i] is added 514 to error E. The error E is the difference between the reconstructed pixel data after filtering and the original data. The i counter is then ticked up by one (515) and is checked 516 to determine whether i is greater than nSeg to test whether the last region or segment has been reached for the Y frame. Total rate distortion (RD) for the Y frame (including all filter F[i] for the Y frame) is then calculated 517 by:

RD=E+Lambda*C (18)

where Lambda=1.5× [symbol] _{mode} and λ_{mode}=α*Wₖ*2^{((QP-12)/3.0)} which depends on Wₖ a weighting factor that depends on encoding configuration and picture type (e.g. 0.57 for I-frame, 0.442 for B-frames at hierarchy 0 etc.), the quantization parameter Qp, and α parameter, and where:

$$α = \{ \begin{matrix}1.0 - Clip 3 ( 0.0 , 0.5 , 0.05 * number\_of \_B \_frames ) \\ 1.0\end{matrix} \qquad ( 18 a )$$

where the value of 1.0 is used for non-reference frames, and a value of 1.0—Clip3(..) used for reference frames. The process 500 then includes determining 518 whether RD<RDmin to see if RD is the minimum RD computed so far. If so, RD is set (519) as RDmin, and nFilt[cIdx] is set as nSeg (as the minimum filter for the Y frame) where nFilt[cIdx] is the total number of filters for the (Y, U, or V) frame.

It will be understood that RD for a frame actually includes adding the RD from region filters and block filters together. This is explained in more detail as follows.

Referring to FIG. 7, frame 700 is provided as an example frame divided into 16 regions (4×4), and show a start region or LCU filter number and an end region or LCU filter number. Thus, one region has 0 0, another 1 1, showing the same number at start and end, and that the region is not merged. Regions 5, 6, 7, and 8 are also similar (not merged) but since they are smaller in size due to being border regions for example, for ease of viewing they do not show both start and end region or LCU filter numbers. On FIG. 7, yCorr refers to cross correlation vector, ECorr refers to autocorrelation matrix, and pixAcc refers to accumulated values of pixels (for say average computation). The regions are also ordered for minimal pixel value change from region to region as explained for other frames herein.

Referring to FIG. 8, the process 500 then may include perform 520 a greedy algorithm to merge one pair of neighboring classes that yields the smallest estimated error. An example merger variation (or iteration) table 800 includes iteration numbers (corresponding to nSeg) for the row and corresponding to the number of filters used in that row (16 to 1), and a bin (corresponding to a filter label number) for each column corresponding to filter F[i]. Each square within the table shows the starting and ending region (or LCU of the two regions listed together, also referred to as classes on FIG. 5) that share the same filter and are therefore merged. For example, row 16 merely shows 16 filters are used, one for each region. For bin (or filter label number) 15 when 16 region filters are used, this region filter 15 is used starting and ending in region/LCU 15. For iteration 1, one filter (filter 0) is used for all of the regions 0 to 15. Iteration 5 has one merger at bin (or filter) 3, where bin or filter 3 is used starting at region 3 and ending at region 4 so that a total of 15 filters are used. Iteration 14 has two mergers at bins 3 and 7, and so forth. Once the error and bit cost (coefficient bits or coeffbits) are computed, and rate distortion (or Lagrangian) is calculated for each iteration (or row) as shown on table 800. The table is computed, or more accurately a similar table is computed, twice, once for region based filters and once for block based filters. While it appears that this would result in higher computations, in reality it is not, as sum of all regions and block class combinations is kept as 16 (the same number used in pure region based filter computation). The resulting RDs (block and region) for the same frame are then added together for each iteration. After all 16 iterations are complete, the minimum rate distortion, and corresponding region and block arrangement, can be selected as the best candidate for use for region and block filters. Alternatively, the region and block classification merger iteration and RDs may be calculated separately, and the two best candidate iterations (one region-based the other block-based) are then added together to form a final RD for each frame.

With regard to the specific alternative BR combinations, by one form, instead of always calculating rate distortion totals for iterations with 16 to 1 filters, each preset BR combination, such as illustrated BR combinations BR1 to BR8, will act as a threshold or initial arrangement where the BR combination sets the maximum number and placement of shared region and block filters. In this case, the system will test iterations with mergers that start at the maximum number provided by the BR combination and work down from that point to one filter shared by the whole frame for region and block filters. For example, BR2 (FIGS. 12-13) uses eight region filters (0 to 7 with one merger for each filter). The iterative process will start with 8 filters and then increment downward to one filter calculating rate distortion for each iteration along the way down to one filter shared by the entire frame. This process will be similar for initial eight block classifications for BR2. The rate distortion will be determined for each iteration from eight to one block classifications.

Returning to process 500, once a pair of classes or regions has been merged, nSeg is set as nSeg−1 (521) to analyze the next iteration, and it is determined 522 whether nSeg<=0 yet. If not, the process returns to operation 511 to analyze the next segment or iteration, and repeats operations 511 to 521 to determine the rate distortion for each iteration similar to that of table 800. If so, then it is determined whether a filter should be used at all. Thus, for each LCU in color component Y, compute 523 distortion with filter (DF) and distortion without filtering (DWF), and if DF>DWF, then reset the LCU AQR flag to 0 (which indicates that filtering should be omitted for that LCU).

The process 500 then up-ticks (524) two-pass counter r by one, and it is determined whether r>1 (525). If not, operations 509 to 522 are repeated, and filter coefficients are now calculated only using the LCUs that are improved by the filtering (see operation 509). If r is greater than one, process 500 then determines 526 whether the current rate distortion value RDval<RDmin. If so, RDval is set (527) to RDmin, and brIdxMin is set to brIdx to indicate the current BR combination (or a iteration thereof) has the minimum rate distortion. If not, this operation is skipped. Either way, the process 500 continues with setting 528 brIdx to brIdx+1 to analyze the next alternative BR combination. It is determined if the last BR combination (BR8 or other maximum BR number) has been reached (529). If so, the Y frame is divided 530 into sixteen block classes as per brIdxMin. Whether BrIdx is the maximum number or not, the process 500 continues with check to see if BrIdx is greater than the maximum number (here 8). If not, the process repeats operations 505 to 520 with the next BR combination. If so, the process checks if the color component is complete.

Specifically, if so, the process then checks 532 whether cIdx>0 (whether Y, U, or V data is being analyzed). If U or V is being analyzed, then the AQR flags are set 533 of all LCUs of P[cIdx] to 1, r counter is set 534 to 0, and nFilt[cIdx] is set to 1. The Wiener matrices are collected 535 for P[cIdx] to use only the LCUs with flags set to 1, and the Wiener filter F is computed 536 using the Wiener Hopf equation. Whether the component being analyzed is Y, U, or V, the process merges again and the DF and DWF are compared 537 to determine if an LCU AQR flag should be set to 0 to omit filtering. The counter r is set to r+1 (538), and checked (539) whether r>1. If not, the process performs the Wiener equations again with only LCUs set to 1 (omitting the ones set to 0). If r>1 is true, then AQR flags of all LCUs of P[cIdx] color component are reset 540 to 1 again, and distortion DF and DWF are compared where any LCU with DF>DWF has its flag set (541) to 0.

Thereafter, counter i is set (542) to 0, and total bit cost for the frame costAqr is set to 0 as well. Total bit costAqr is computed 543 by adding the EstCost(F[cIdx][i]) to costAqr which is the bit cost of the ith Filter for component cIdx (a component can be luma Y, or chroma such as U or V). Counter i is set (544) to i+1, and then checked 545 to see if nFilt[cIdx] is greater than i. If not, the process loops back to operation 543 to add in the distortion of the next filter to costAqr. If so, costAqr is set 546 to costAqr plus the overhead used to specify the number of segments and merging intervals. An estimate of distortion distAqr of the entire color component P[cIdx] is computed 547 using the AQR filters, and an estimate of distortion distOff of the entire color component P[cIdx] without AQR filtering is computed 548. A rate distortion RDAqr is computed by adding distAqr to Lamda times costAqr (549). RDAqr is then checked against DistOff (550). If RDAqr (total distortion considering bit cost) is less than distOff, an aqr_flag[cIdx] for the frame and component [cIdx] is set (552) to 1 (to use the filter for that (Y, U, or V) frame. If not, the aqr_flag[cIdx] is set 554 to 0 (so the filter is not used for that frame with the color component). Either way, the process 500 continues with setting 556 cIdx to cIdx+1, and then checking 558 whether cIdx is greater than 3. If not, the process 500 loops back to operation 503 to perform the analysis for the next color component (U or V for example). If so, cIdx is set 560 to 0 to begin encoding the data from each color component of the frame being analyzed.

The aqr_flag[cIdx] of the frame is encoded 162, and then checked to see if it equals 1 and filtering is enabled (564). If not, the process 500 skips the encoding for this color component, and continues with operation 586 to move to the next color component for encoding. If so (and filtering is enabled for this component on this frame, then it is determined if the current component is Y (cIdx=0?) 566. If the component is chroma U or V (cIdx=1 or 2), a golomb coder is selected 574 as the filter coefficient coding (CC) method for U or V frames, and in one form, as with HM7.1 HEVC.

If the Y frame is the current frame, the number of segments (or filters) and merging information for the frame is encoded 568. To derive the relation between multiple filters and regions, the mapping information between regions and filters should be signaled to the decoder. A syntax element related to the number of filters is signaled first. This syntax element indicates one of three cases: one filter, two filters, or more than two filters that are used. By one example, a frame may have regions 0 to 15 that uses five filters (or merged regions) that are numbered (labeled) 0 to 4. Thus, by one possible example for the regions 0 to 15, regions 0 to 3 use filter 0, regions 4-5 use filter 1, regions 6-10 use filter 2, regions 11-12 use filter 3, and regions 13-15 use filter 4. In this example, where there are 16 classes/regions and five distinct filters, the mapping between those can be described as [0,0,0,0,1,1,2,2,2,2,2,3,3,4,4,4], and it can be coded using differential pulse-code modulation (DPCM) coding as [0,0,0,0,1,0,1,0,0,0,0,1,0,1,0,0]. Note that this mapping information is not needed when one filter or two filters are used for whole frames. When one filter is used, all regions must be merged, so no merging information has to be coded. When two filters are used, the index where the second filter starts to apply is sent. Then, a 3-bit BR combination selection (brIdxMin) is encoded 570 to indicate which alternative BR combination, of the eight herein or other set of preset BR combination is to be used as the basis for determining iterations for a frame.

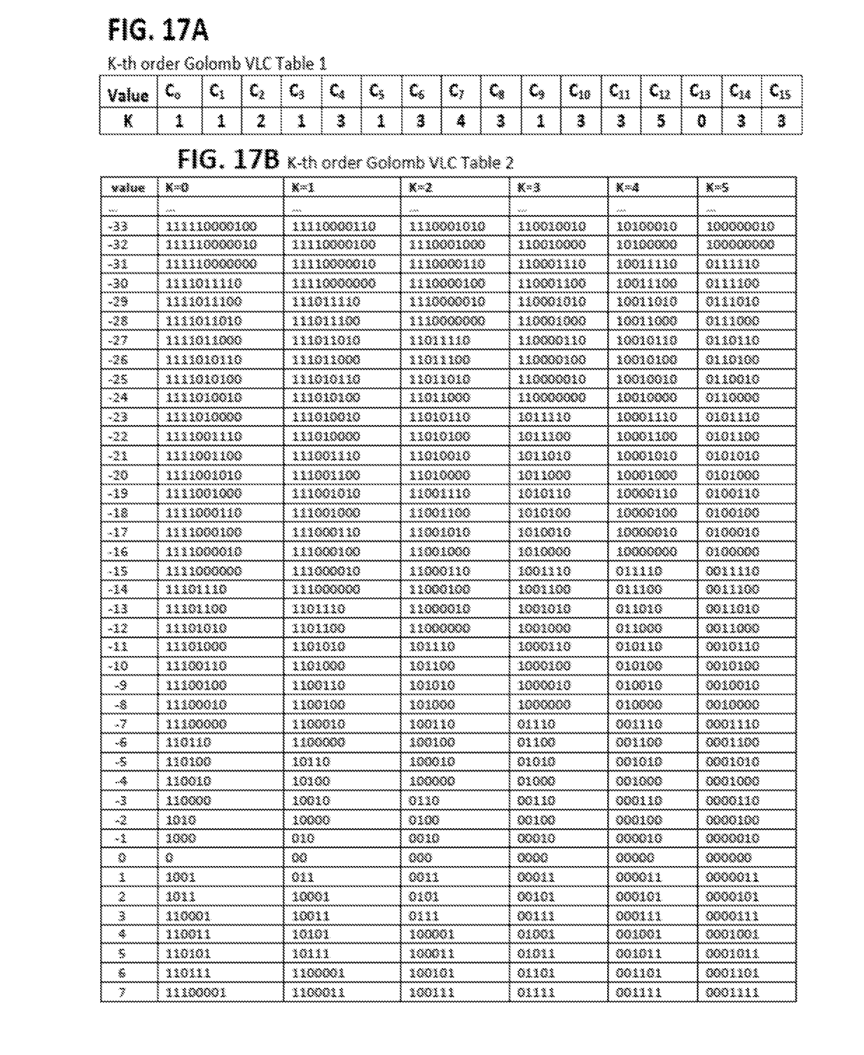

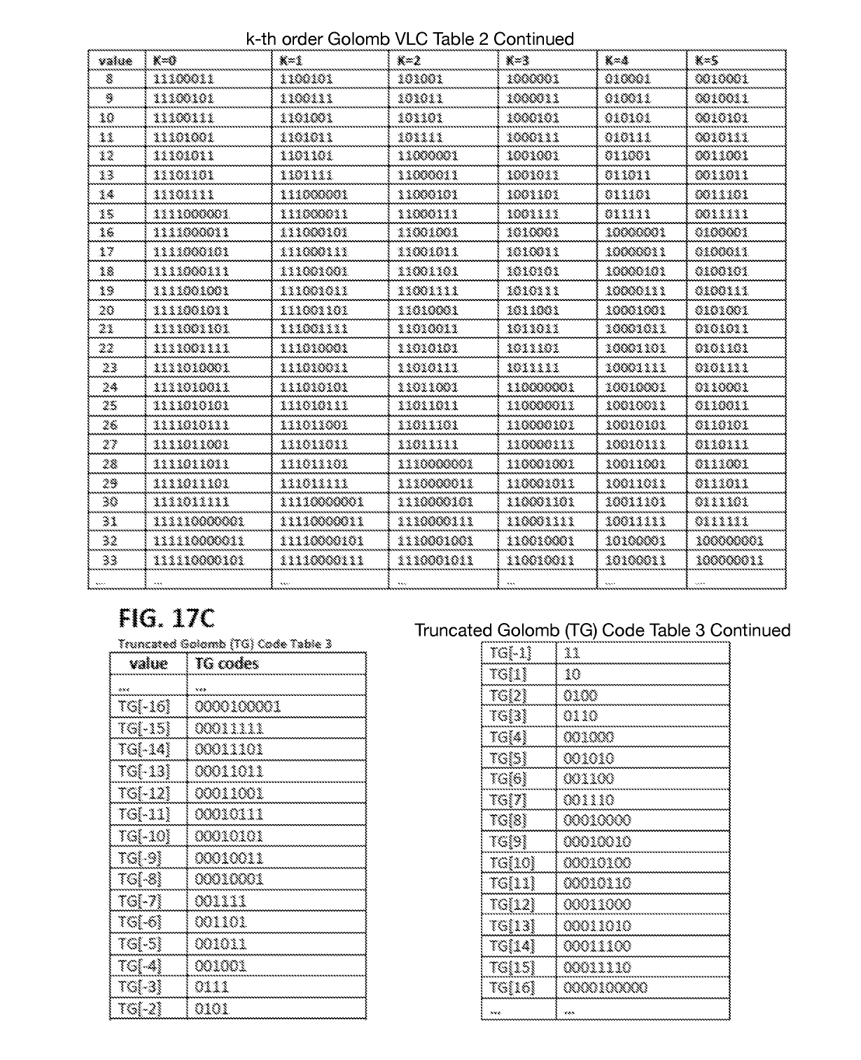

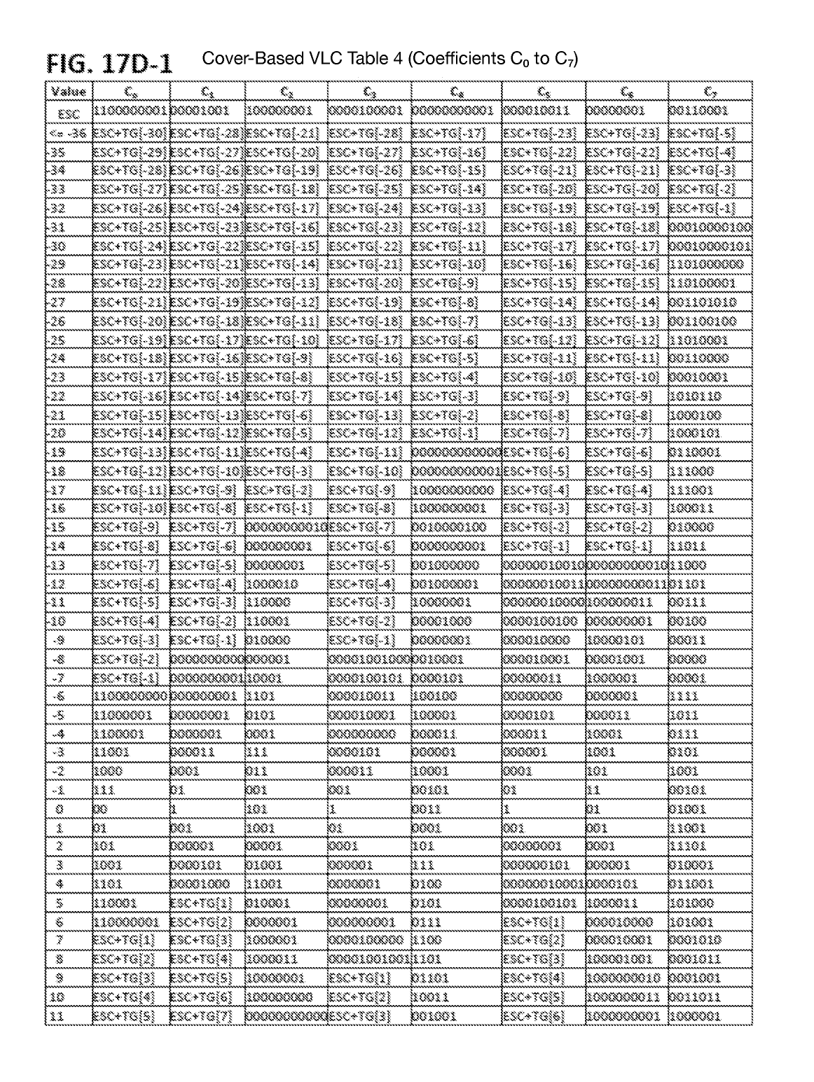

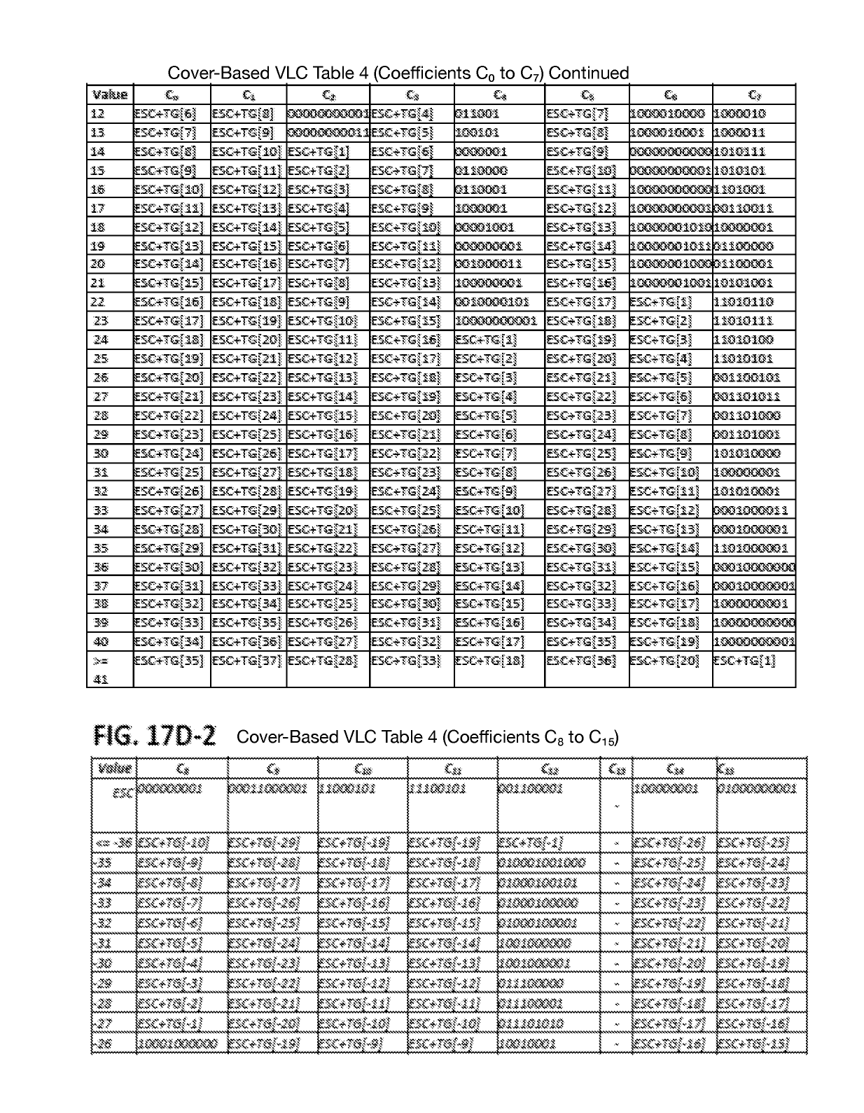

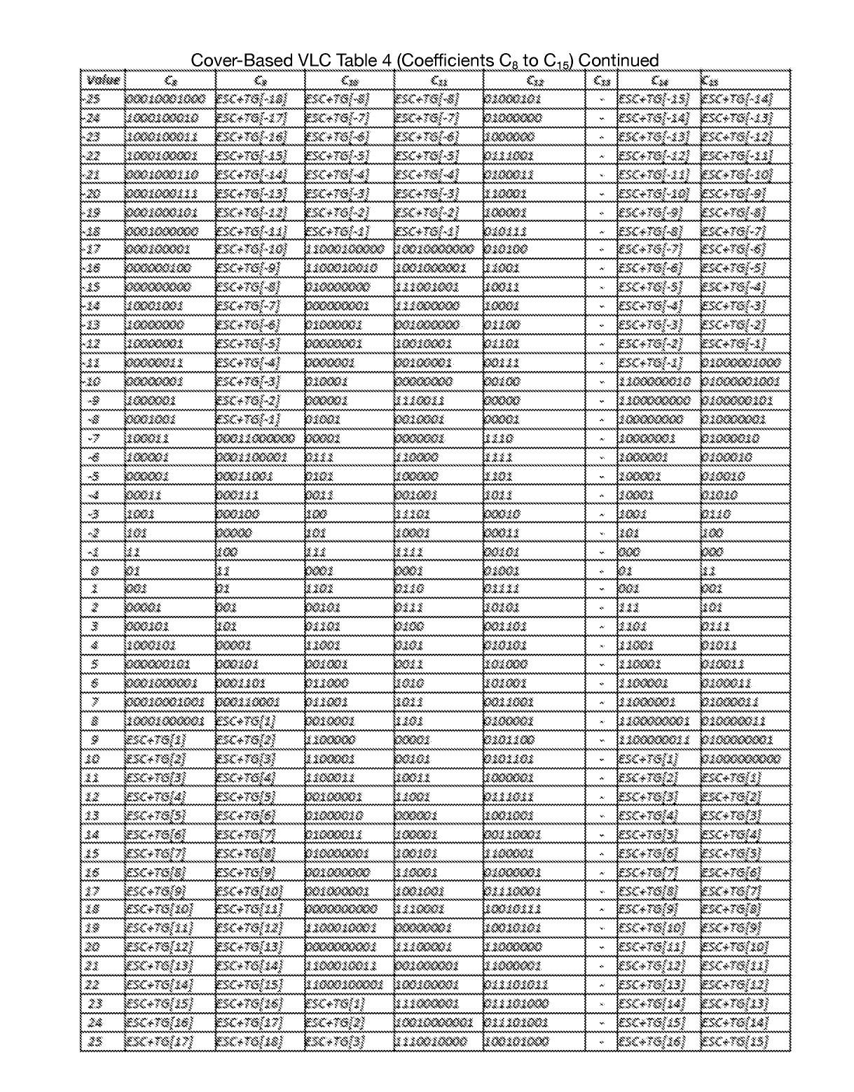

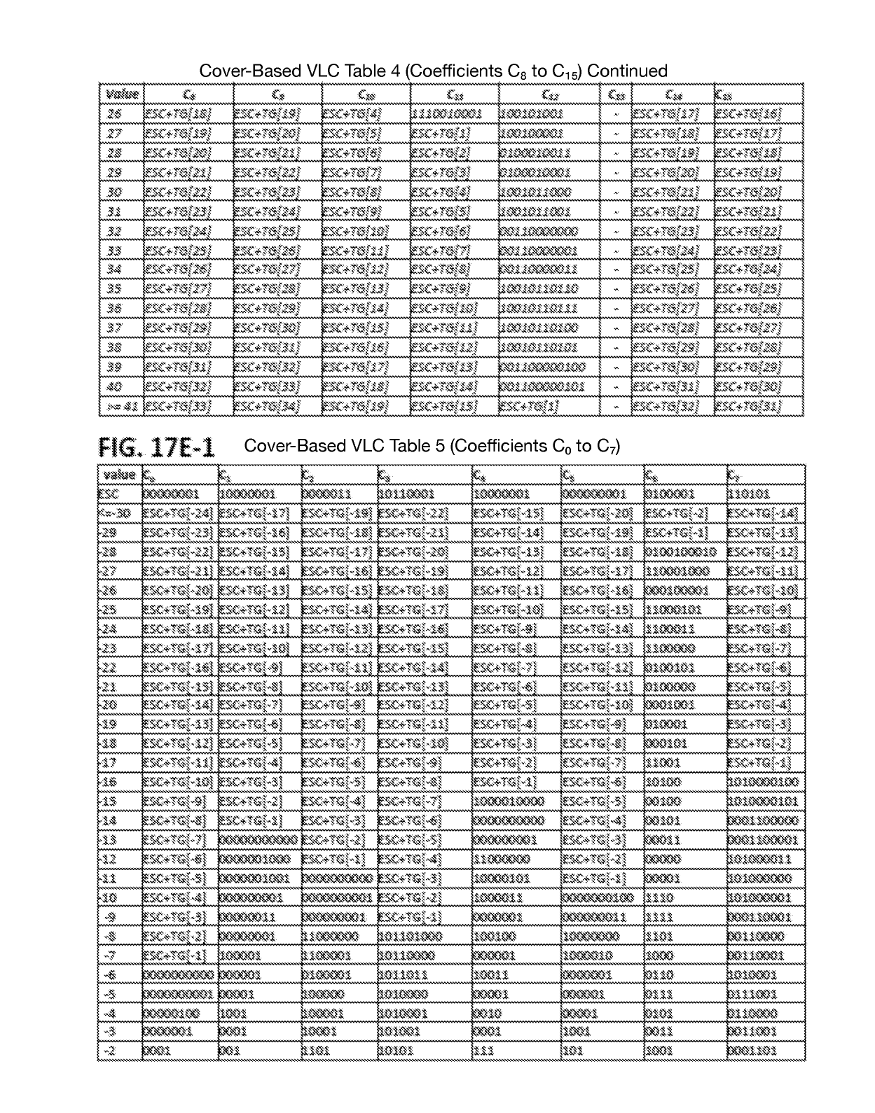

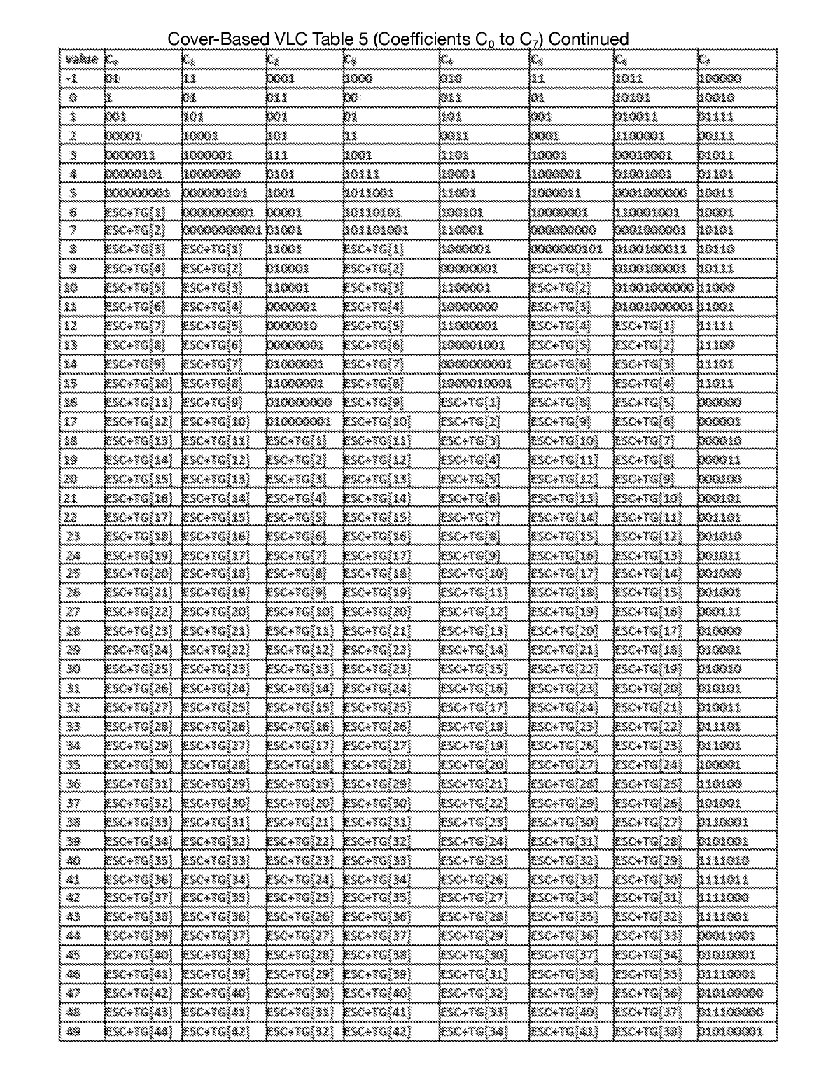

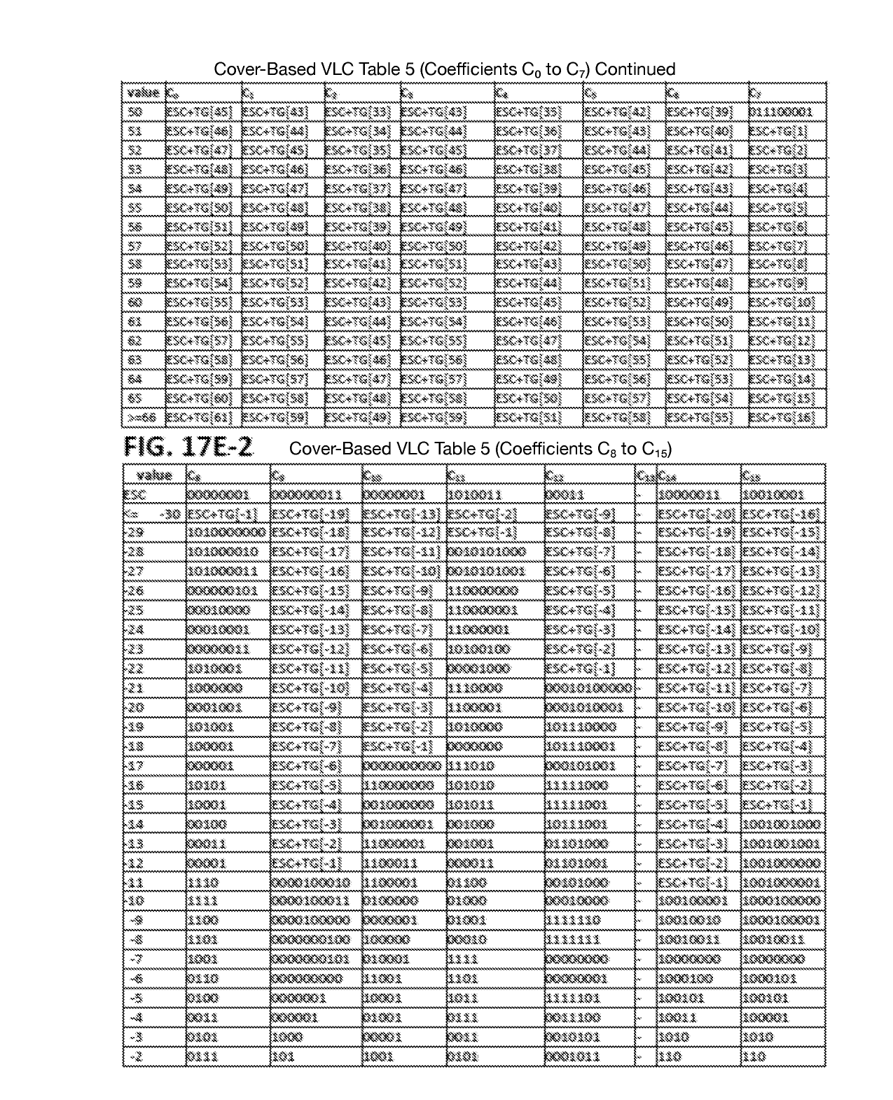

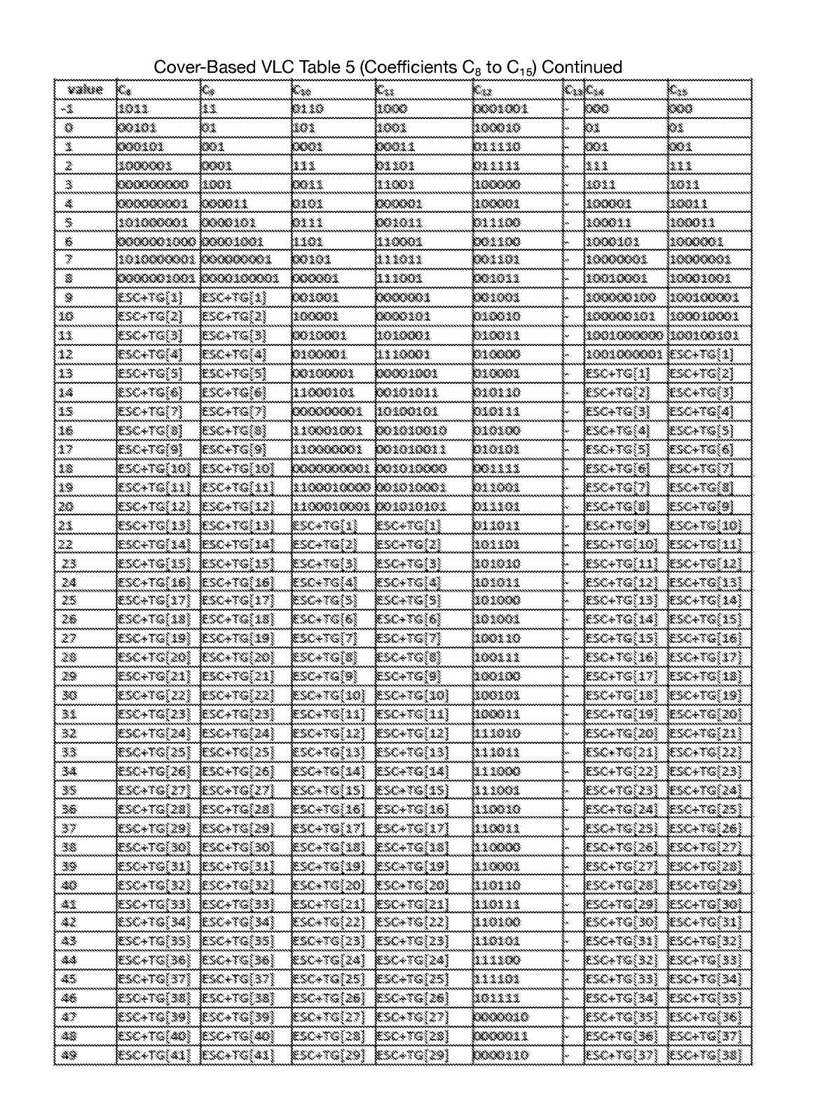

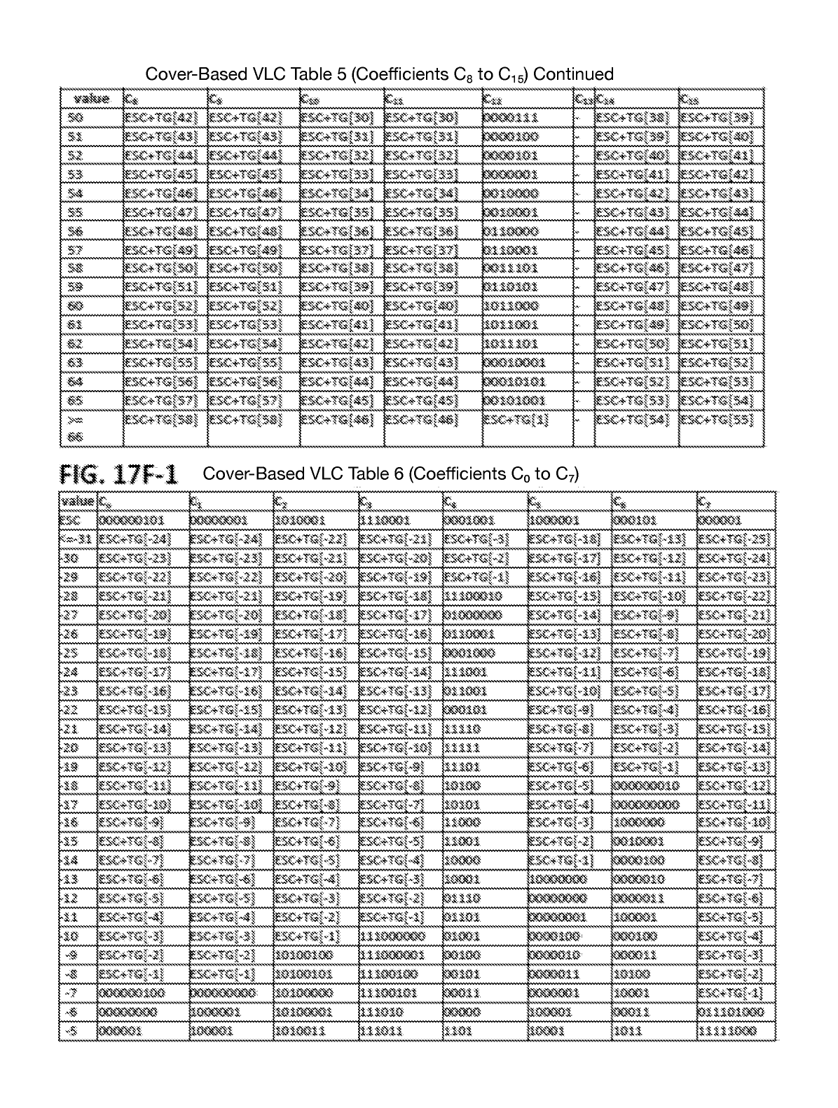

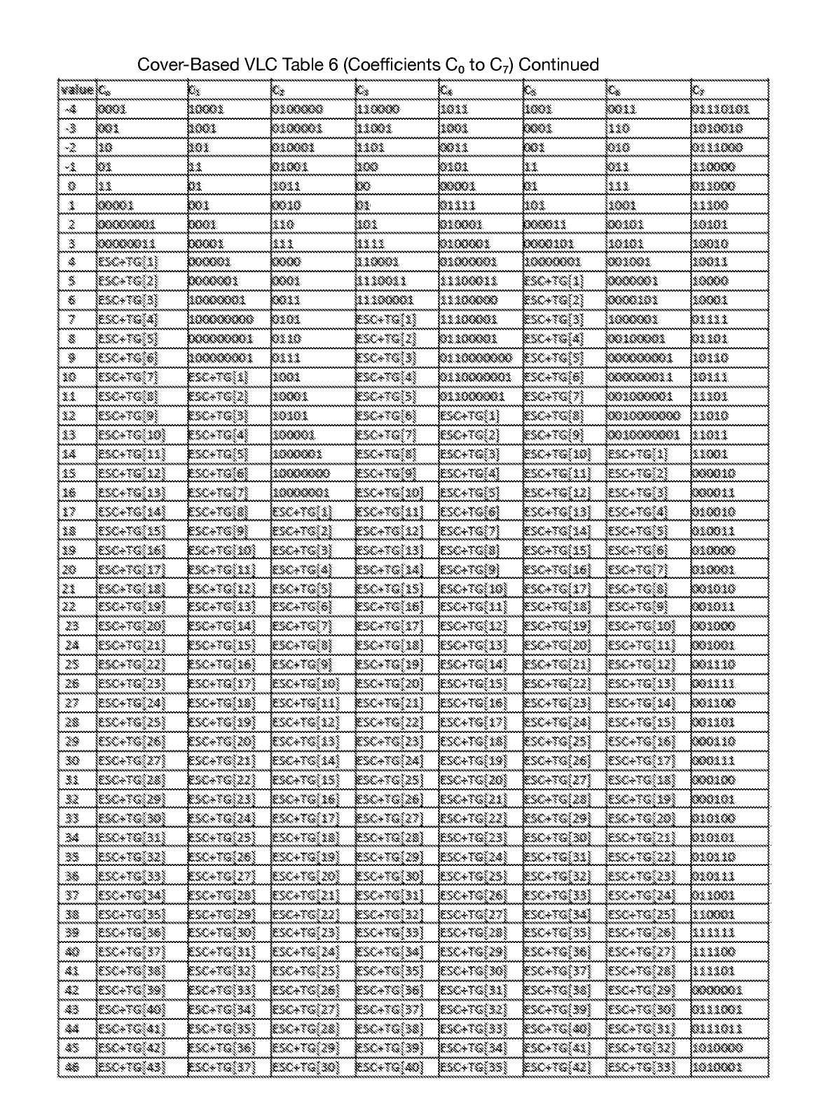

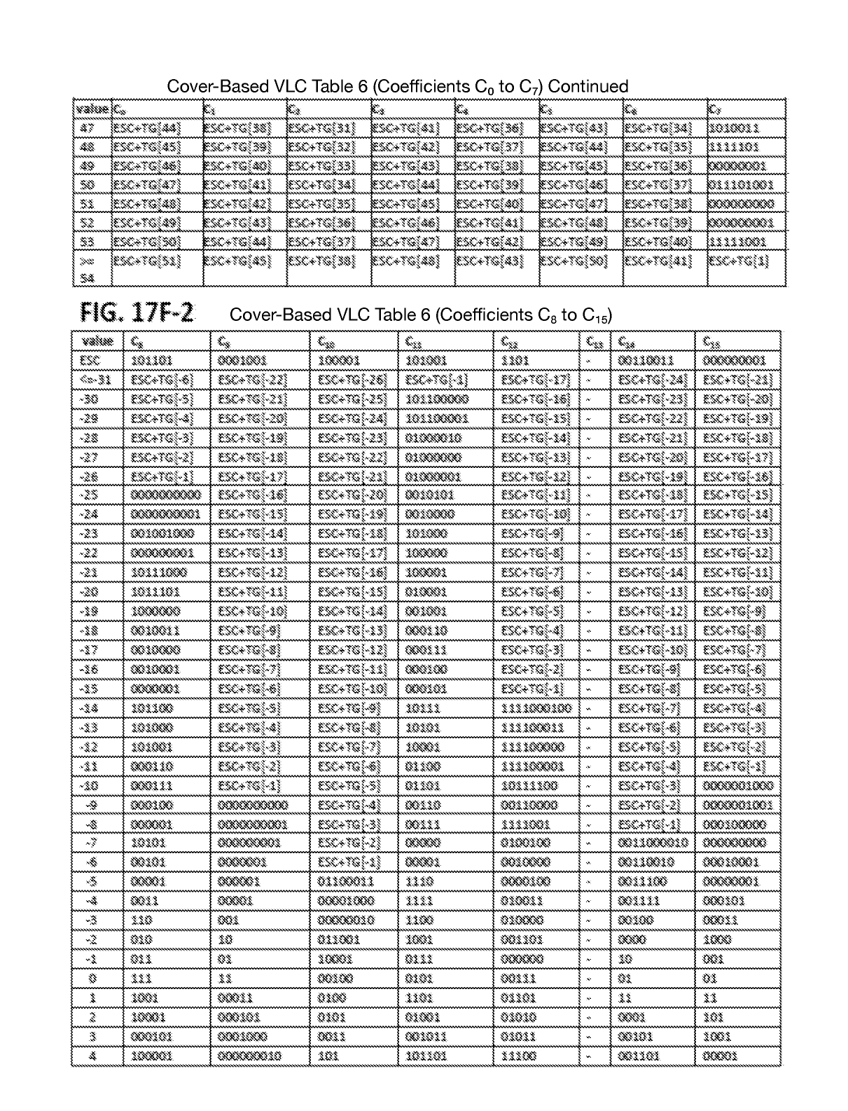

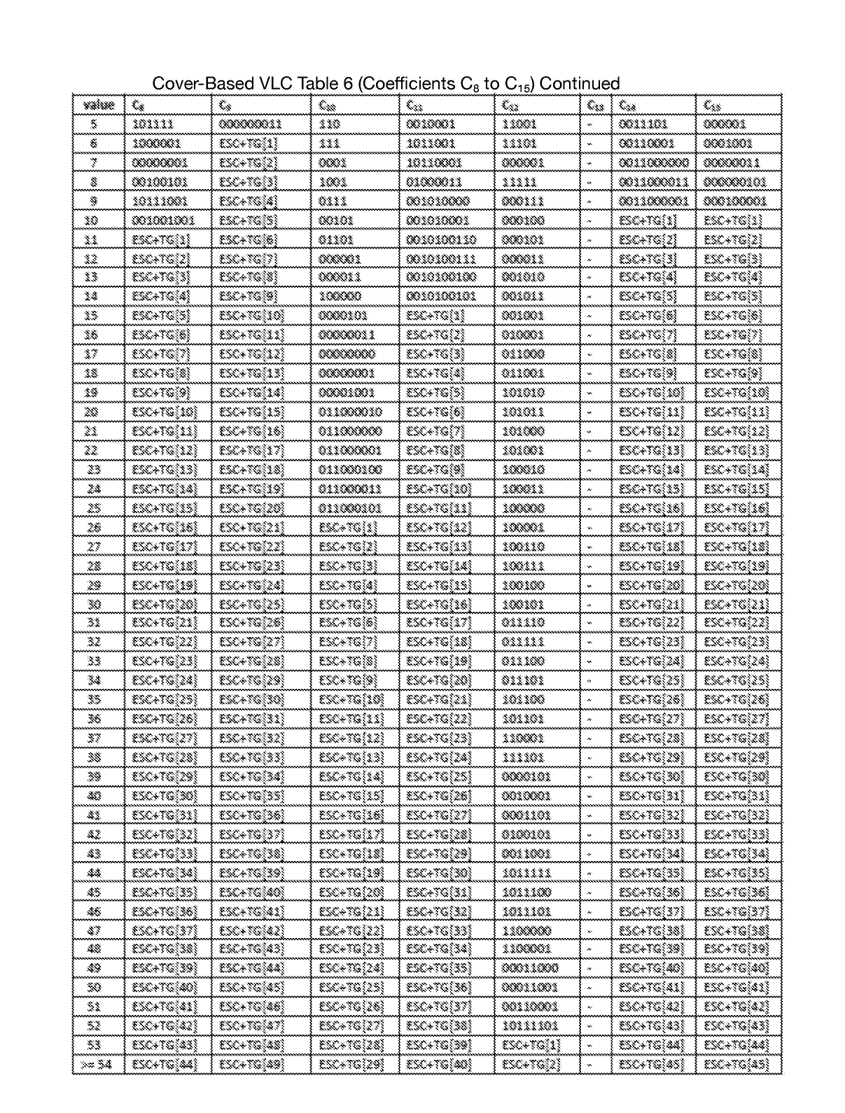

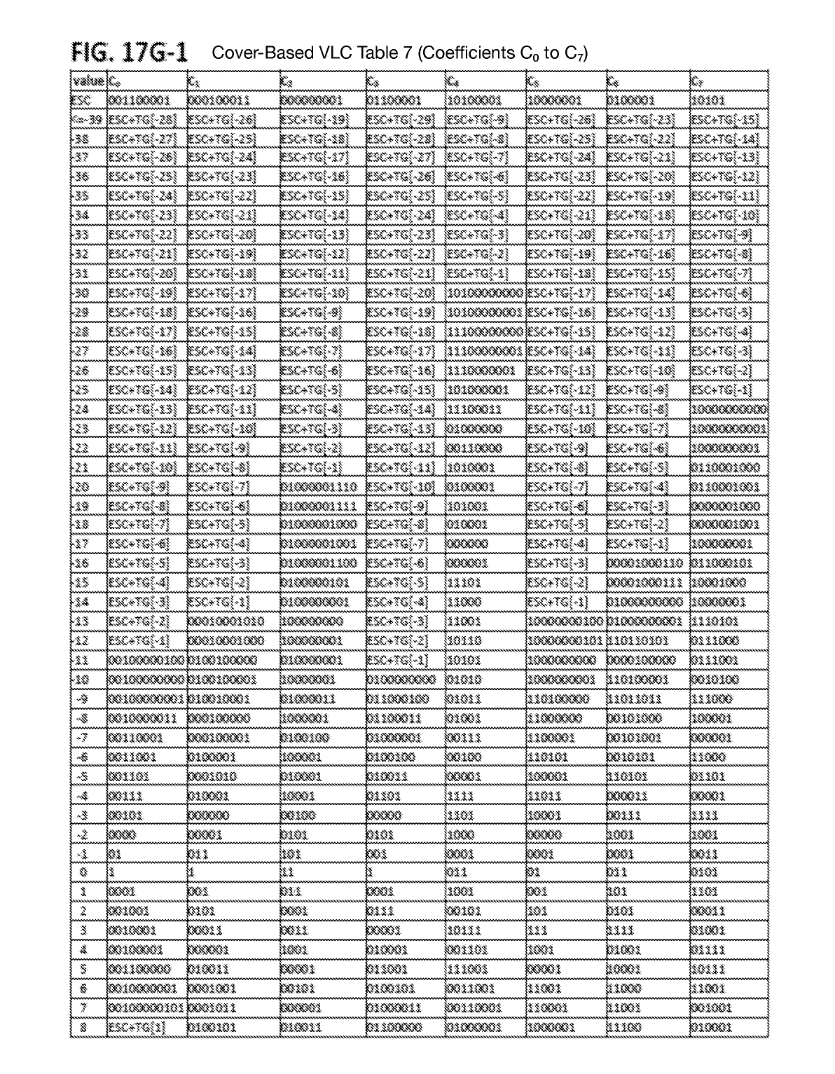

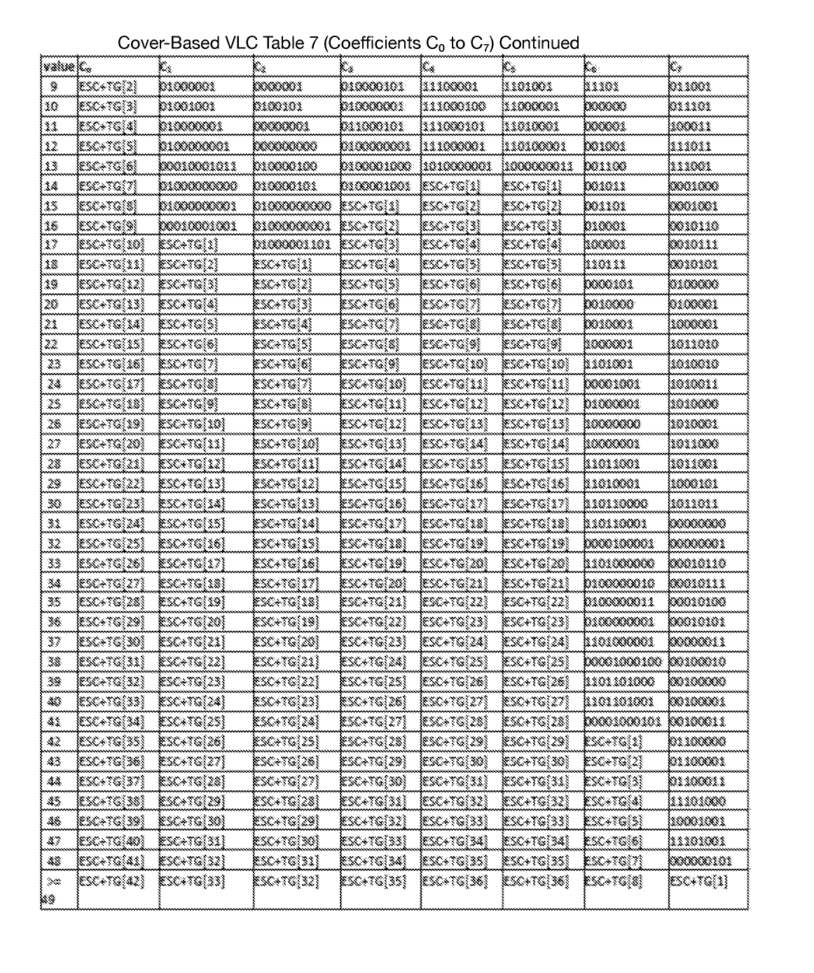

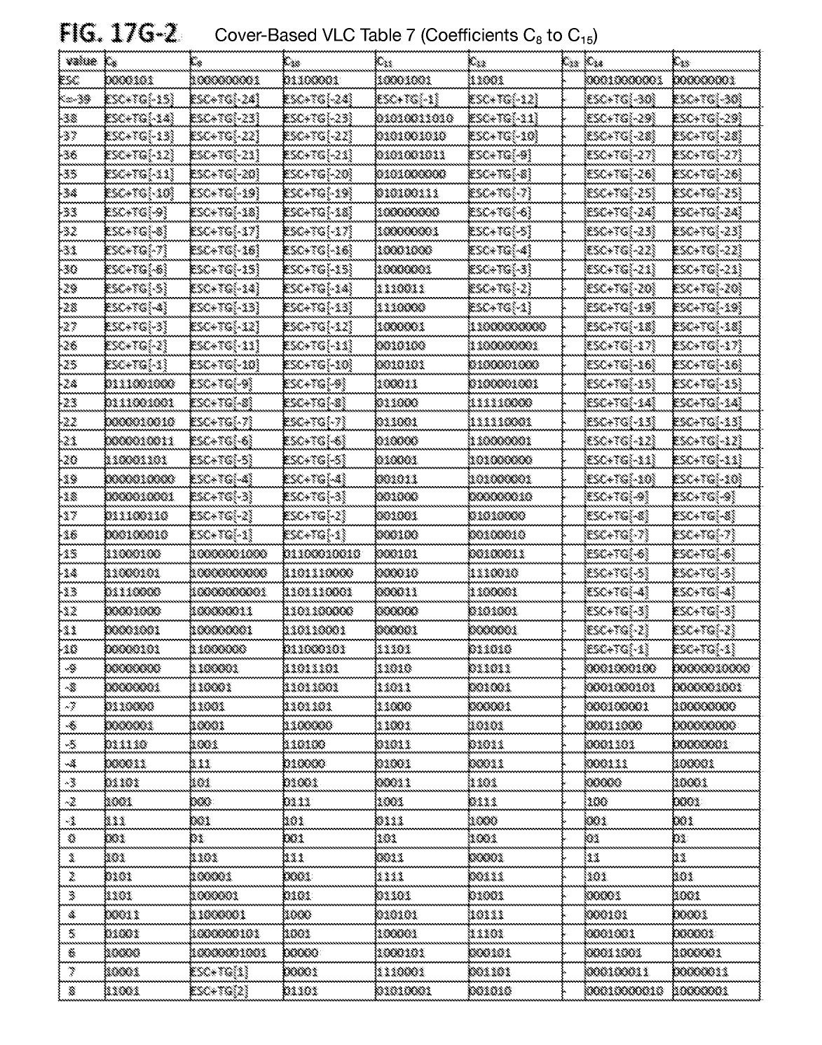

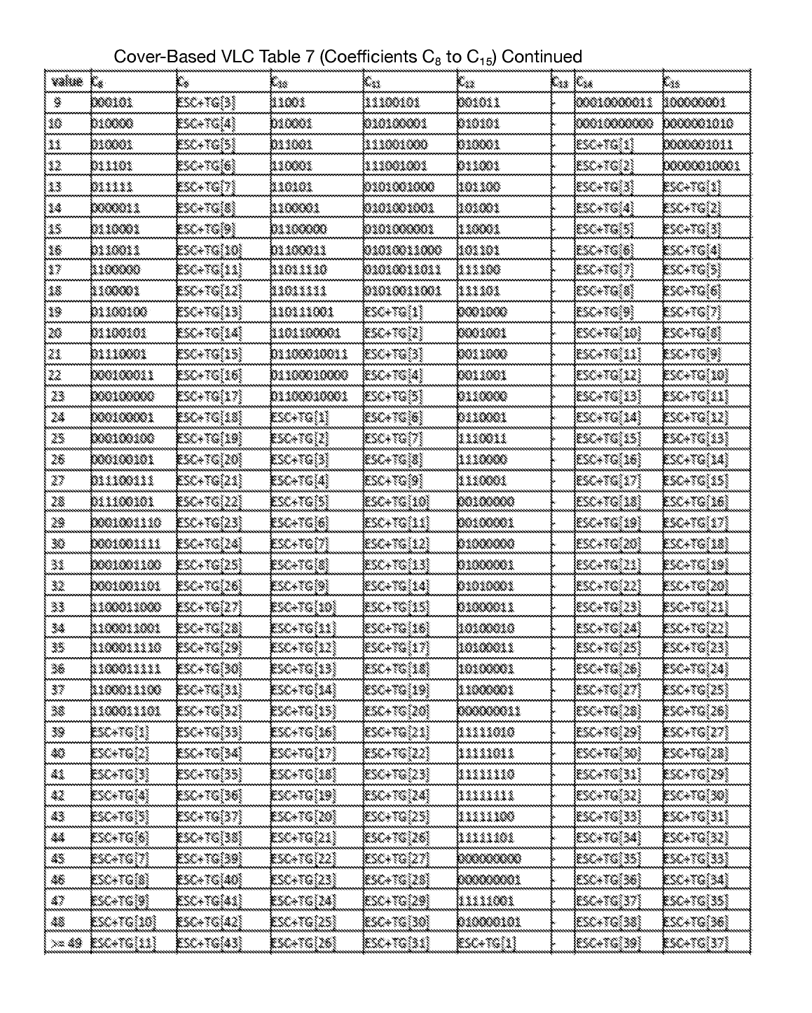

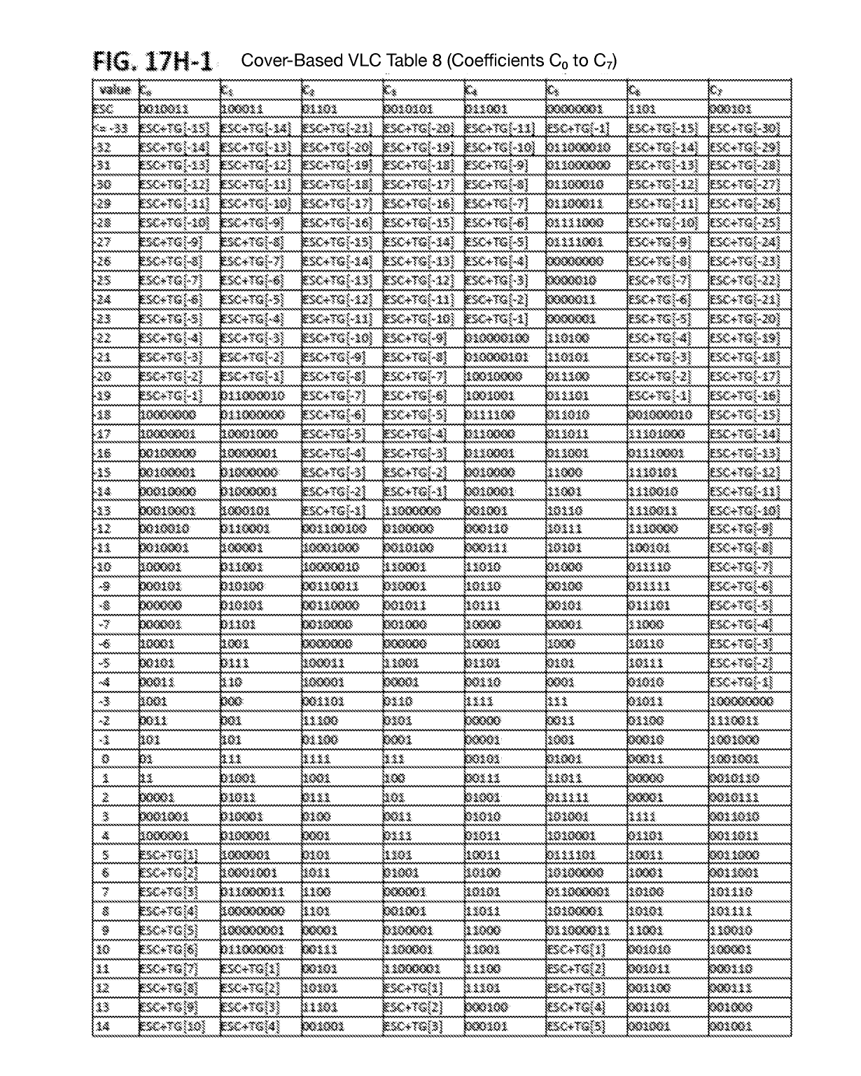

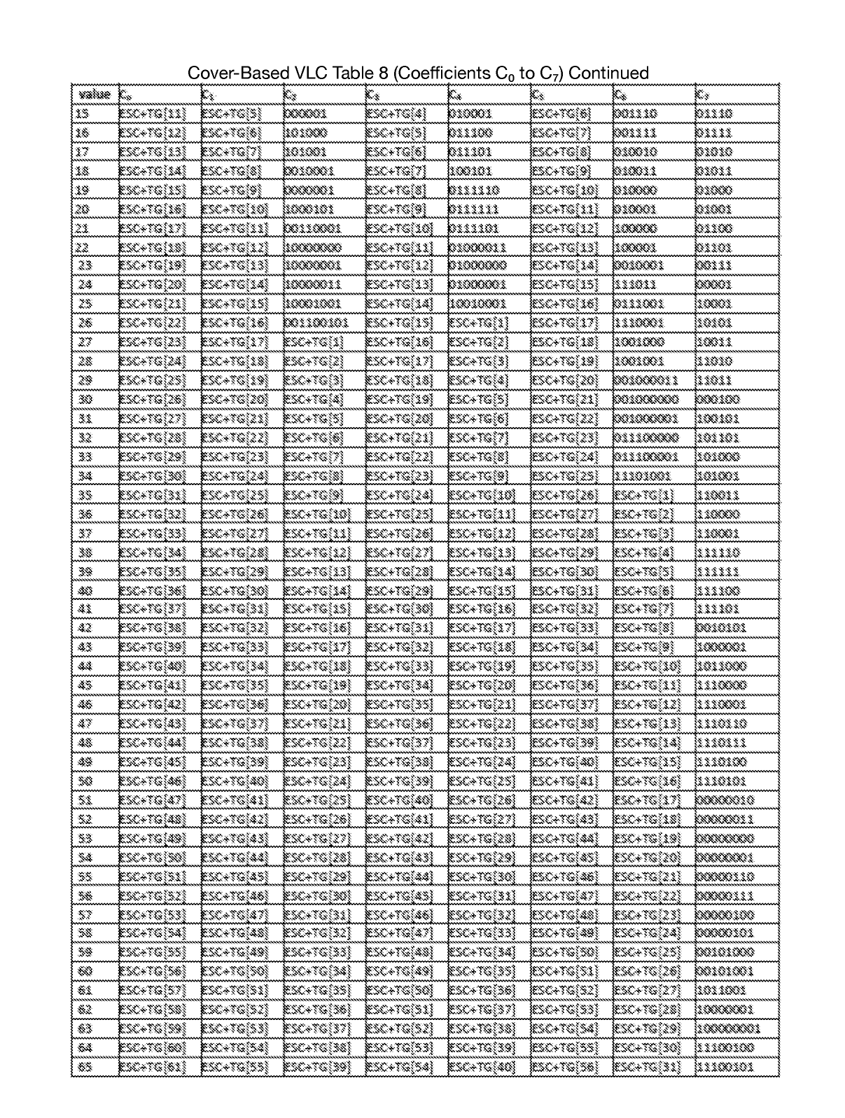

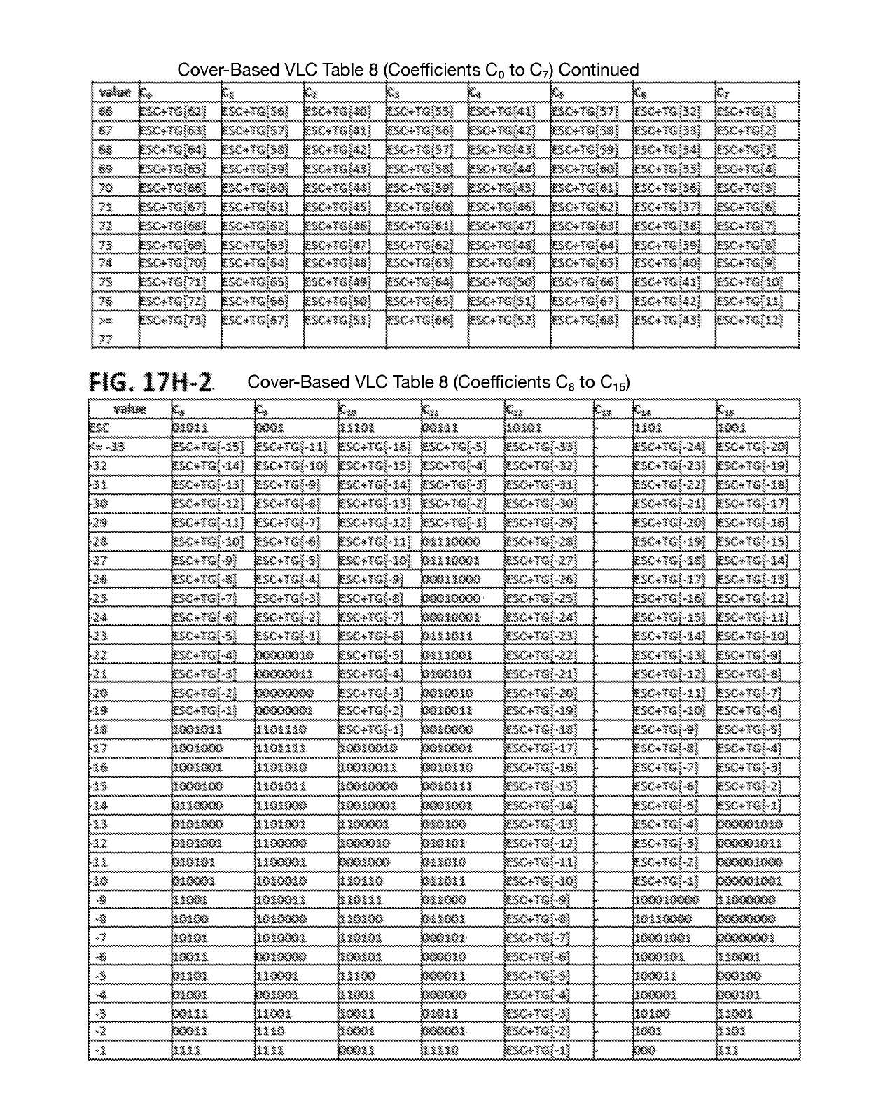

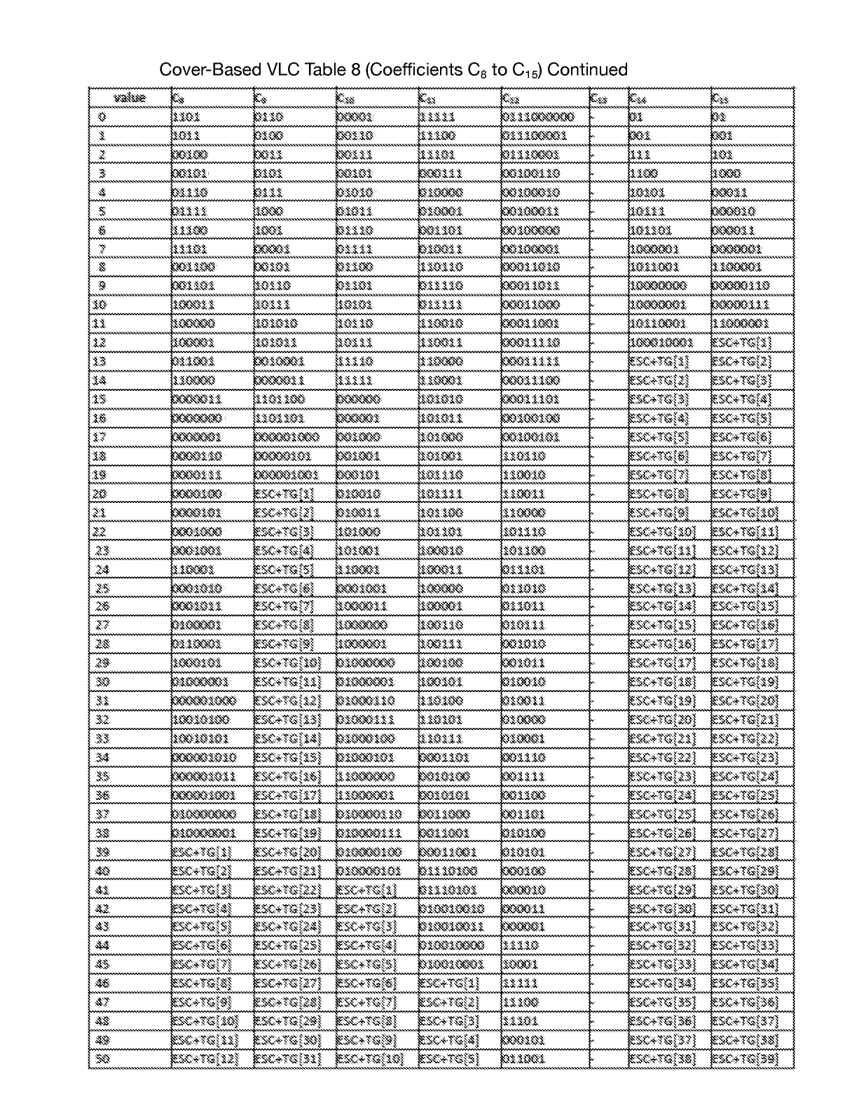

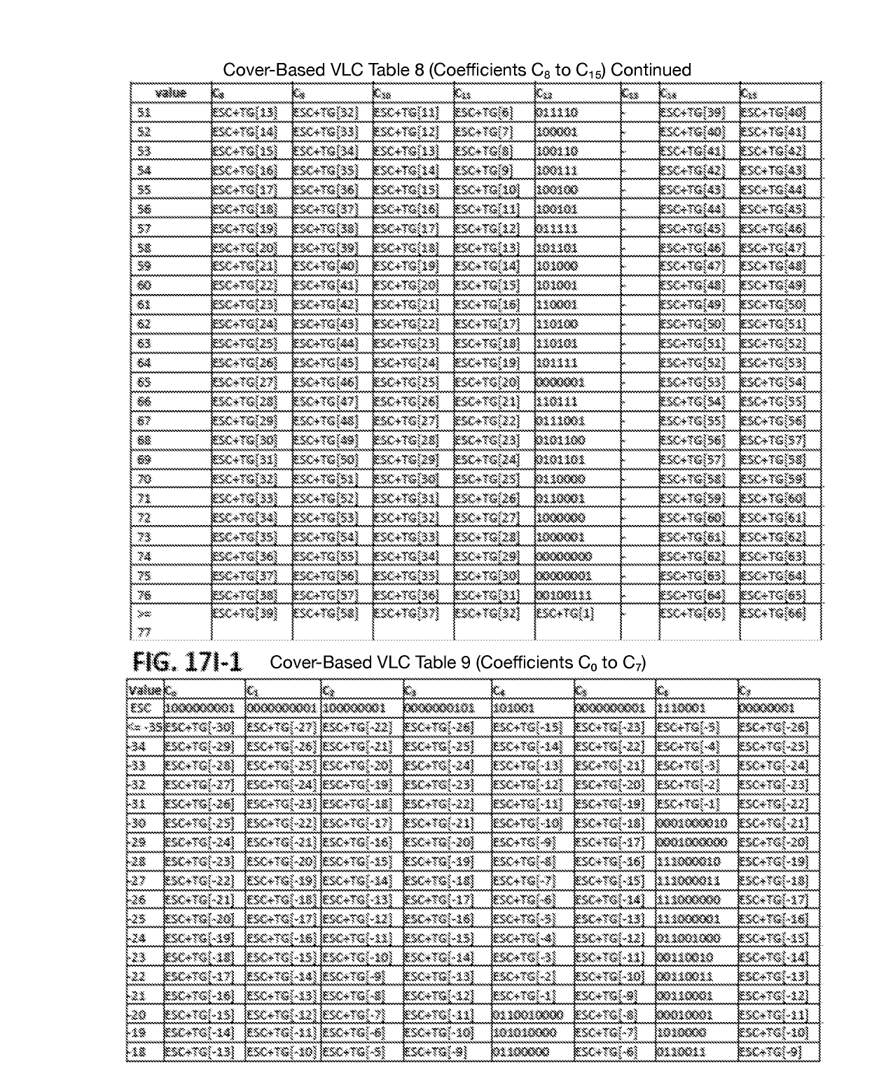

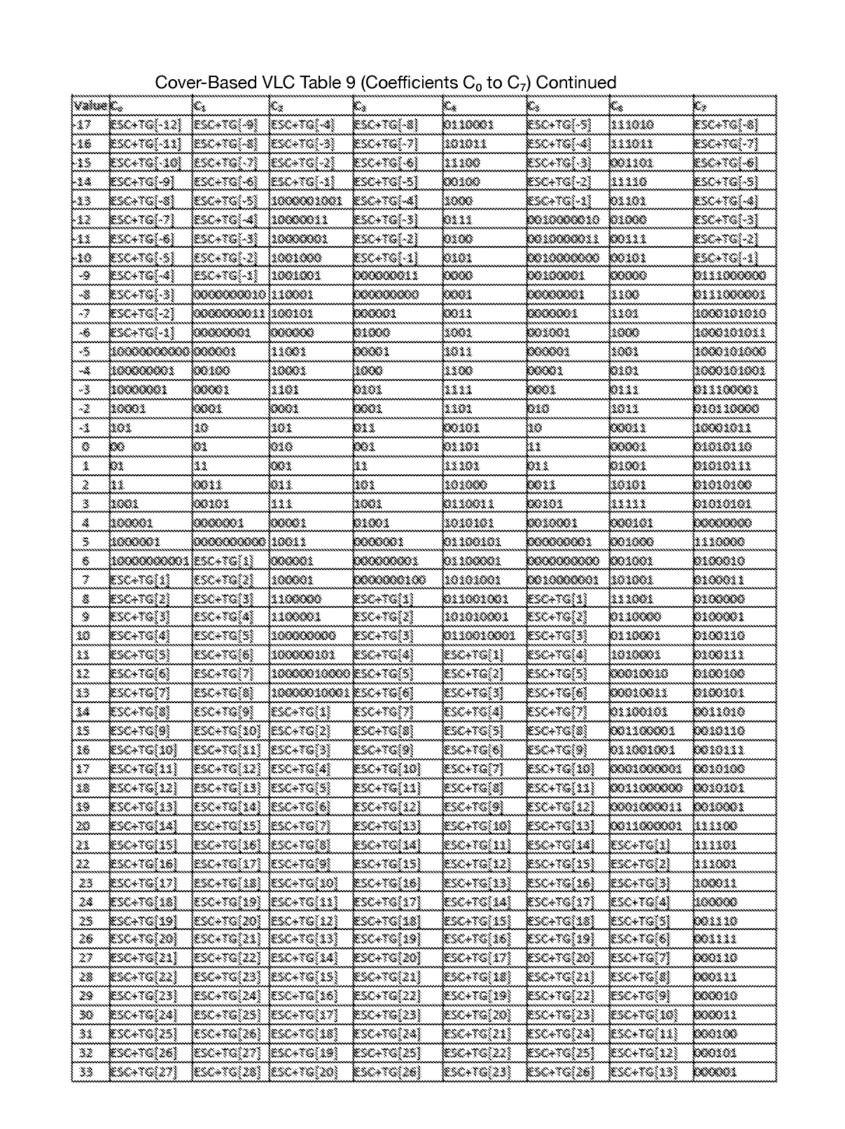

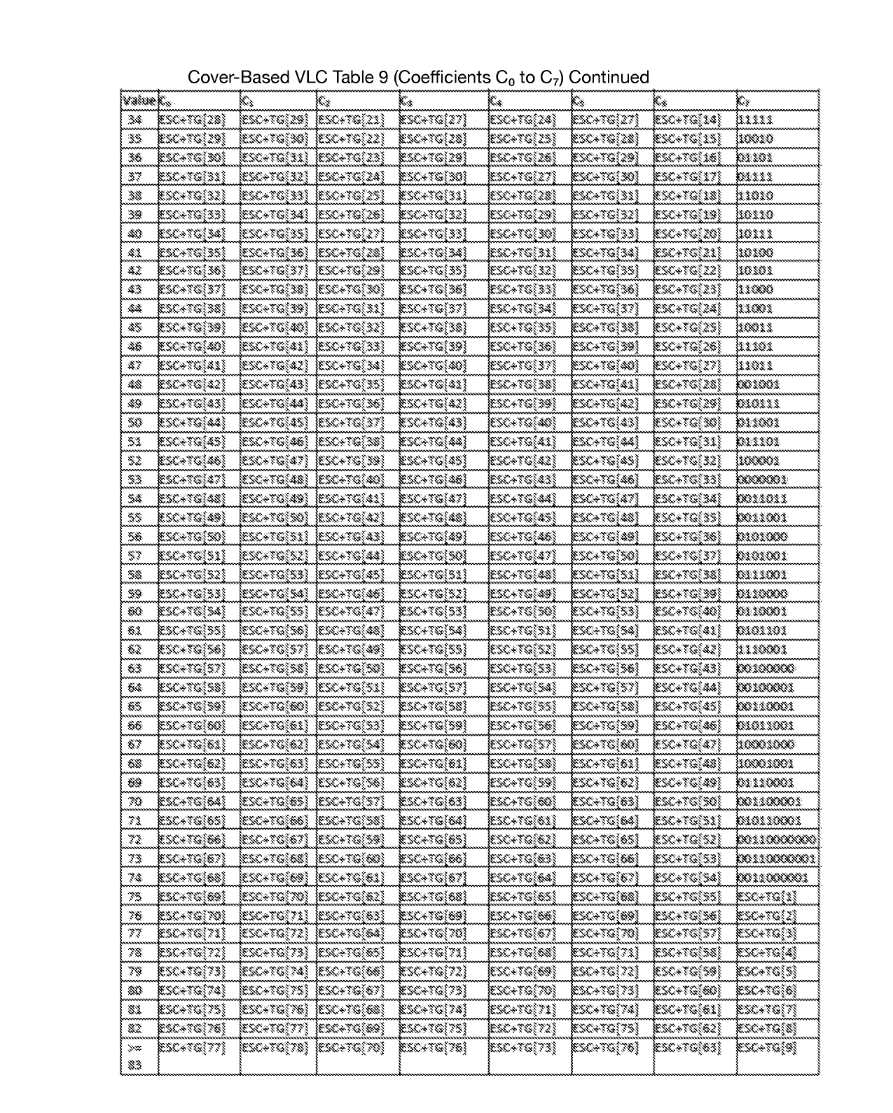

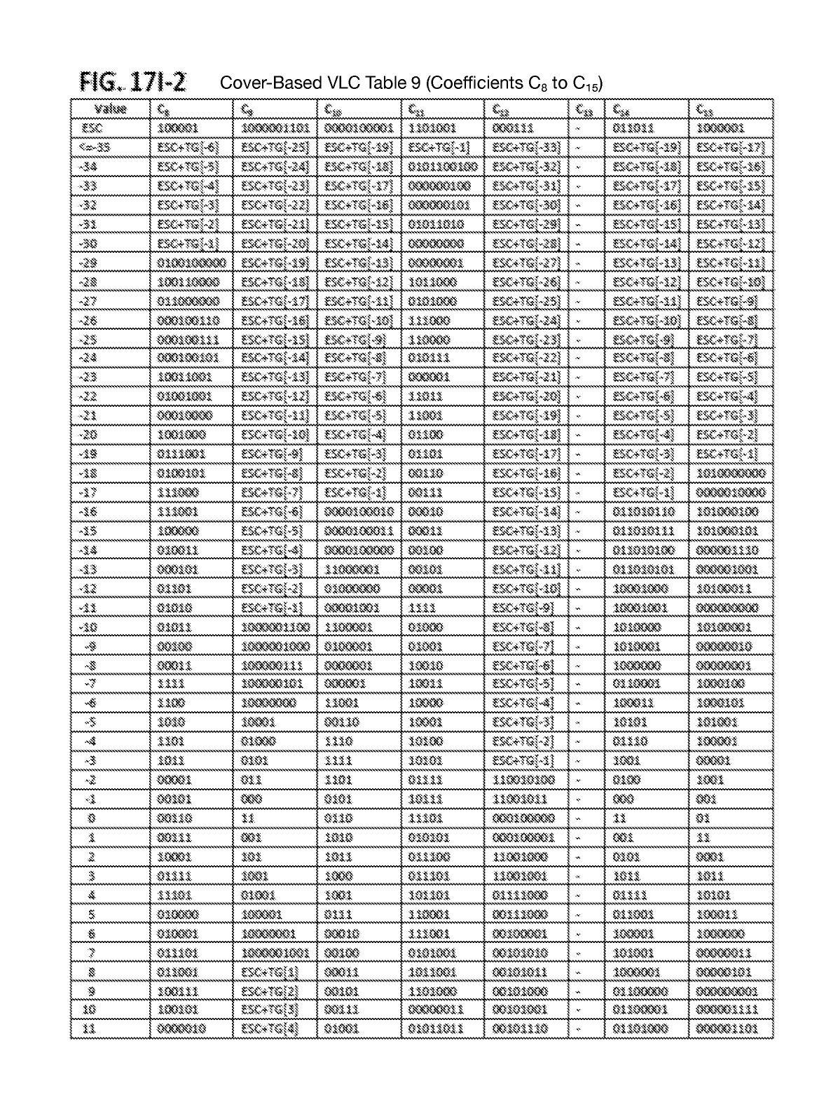

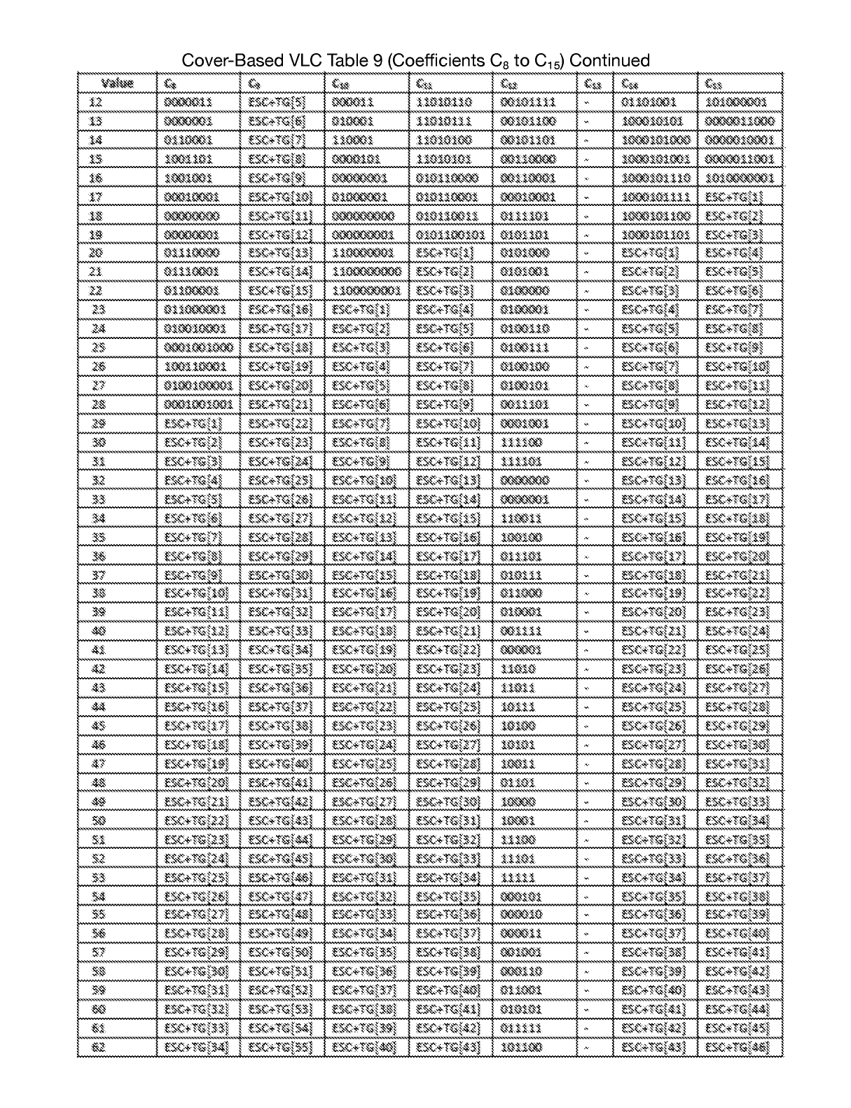

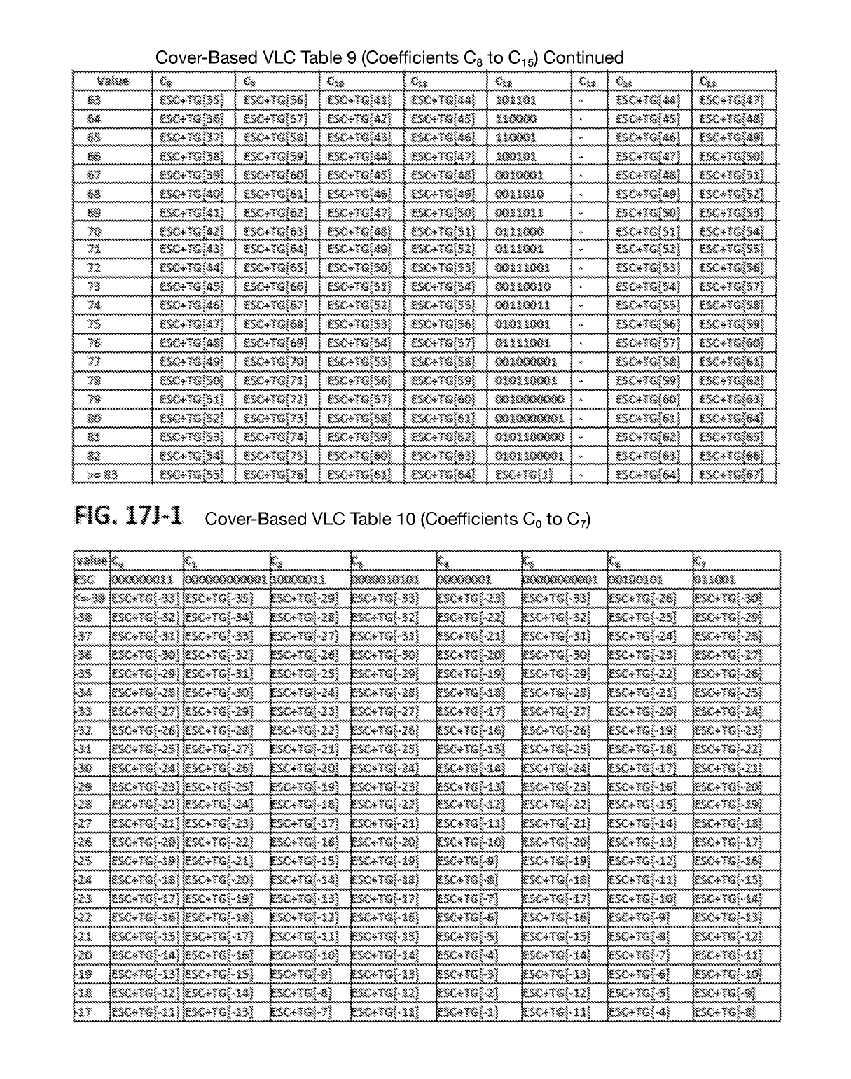

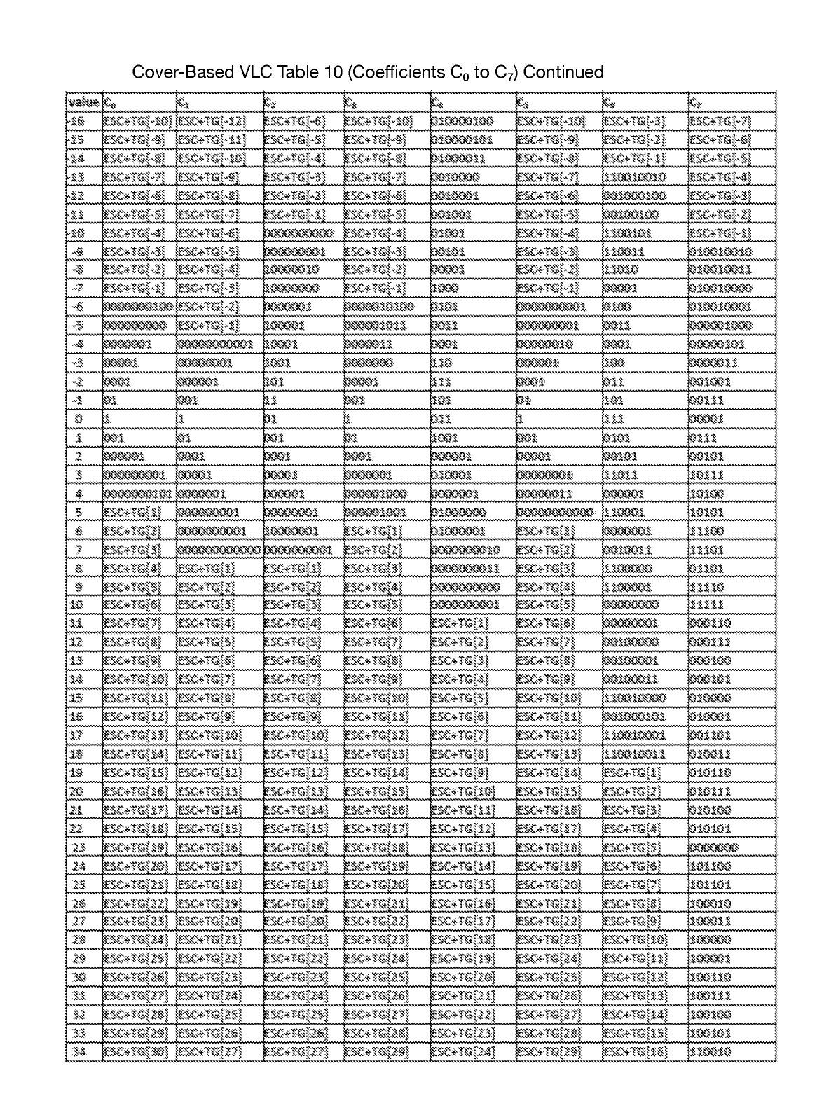

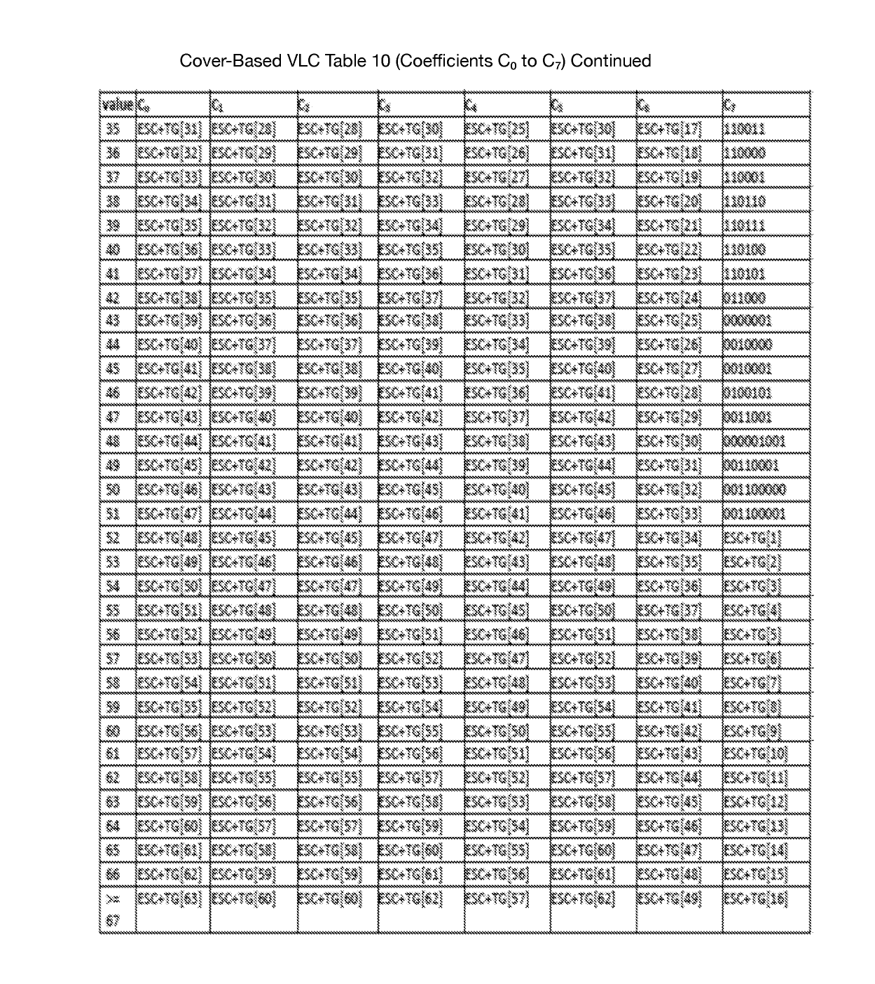

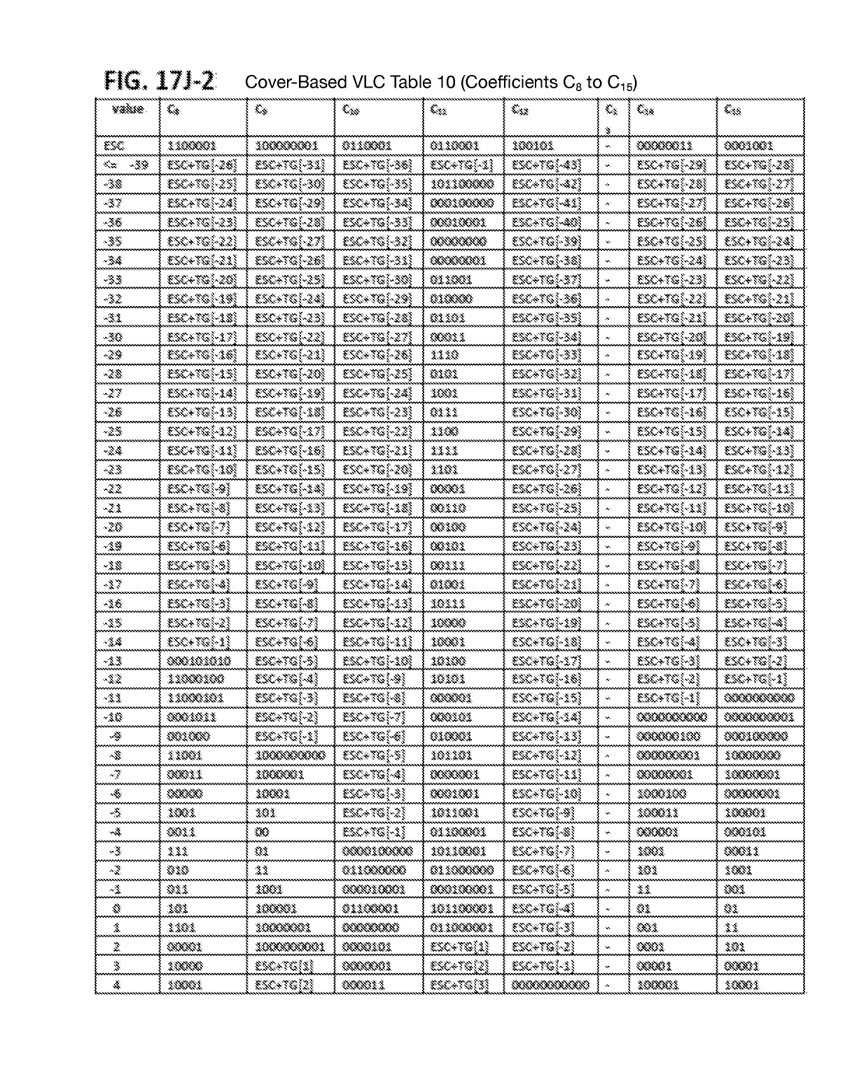

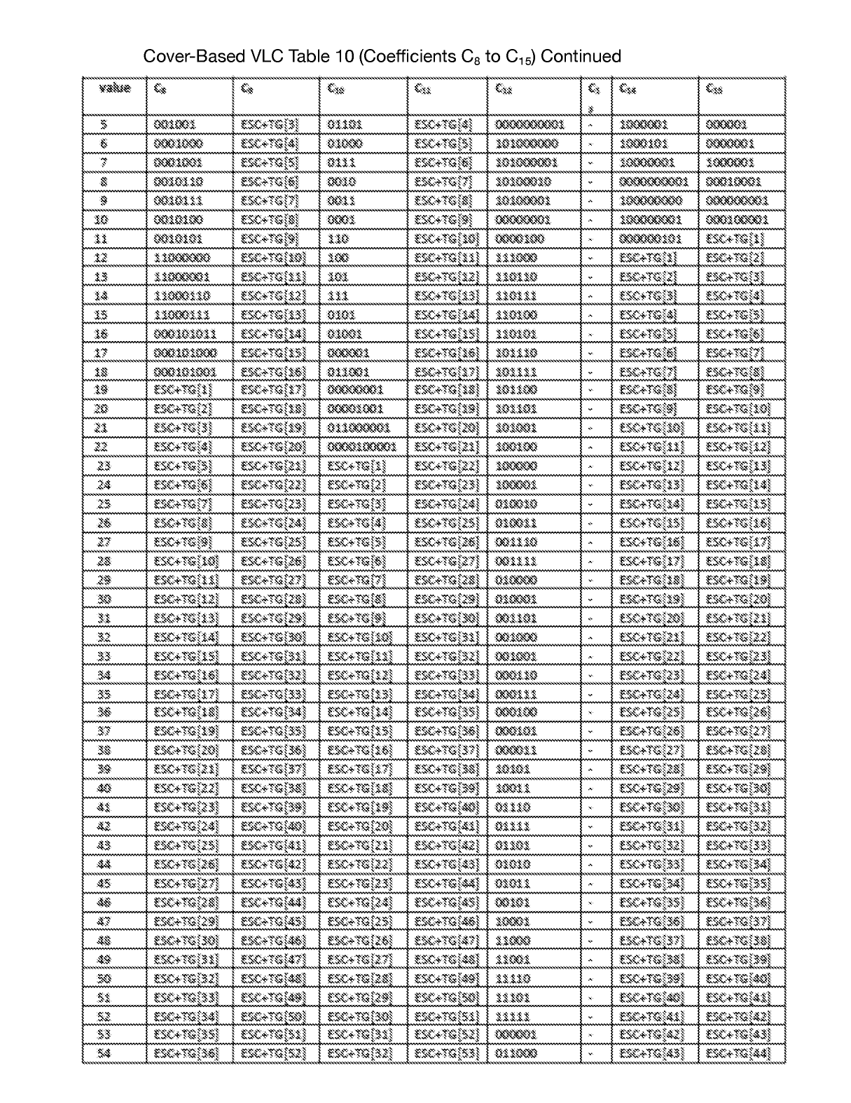

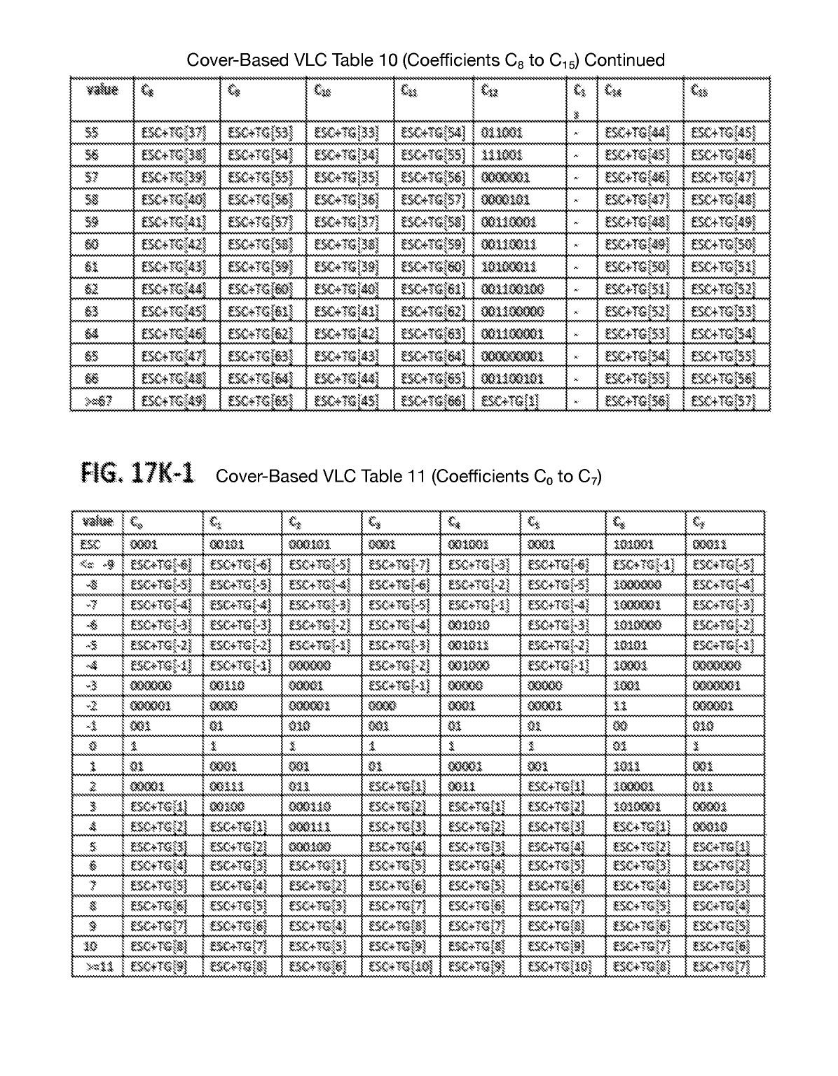

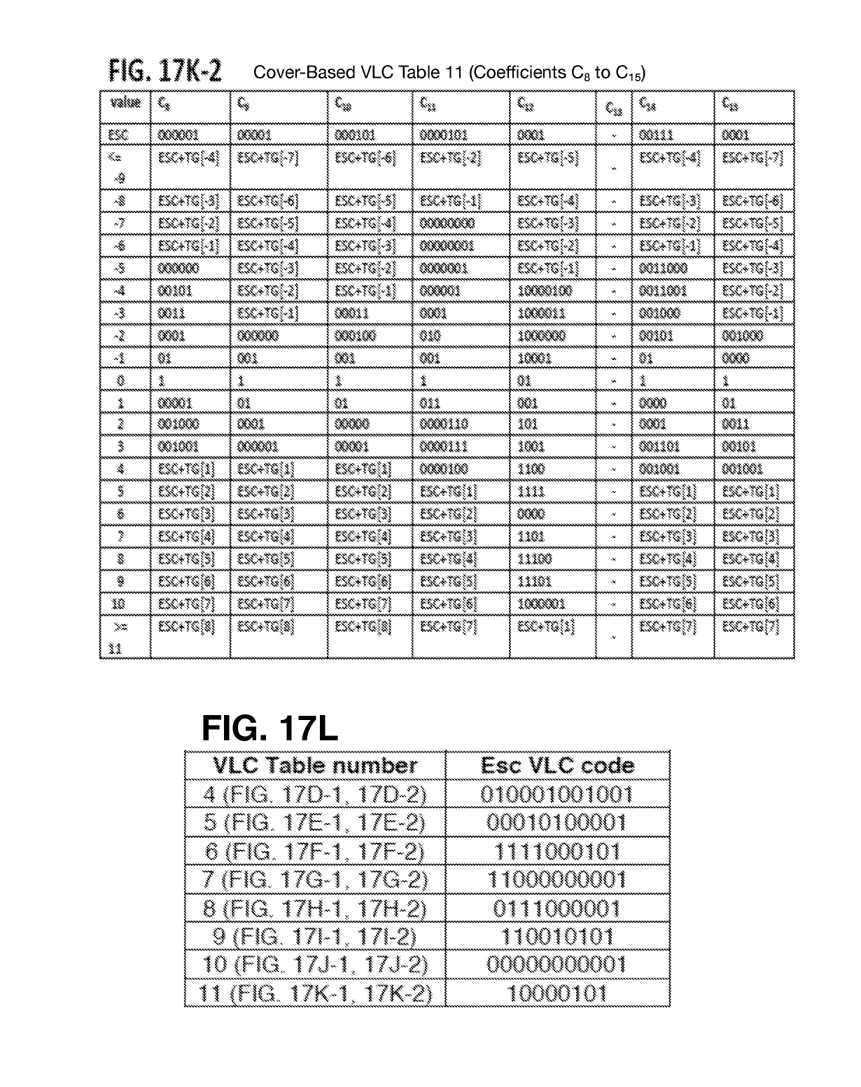

Referring to FIGS. 17A-17L, next the best coefficient coding (CC) method using past frame filters is computed 572. More specifically, for encoding of the filter coefficients for luma, one of a number of alternative coding methods may be selected. By the present example, an exponential golomb based method is available as well as eight different cover-based methods. If no encoding history is available such as for the first frame of a sequence or at a scene change frame, a simple k-th ExpGolomb coder is used (method=0). The simple k-th order ExpGolomb coder (where k varies per coefficient location as shown in FIG. 17A) is used to code filter coefficients in Luma filters. In the illustrated example, k-th order Golomb VLC Table 1 (FIG. 17A) shows 16 coefficients (C0 to C15) with k values ranging from 0 to 4. The k-ExpGolomb used in the proposed adaptive coding uses the k values for the 16 filter locations of the proposed filter shape. A k-th order golomb VLC table 2 shows the binary codes that correspond to coefficient values and depending on the k value. While only a portion of the table in the most often used range of −33 to 33 is shown, the remaining table can be deduced to cover all coefficient values. The binary codes are then written to the bitstream for decoding by the decoder.

When a filter history is available, an adaptive coding mechanism may be provided for Luma filters and by using filters from previously processed frames to choose an AQR coding method at each frame. By one example, besides k-ExpGolomb method for when no history is present, there may be eight cover methods that use variable length coding, and respectively corresponding to Tables 4-11(FIGS. 17D-1 to 17K). Table 3 (FIG. 17C) provides codes for truncated golomb (TG) coding that is available for any of the cover methods, and Table 12 (FIG. 17L) provides codes for a non-zero center coefficient (coefficient C13 for the filter pattern 600 provided herein). The main cover Tables 4-11 are each split so that, for example, FIG. 17D-1 shows the code values for coefficients C0 to C7 while FIG. 17D-2 shows the code values for coefficients C8 to C15.

The Cover method for coding of filter coefficients, unlike a Golomb coder, allows for assigning specific VLCs to the most frequently occurring coefficients at each coefficient location separately. This mechanism is used for all coefficient locations. Each filter coefficient location, however, is assigned its own cover. A total of eight sets of Cover VLCs along with a Golomb code is adaptively switched at each frame. This yields to notable bit savings if the appropriate table is selected. At each coefficient location, a cover method “covers” the range of values with specific VLCs while using an escape code (ESC) to indicate a value outside of the “cover”. Therefore, if a value falls inside of the cover, then a single VLC code is used to code that value. However, if the filter coefficient value falls outside of the cover, the escape code is coded first, followed by the coding of the differential of the value with the closest range limit value using Truncated Golomb (TG) coder. For example, suppose the cover for a given coefficient value is [−7, . . . , 15]. Value 3 would simply be coded with a VLC code corresponding to value 3 since it falls inside of the cover. If the value is −10 for example, which falls outside of the cover, the escape codeword ESC is first coded (to indicate that the coded value is out of the cover), and then the differential with the closest range limit value (−7 in this case) is computed which results in −10−(−7)=−3. Then, −3 is coded with Truncated Golomb (TG) code, which is a simple Golomb coder in which 0 is not a valid value, and thus a one bit prefix of each non-zero Golomb code is deleted (note that the differentials theoretically range from (−∞ . . . −1] U [1 . . . ∞)).

Looking at Table 4 (FIG. 17D-1) for example, the escape code (ESC) is listed along the top row for each filter coefficient, and the filter coefficient values are listed along the side of the table. For Table 4, the coefficient values listed are from −30 to 66 (although the other tables may list a different range), and where −6 to 6 is considered the cover range for coefficient C0. Any value less than −30 or more than 66 receives the same code as those limit values. For a coefficient value between the cover range (−6 to 6), that value is merely coded with the listed binary coding. For any values out of that range, say −9 for example, then that value is coded with ESC+TG[−3], which refers to the escape code plus the truncated Golomb coding TG[−3] since −9 minus the closest cover range limit (−6) is −3. Once this differential is determined, then the binary code for TG[−3] may be looked up on Table 3 (FIG. 17C). The other Tables 5-11 operate similarly.

For non-symmetric coefficient locations C14 and C15, a predicted value differential is coded instead of the actual value. The coefficient C8 is used as prediction for coefficient C14, and the coefficient C6 is used as prediction for coefficient C15 for the purpose of computing predicted value differentials to be coded.

Each of the eight cover coding methods (corresponding to Tables 4-11) may have different cover ranges. The cover coding tables also have different binary codes for the same coefficient value with the same coefficient number (or position) from table to table. By one approach, the best table is found by “brute force” in a manner of speaking, and each VLC table is tested, and the table that produces the lowest number of bits, or in other words, the one that maximizes compression, is considered the best table. This table (or an index for the table) is then signaled in the bitstream so that the decoder can use the same table to decode the filter coefficients. In the alternative, less than all of the VLC tables may be tested when some content analysis knowhow can be used. There is some overhead for selection of tables, etc. that also should be accounted for, but this is usually insignificant.

The generation of the VLC tables is based on the following explanation. To start, three reasons for adaptive algorithms (here, it is adaptive entropy coding of QR filter coefficients) in video coding are: (1) image properties (less/more details, slow/fast motion, . . . ) of the video content itself that is being coded, (2) constraints on storage/transmission bandwidth, such as bitrates, and (3) the expectation of (high) video quality (or equivalently, high compression). The three taken together represent an operating point that can range from not challenging (easy) to low to medium to high to extremely challenging. Generally, the higher the challenge level, the more adaptivity is likely needed. Although other practical issues exist such as complexity, this is ignored for now.

The adaptive system presented herein raises the need for higher compression that necessitated multiple VLC tables by some of the examples, but still maintaining relatively lower decoding complexity, which was avoided here by not using arithmetic coding type of schemes. Thus, a mechanism for selecting among the VLC tables should provide sufficiently high compression gains from the VLC, otherwise the gains from the adaptive QR filter would appear smaller. The system also should remain simple because it will become unworkable (or too bit expensive) if it becomes too complex. The present system makes these tradeoffs by using an eight VLC table set based system (further each coefficient may use its own VLC table). Eight tables are used since it allows balance between table selection overhead versus likely benefit in coding coefficients efficiently. The eight tables were constructed and chosen as a tradeoff based on heuristics and experimentation (content and bitrate/quantizer based). Thus, other numbers of tables may also operate adequately.

The specific coefficient covers in Tables 4 to 11 may be derived by collecting QR filter coefficients for a large number of video sequences, and under different bitrates and quantizer values, statistically processing them (mean, variance, histograms, and so forth) and creating collections or sets if you will, and assigning codewords to each event based on probability of occurrence. Typically, the groupings and/or sets are created sufficiently distinct so that there is some overlap between neighboring ranges, but also there should be compression gain benefit of adding every new set. Tables 4-11 generally represent some subsets of coefficients that are increasing wider in range from Table 4 to Table 9, but the trend does not necessarily continue with Tables 10-11. In reality, some of the tables were created in experiments with additional content, and were merely added later such that the size of the cover range is not in order with the other Tables. From the encoder point of view, VLC table selection point of view, compression point of view, or decoding point of view, the order of the tables is not significant.

Thus, while some of the data follows some monotonic trends, not all of it does. In fact, the issue of total and cover ranges while significant is not as important (as actually each coefficient allows full range, the ranges you see specified are the ranges in which encoding is most efficient but it handles full range by using escape codes which are a bit longer but usable) as VLC codes of different lengths may be assigned to the same coefficient in different tables. As mentioned above, the VLC code lengths depend on the frequency of occurrence of the coefficient value. The more a filter coefficient value occurs, the shorter the code the filter coefficient value is assigned by the table.

Referring to FIG. 17L, the center coefficient, C13, is predicted from the sum of all other coefficients. The center differential is most likely 0. If it is 0, the center coefficient is not coded. If, however, the center value is non-zero, an escape codeword (Esc VLC code) listed on Table 12 (FIG. 17L) is used at C12 coefficient to indicate non-zero center. Then, the actual value of the center is coded with Truncated Golomb coder, and it is coded last (so that the sum of all non-center coefficients can be computed at the decoder). Specifically, Table 12 lists the escape code that indicates that the difference between center coefficient (C13) and sum of non-center coefficients is non-zero. Further, in this case, the non-zero difference is coded together with the last non-center coefficient, such as an escape code followed by the difference of the center coefficient (C13), followed by a last non-center coefficient.

Appendix A below shows a sample portion of the ‘C’ program code that shows an example implementation of portions of Tables 4-11.

Returning again to process 500, once the coefficient coding method is computed and selected, a counter i for encoding all of the filters in a frame is set (576) to 0, and the filter coefficients of F[cIdx][i] are encoded 578 according to the selected coefficients coding (CC) method. The process 500 then adds one to i (580), and checks 582 if i>nFilt[cIdx]. If not, the process loops back to encoding operation 578 to encode the next filter. If so, for each LCU, the process 500 encodes 584 the LCU on/off flag with content adaptive binary arithmetic coding (CABAC) for component P[cIdx] to show whether or not the LCU, by component, is to be filtered.

Process 500 then may include changing 586 the component value cIdx by adding one, and determining 588 whether cIdx is more than three. If not, the process 500 loops back to operation 562 to set flags and encode the data for the next color component. If so, it is determined 590 whether the last frame (or picture (pic)) has been reached. If so, the process is ended for this video sequence. If not, P is set 592 to the next picture or frame in the picture order count (POC), and the process loops back to operation 502 to restart the process with the next frame or picture.

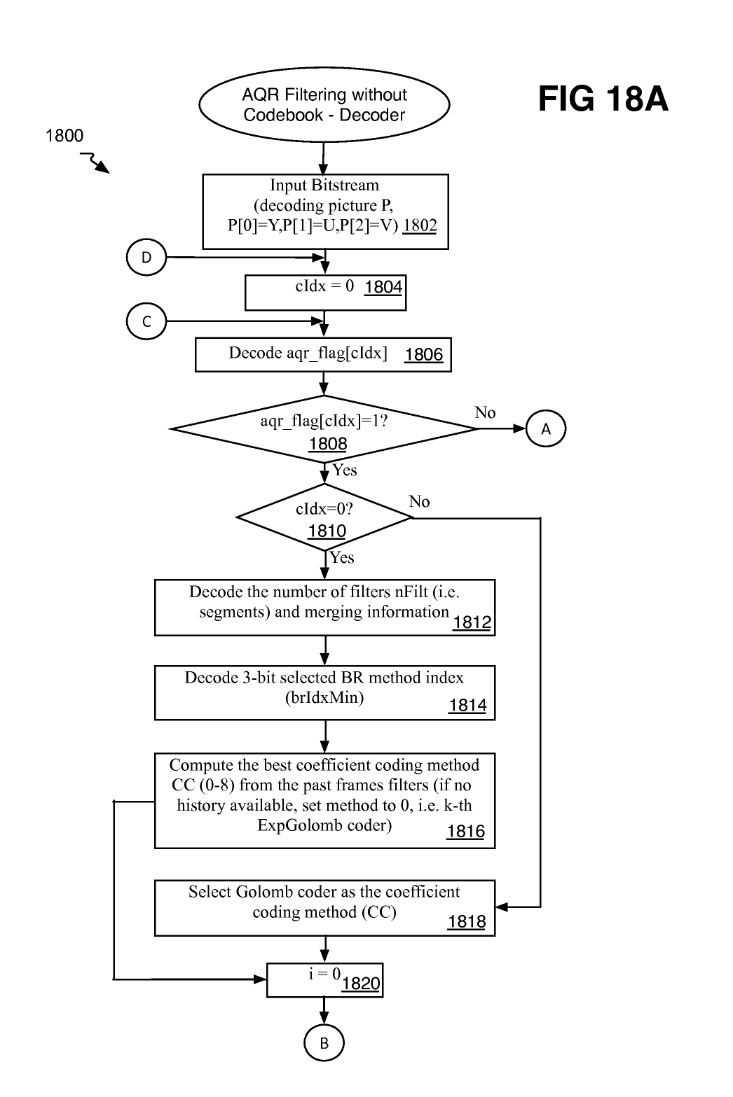

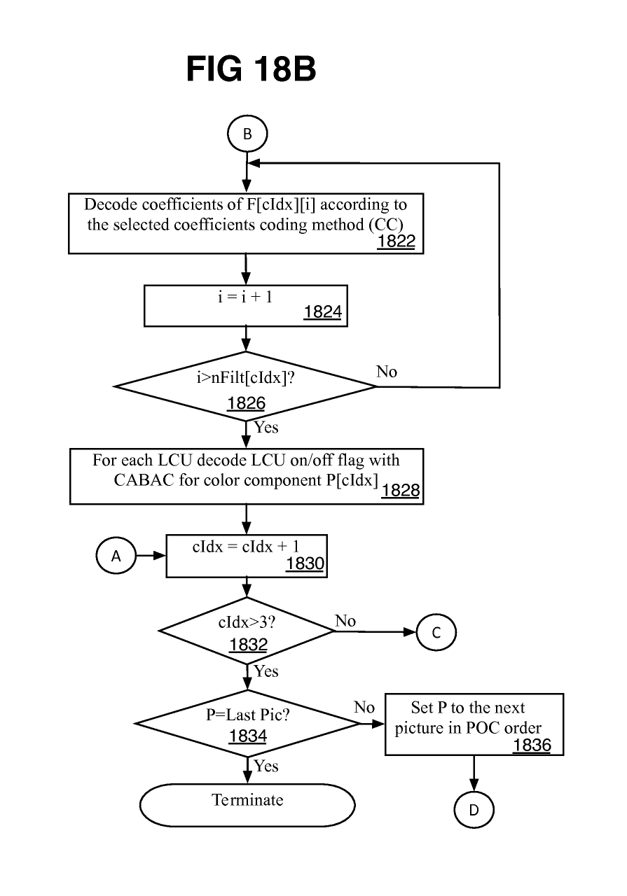

Referring to FIGS. 18A-18B, a flow chart illustrates an example AQR filtering process 1800 at a decoder and without the use of a codebook, and arranged in accordance with at least some implementations of the present disclosure. In general, process 1800 may provide another computer-implemented method for highly content adaptive quality restoration for video coding. In the illustrated implementation, process 1800 may include one or more operations, functions or actions as illustrated by one or more of operations 1802 to 1836 numbered evenly. By way of non-limiting example, process 1800 will be described herein with reference to operations discussed with respect to FIGS. 1-2 and 6-17 and may be discussed with regard to example systems 100, 200 or 2200 discussed below.

Process 1800 may include input 1802 the bitstream with picture P data where P[0]=Y, P[1]=U, and P[2]=V. Color component index counter cIdx is set (1804) to 0, the aqr_flg[cIdx] flag is decoded 1806, and checked 1808 to see if the flag equals 1 (indicating filtering is enabled for that component (Y, U, or V frame)). If not, the process moves to operation 1830 to analyze the next color component for the same frame. If so, the process 1800 checks 1810 whether cIdx=Y (luma). If not, the Golomb decoder is selected as the coefficient coding (CC) method. But if so, then the number of filters nFilt (or segments) and merging information is decoded 1812, and the 3-bit selected BR alternative combination index (brIdxMin) is decoded 1814.

By one approach, the decoder may repeat the analysis at the encoder to compute the best coefficient coding method CC (0 to 8) from the past frames filters. For instance, the decoder would compute the same frequency of selection of filter tables for say last 5 frames that is computed at the encoder, and thereby would select the same table implicitly for decoding of coefficients as used by the encoder, without having to send this information explicitly. The best coefficient coding (CC) method is computed 1816 among methods 0 to 8 explained above with the decoder. As mentioned above, if no past frame filtering history exists, the k-th ExpGolomb coder is selected, but otherwise one of the cover methods is selected. Alternatively, the identification of the VLC table itself may be explicitly included in the bitstream and used to decode the filter coefficients. This approach however incurs additional overhead due to the additional bit cost needed for explicitly sending identification of the best VLC Table to the decoder. Either way by implicitly deducing the best table to use at the decoder or by decoding from the bitstream as often as needed, identifiers of the best table used by the encoder, the filter coefficients 1822 of F[cIdx][i] can be decoded according to the selected coefficients coding (CC) method. Also, the filter counter i is set to 0 (1820).

After decoding of the filter coefficients, one is added to i (1824) and checked 1826 to determine whether i>nFilt[cIdx] (whether the least filter of the frame was analyzed). If not, the process returns to the coefficient decoding operation 1822 to decode the coefficients of the next filter. If so, for each LCU, the process 1800 decodes 1828 the LCU on/off flag with content adaptive binary arithmetic coding (CABAC) for component P[cIdx]. Then, one is added to the cIdx (1830), and checked 1832 to determine whether the cIdx is over 3. If not, the process 1800 returns to operation 1806 to analyze the next color component (U or V) frame. If so, there is a check as to whether the last picture (or frame) has been decoded 1834. If so, the process ends. If not, P is set to the next picture in the POC order and process returns to operation 1804 to decode the next picture. Once the filter coefficients are decoded, they may be used at the appropriate filters, LCUs, and component (Y, U, or V) frames to derive filtered reconstructed frames.

Below is sample pseudo code for HEVC bitstream syntax incorporating AQR filtering without a codebook.

### ACRONYMS

uvlc(v)—Unsigned VLC coding of value v

uvlc(v)—Signed VLC coding of value v

glmb(v)—Golomb coding of value v

covr(v)—Cover VLC coding of value v

tgc(v)—Truncated Golomb coding (no zero case) of value v

cbac(v)—CABAC coding of value v

| Syntax | | Description | Bits |
|---|---|---|---|
| slice_header( ) { | | | |
| . . . | | | |
| for(cIdx=0; cIdx<3; cIdx++) { | | | |
| aqr_slice_filter_flag[ cIdx ] | | AQR on/off flag for the color | 1 |
| | | component cIdx | |
| } | | | |
| . . . | | | |
| for(cIdx=0; cIdx<3; cIdx++) { | | | |
| aqr_picture_info( cIdx ) | | AQR filter information for | Var |
| | | the color component cIdx | |
| } | | | |
| . . . | | | |
| } | | | |
| aqr_picture_info( cIdx ) { | | | |
| aqr_aps_filter_flag[ cIdx ] | | AQR on/off flag for the | 1 |
| | | color component cIdx | |
| if(aqr_aps_filter_flag+ cIdx +) { | | | |
| if(cIdx==0) { | | Luma case | |
| aqr_no_filters_minus1 | | Number of AQR filters per | uvlc(v) |
| | | picture minus 1 | |
| if( aqr_no_filters_minus1==1) { | | | |
| aqr_start_second_filter | | If there are only 2 filters, | uvlc(v) |
| | | indicate 2 merged groups | |
| | | with starting location of the | |
| | | 2^{nd} filter | |
| } | | | |
| else if( aqr_no_filters_minus1 > 1) { | | | |
| for( i = 1; i <16; i++) { | | | |
| aqr_filter_pattern_flag[ cIdx ] [ i ] | | If there are more than 2 | 1 |
| | | filters, indicate with 1 bit per | |
| | | 16 groups how are groups | |
| | | merged | |
| } | | | |
| } | | | |
| aqr_rb_method | | AQR regions/blocks method | 3 |
| | | used (8 possible methods) | |
| aqr_coef_coding_meth | = | Derive best coding method | |

| | | |
|---|---|---|
| get_best_coef_meth( ) | from history (past filters): | |
| | 0=GOLOMB, 1-8=COVER | |
| | with VLC tables 1-8 | |
| for( i = 0; i < AqrNumFilters; i++) { | | |
| if ( aqr_coef_coding_meth==GOLOMB) { | | |
| for( j = 0; j < 16; j++) { | | |
| aqr_filt_coeff[ cIdx ][ i ][ j ] | The j-th filter coefficient of | glmb(v) |
| | i-th filter used in the AQR | |
| | process for the color | |
| | component cIdx, coded with | |
| | k-th ExpGolomb method | |
| } | | |
| } | | |
| else { | | |
| for( j = 0; j < 13; j++) { | | |
| if(j==12 && aqr_filt_coeff[cIdx][i][13]) | | |
| { | | |
| aqr_center_coef_esc | Escape indicating center | 8-12 |
| | coefficient (13-th) is non- | |
| | zero | |
| } | | |
| aqr_filt_coeff[ cIdx ][ i ][ j ] | The j-th filter coefficient of | covr(v) |
| | i-th filter used in the AQR | |
| | process for the color | |
| | component cIdx, coded with | |
| | cover method | |
| } | | |
| aqr_filt_coeff[ cIdx ][ i ][ 14 ] | The difference between 14- | covr(v) |
| | th and 8-th filter coefficient | |
| | of i-th filter used in the AQR | |
| | process for the color | |
| | component cIdx, coded with | |
| | cover method | |
| aqr_filt_coeff[ cIdx ][ i ][ 15 ] | The difference between 15- | covr(v) |
| | th and 6-th filter coefficient | |
| | of i-th filter used in the AQR | |
| | process for the color | |
| | component cIdx, coded with | |
| | cover method | |
| aqr_filt_coeff[ cIdx ][ i ][ 13 ] | If indicating center | tgc(v) |
| | coefficient (13-th) is non- | |
| | zero code it with Truncated | |
| | Golomb Code | |
| } | | |
| } | | |
| } | | |
| else { | Chroma case | |
| for( j = 0; j < 16; j++) { | | |
| aqr_filt_coeff[ cIdx ][ i ][ j ] | The j-th filter coefficient of | svlc(v) |
| | i-th filter used in the AQR | |
| | process for the color | |
| | component cIdx, coded with | |
| | SVLC code | |
| } | | |
| } | | |
| } | | |
| } | | |
| slice_data( ) { | | |
| . . . | | |
| for(cIdx=0; cIdx<3; cIdx++) { | | |
| for(i=0; i<SliceNumLCUs[ cIdx ]; i++) { | | |
| lcu_data(i) { | | |
| . . . | | |
| aqr_lcu_onoff_flag[ xIdx ][ i ] | LCU level AQR on/off flag | cbac(v) |
| | for i-th LCU of color | |
| | component cIdx | |
| . . . | | |
| } | | |
| } | | |
| } | | |
| . . . | | |
| } | | |

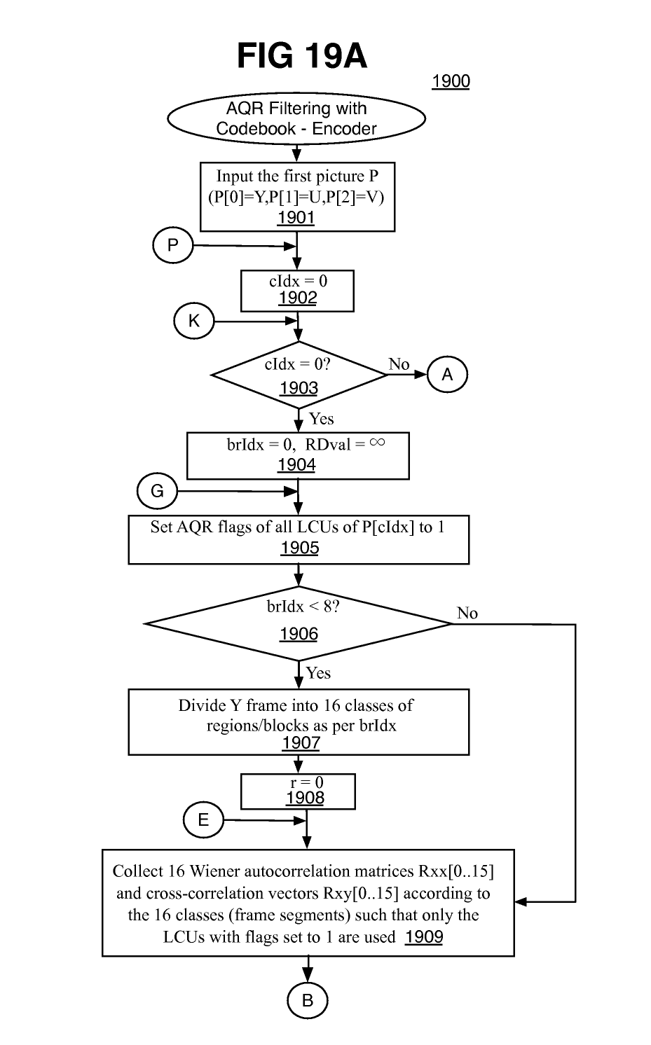

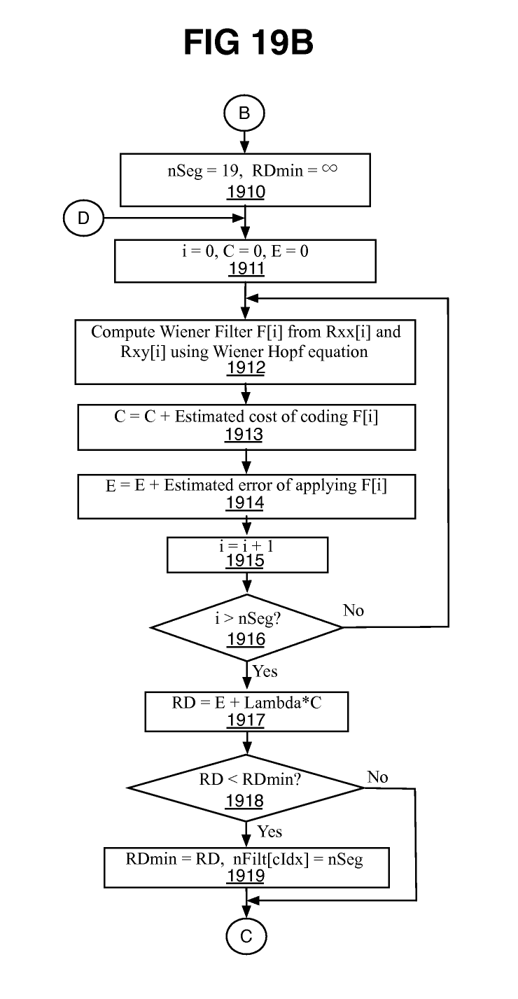

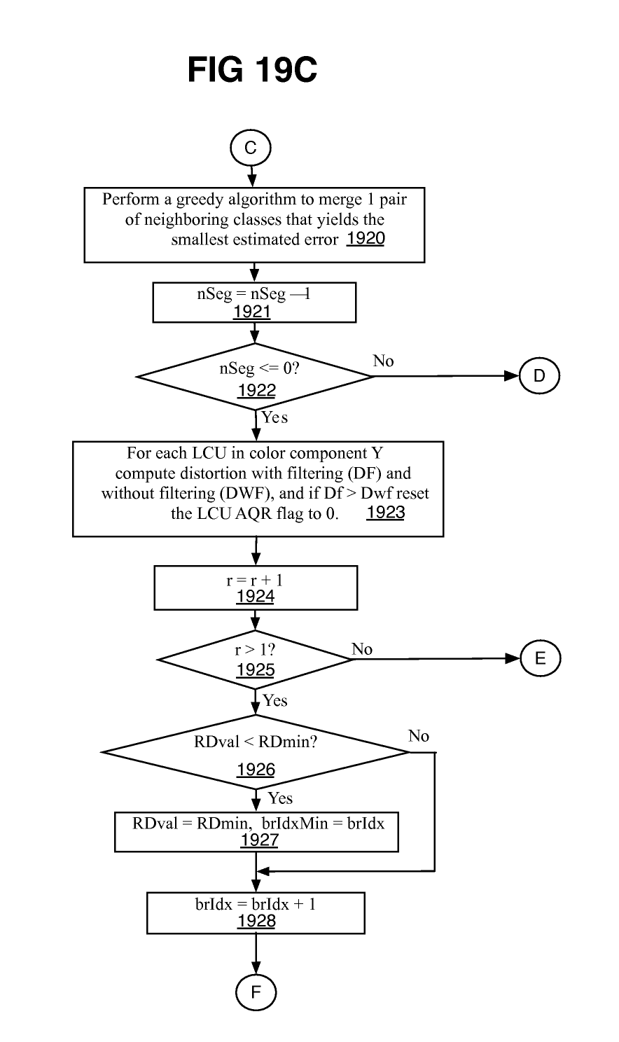

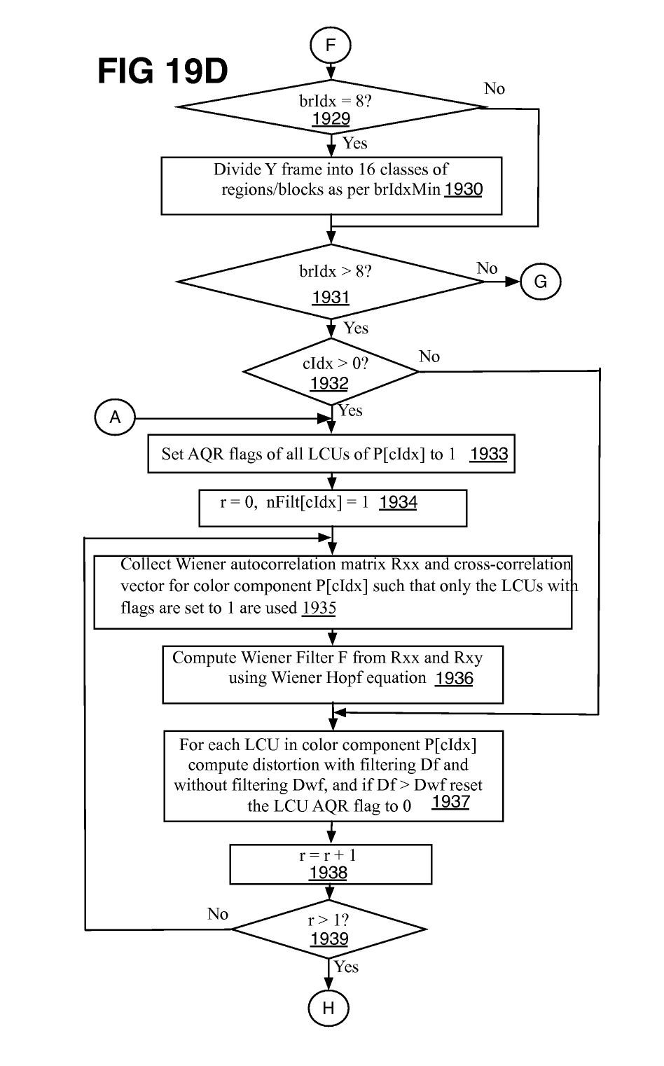

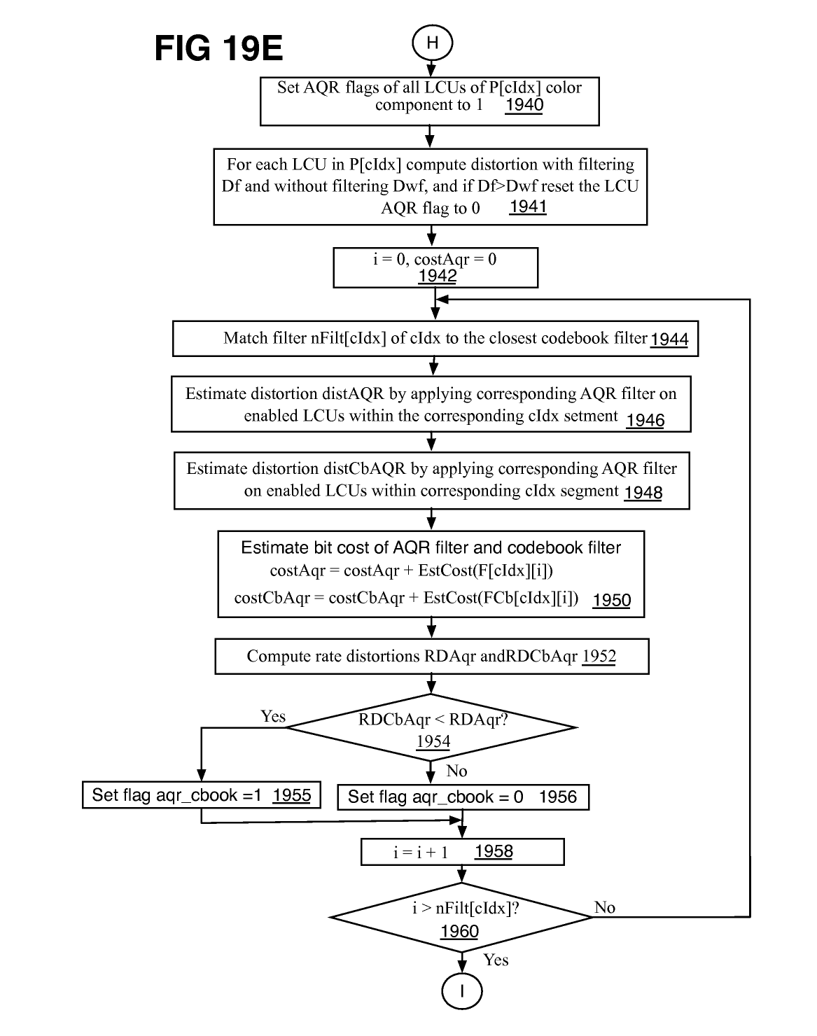

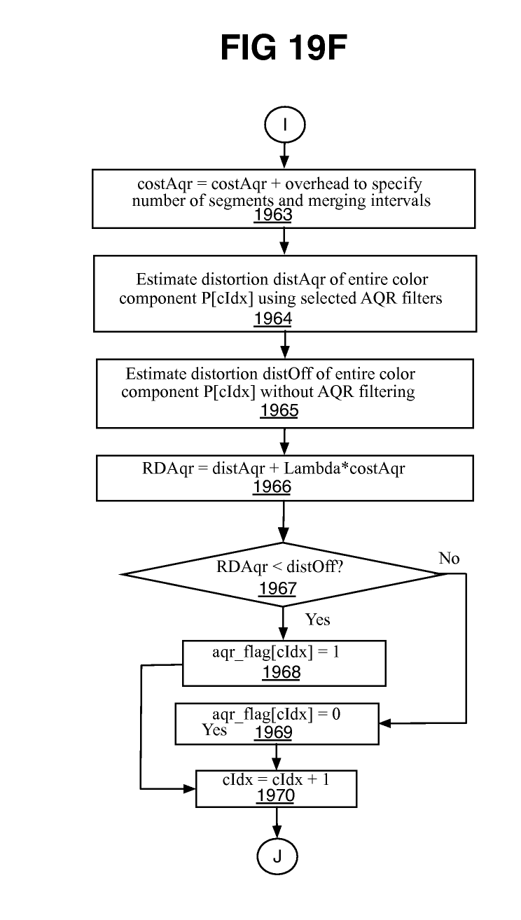

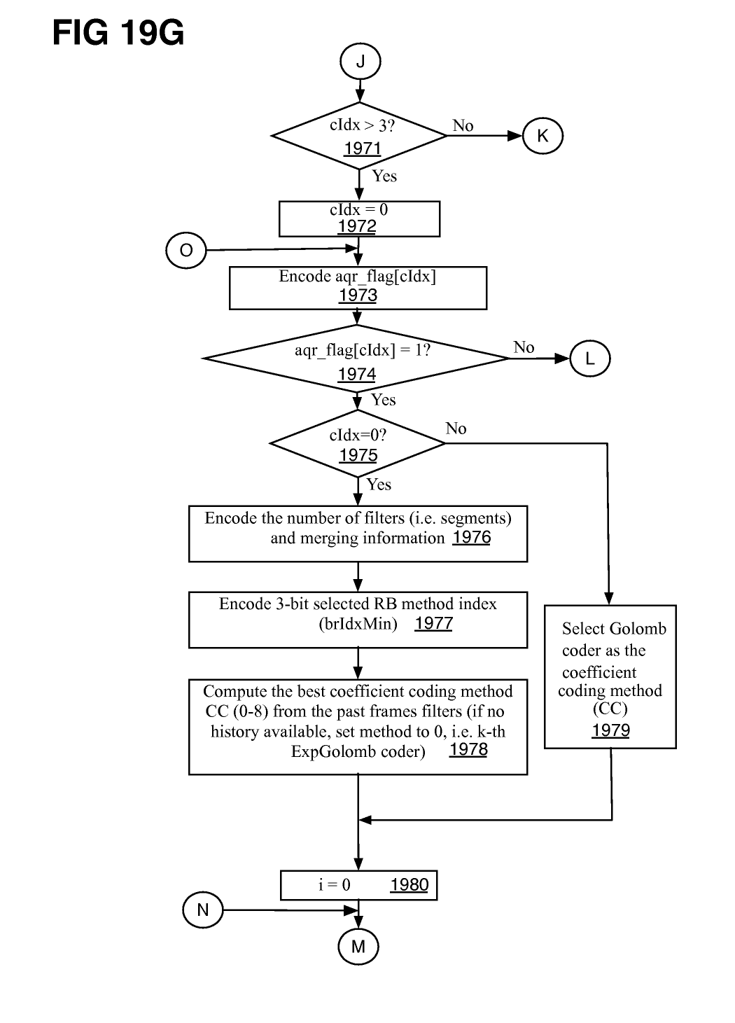

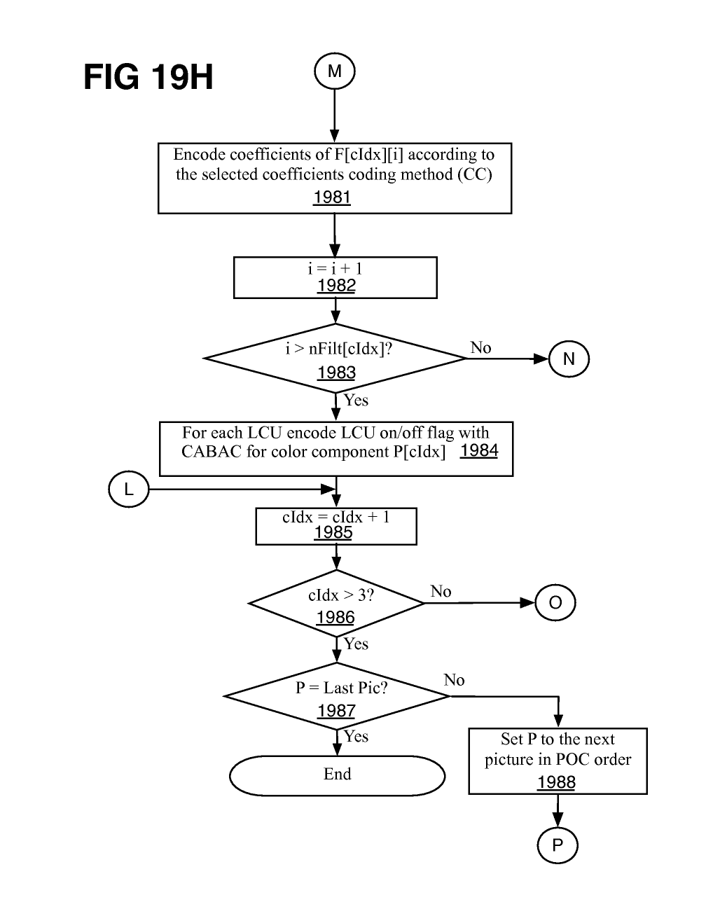

Referring to FIGS. 19A-19H, process 1900 is an example method of AQR filtering with the use of a codebook so that the filter system provides an option to transmit shorter codes to the decoder rather than the coding of the filter structure and longer filter coefficients in order to increase compression gains for the filtering. Process 1900 is arranged in accordance with at least some implementations of the present disclosure. In general, process 1900 may provide another computer-implemented method for highly content adaptive quality restoration for video coding. In the illustrated implementation, process 1900 may include one or more operations, functions or actions as illustrated by one or more of operations 1902 to 1988 numbered as shown on the FIGS. 19A-19H. By way of non-limiting example, process 1900 may be described herein with reference to operations discussed with respect to FIGS. 1-2 and 6-17, and may be discussed with regard to example systems 100, 200 or 2200 discussed below.

Process 1900 is similar to process 500 except for operations directed to the codebook described herein. Thus, codebook flags (aqr_cbook_flag) are added in addition to the AQR flags that enable the AQR filter in the first place. In light of the similarities, the operations that are similar are not described again, and process 500 should be referred to. The differing operations are as follows.

In addition to the operations of process 500 that include calculating filter coefficients for a filter, process 1900 may include operations to use a codebook of preset or predetermined filters with preset filter coefficients so that a shorter code is transmitted from encoder to decoder instead of the full filter coefficient values. In the present case, the codebook values are used in addition to the other computed processes (BR combination and merger testing), and the method (computed versus codebook) resulting in the lowest rate distortion is selected for use. Thus, by one form, the different operations explained below are added to process 500 rather than directly replace any of the operations of process 500. By other alternatives, the codebook may be the only process available of the three processes (BR combinations, merger iterations, and codebook) mentioned.

Specifically, up to operation 1942, process 1900 may be the same or similar to process 500, which has a similar operation 542 to set a counter i to 0, and a costAqr is set to 0. For operation 1942, a costAqr is similarly set to 0. For process 1900, however, the next operation may be match 1944 filter nFilt[cIdx] to the closest codebook filter. This may include a codebook search to find the best codebook filter representative. Thus, in the present case, the codebook may include multiple alternative filters with each filter comprising of a coefficient-set of 16 coefficients that correspond to a single diamond shape filter as described herein. By one-form, the codebook may include not only filters that correspond to a single diamond shape discussed herein but also other shapes as well, some of them less complex than the diamond shape, while others may have a greater complexity; these filters could be arranged as a single codebook or in the form of sub-codebooks. By one form, a codebook could also be composed of luma/chroma sub-codebooks such as one sub-codebook may contain luma (Y) filters, and other sub-codebooks may contain chroma U filters, chroma V filters, etc. By another form, a codebook may also contain different types of filters, some that are applicable to low detail areas, others applicable to textured areas, and yet others applicable to edges. These filters may be suitable for different types of content, and may be arranged implicitly as a single codebook or explicitly as separate sub-codebooks. Depending on the codebook strategy employed, search for finding best filter (coefficient-set) may be easy or hard, highly content dependent or not, bitrate efficient or not, memory intensive or not, or flexible or not. Further any codebook or sub-codebook may be implemented as lookup tables such as in ROM, or in dynamic memory such as RAM, or by other means.

Process 1900 then may include estimate 1946 distortion distAqr by applying a corresponding AQR filter on enabled LCUs within the corresponding cIdx element (or segment). The process 1900 continues with estimate 1948 distortion distCbAqr (distortion with the codebook) by applying a corresponding AQR filter on enabled LCUs within the corresponding cIdx element. The bit cost is then estimated 1950 of both the AQR filter and the codebook filter. The costAqr is calculated by adding costAqr to EstCost(F[cIdx][i]) similar to operation 543 of process 500, where EstCost(F[cIdx][i]) is the estimated cost for the filter being analyzed. Similarly, a codebook cost total costCbAqr is computed by adding costCbAqr to EstCost(FCb[cIdx][i]). Both costCbAqr and costAqr are originally set to 0.

The process 1900 includes computation 1952 of rate distortions RDAqr and RDCbAqr similar to RD calculations discussed earlier such as E+Lambda×C. A check 1954 is performed to determine whether RDCbAqr<RDAqr, and if so, a codebook flag aqr_cbook_flag is set (1955) to 1 (enabled); otherwise set (1956) to 0. This determines whether the codebook method is better than the computed method for a filter [i], and in turn the segment (or region or block classification) that corresponds to that filter.

After this codebook flag is set, operation returns to that similar to process 500. Thus, filter counter i is set (1958) to i+1, and it is determined whether i>nFilt[cIdx] (1960). If not, the next filter is analyzed and the process returns to operation 1944 to lookup the next codebook filter. If all of the filters of the frame have been analyzed, the process 1900 then continues with operation 1963, which is similar to operation 546, and the two operations continue similarly from that point onward for determining a final block-region arrangement, and then coding that arrangement as explained with process 500. One difference is that process 1900 now includes encoding a codebook index, and in one case an 8-bit codebook index in addition to encoding the number of filters and merging information (operation 1976). For practical reasons, a codebook of size 256 to 512 filters (each filter comprised of 16 coefficients) offers a reasonable compromise allowing amount of choice of filters, amount of storage for codebook, search complexity of codebook, and bits overhead to index the codebook. As an example if codebook size is 256, an 8 bit code with value in 0-255 range can index any one of 256 stored filters.

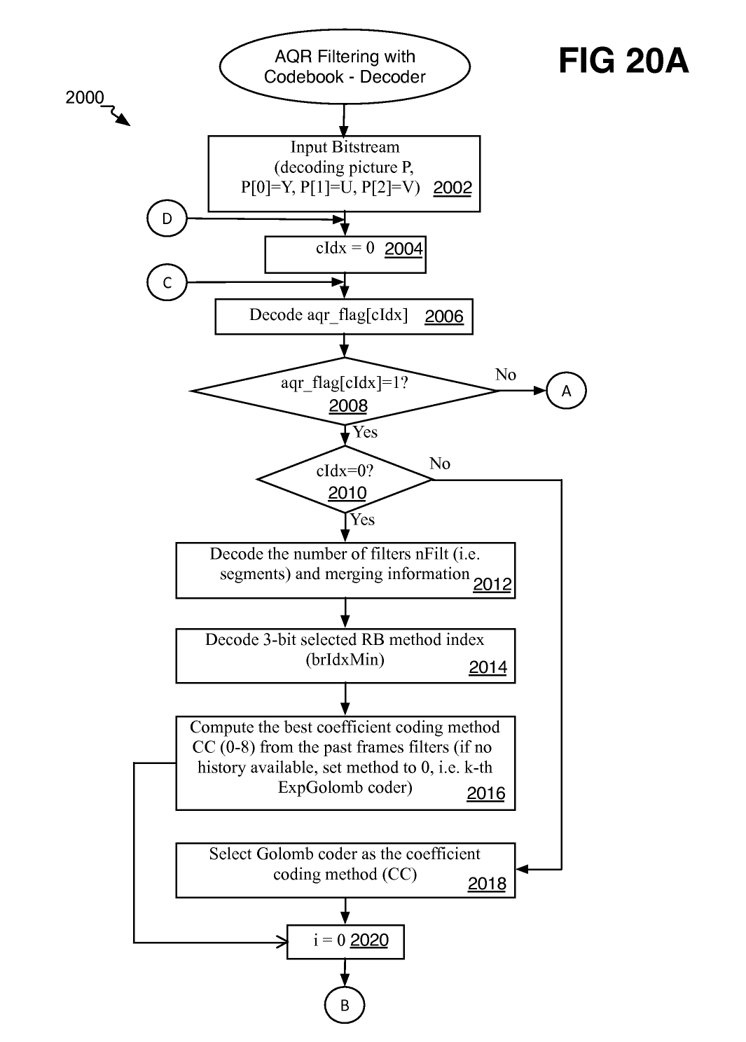

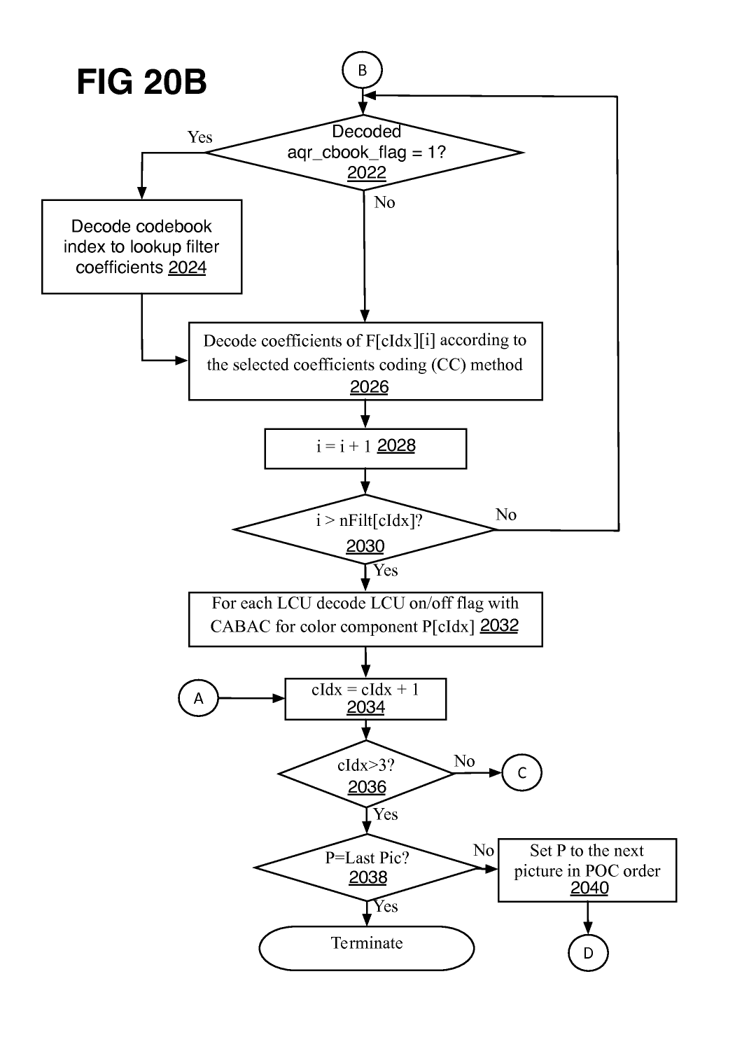

Referring to FIGS. 20A-20B, a process 2000 provides operation of a decoder for AQR filtering with a codebook. Process 2000 includes operations or functions 2002 to 2040 numbered evenly, and applies to many of the implementations described herein, including systems 100, 200, and 2200. This process 2000 is similar to process 1800 such that the similar operations are not repeated. The differing operations are as follows.

A flag aqr_flag[cIdx] is decoded (operation 2006), but this flag is similarly checked to see if filtering is enabled at all. Otherwise, decoding continues the same or similarly as without a codebook until an operation 2022 to check whether a decoded codebook flag aqr_cbook_flag is set to 1 (enabled). If so, the codebook index is decoded 2024 to lookup the filter coefficients. After this operation, whether codebook flag is set to 1 or 0, process 2000 continues with decode 2026 the coefficients of F[cIdx][i] according to the selected coefficient coding (CC) method, similar to process 1800. The decoding process 2000 then continues from there similarly to process 1800. Once the filter coefficients are decoded, they may be used at the appropriate filters, LCUs, and component (Y, U, or V) frames to derive filtered reconstructed frames.

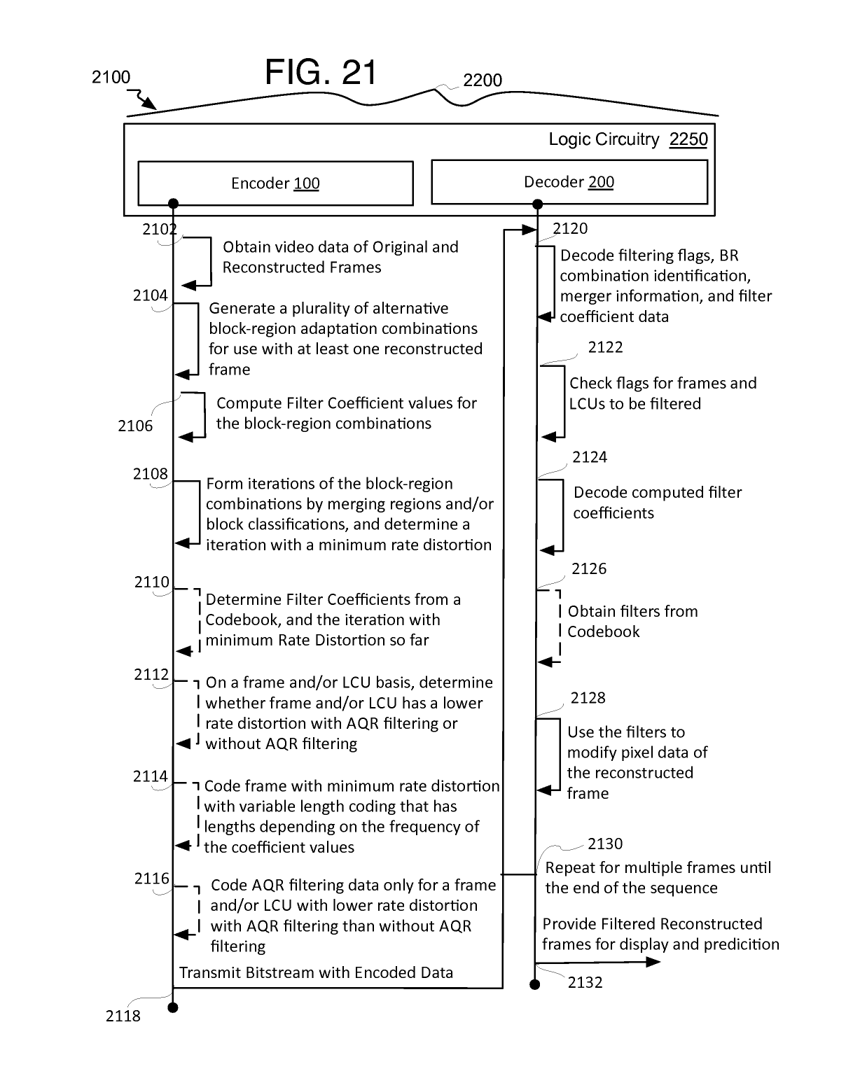

Referring now to FIG. 21, system 2200 may be used for an example AQR filtering process 2100 shown in operation, and arranged in accordance with at least some implementations of the present disclosure. In the illustrated implementation, process 2100 may include one or more operations, functions, or actions as illustrated by one or more of actions 2102 to 2126 numbered evenly, and used alternatively or in any combination. By way of non-limiting example, process 2100 will be described herein with reference to operations discussed with respect to any of the implementations described herein.

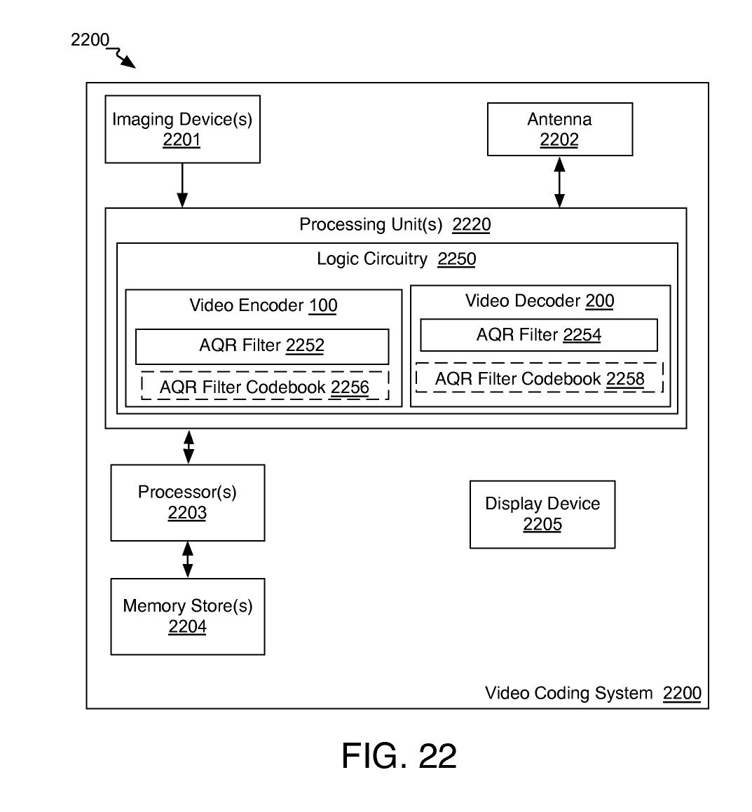

In the illustrated implementation, system 2200 may include a processing unit 2220 with logic units or logic circuitry or modules 2250, the like, and/or combinations thereof. For one example, logic circuitry or modules 2250 may include the video encoder 100 and/or the video decoder 200. Either coder or both may include the AQR filter unit 2252 or 2254 respectively, and optionally codebooks 2256 and 2258 respectively (and shown in dashed line). Although system 2200, as shown in FIG. 22, may include one particular set of operations or actions associated with particular modules, these operations or actions may be associated with different modules than the particular module illustrated here.

Process 2100 may include “obtain video data of original and reconstructed frames” 2102, where the system, or specifically the AQR filter unit, may obtain access to pixel data of reconstructed frames. These frames may or may not have already been filtered by deblocking and/or SAO filtration. The data may be obtained or read from RAM or ROM, or from another permanent or temporary memory, memory drive, or library as described on systems 2200 or 2300. The access may be continuous access for analysis of an ongoing video stream for example.

Process 2100 may include “generate a plurality of alternative block-region adaptation combinations for use with at least one reconstructed frame” 2104. As explained above, this may include using heuristics to develop a set of alternative block-region combinations such as BR1 to BR8 (frames/tables 900 to 1600 of FIGS. 9 to 16). A reconstructed frame is divided into regions, where each region is assigned a region filter, and the region filter may or may not be shared by multiple regions. One or more openings are formed on the frame where blocks of certain block classifications are assigned one or more block filters. The same BR combinations may be used for multiple reconstructed frames.

Process 2100 may include “compute filter coefficient values for the block-region combinations” 2106, and particularly to form the filter values for the BR combination being analyzed, such as explained with process 500 or 1900. By one example, a Wiener Hopf equation may be used, and the filter pattern may or may not be diamond-shaped filter 600 (FIG. 6) with holes.

Process 2100 may include “form iterations of the block-region combinations by merging regions and/or block classifications, and determine an iteration with a minimum rate distortion” 2108. As mentioned above, each BR combination may be used as an initial arrangement, and then modified to deter an arrangement with the lowest rate distortion. The arrangements may be modified by merging two of the regions and/or block classifications to share a filter with each iteration until a single region filter and single block filter are used for an entire frame. A Lagrangian equation may be used to determine rate distortion for each iteration.

Process 2100 optionally may include “determine filter coefficients from a codebook, and the iteration with the minimum rate distortion so far” 2110 (shown in dashed line). This may include using the codebook filters, with saved filter coefficients, on the BR combinations provided and while analyzing the iterations of the BR combinations. The best codebook iteration may be compared with the best computed iteration to determine the iteration with the lowest rate distortion among them.

Process 2100 then may include “on a frame and/or LCU (or other block unit) basis, determine whether the frame and/or LCU has a lower rate distortion with AQR filtering than without AQR filtering” 2112. Thus, this system may check every LCU (or other frame sub-unt) and/or frame to determine whether the AQR filtering is better than coding without the filter.

Process 2100 may continue with coding of the best iterations at LCUs and frames approved for AQR filtering. By one example, this may include “code filter coefficients of the iteration with minimum rate distortion with variable length coding that has code lengths depending on the frequency of the coefficient values” 2114. This may be in addition to coding codebook codes that indicate which filter of the codebook is to be used in a particular location in a certain frame or iteration.

Process 2100 also may continue with “code AQR filtering data only for a frame and/or LCU with a lower rate distortion with AQR filtering than without AQR filtering” 2116. Thus, AQR filtering data is not coded and transmitted for the frames or LCUs (or it may be other sizes) that have lower rate distortion without the AQR filtering thereby further lowering the bitrate load.

Process 2100 then may include “transmit bitstream with encoded data” 2118, and then have a decoder 200 “decode filtering flags, BR combination identification, merger information, and filter coefficients” 2120. Process 2100 may then continue with “check flags for frames and LCUs to be filtered” 2122, and “decode computed filter coefficients” 2124, as well as “obtain filters from the codebook” 2126 when codebook filters are provided. This may include first decoding a code such as an 8-bit code that corresponds to a particular filter in the codebook, and in turn, all of the filter coefficients and filter pattern information included with that filter.

Process 2100 may include “use the filters to modify pixel data of the reconstructed frame” 2128, and then “repeat for multiple frames until the end of a sequence” 2130. The reconstructed frames may then be provided for display and prediction 2132.

In general, process 2100 may be repeated any number of times either in serial or in parallel, as needed. Furthermore, in general, logic units or logic modules, such as that used by encoder 100 and decoder 200 may be implemented, at least in part, by hardware, software, firmware, or any combination thereof. As shown, in some implementations, encoder and decoder 100/200 may be implemented via processor(s) 2203. In other implementations, the coders 100/200 may be implemented via hardware or software implemented via one or more other central processing unit(s). In general, coders 100/200 and/or the operations discussed herein may be enabled at a system level. Some parts, however, for enabling the AQR filter, other filters in a decoding loop, and/or otherwise controlling the type of compression scheme or compression ratio used, may be provided or adjusted at a user level, for example.

While implementation of example process 300, 400, 500, 1800, 1900, 2000, or 2100 may include the undertaking of all operations shown in the order illustrated, the present disclosure is not limited in this regard and, in various examples, implementation of any of the processes herein may include the undertaking of only a subset of the operations shown and/or in a different order than illustrated.

In implementations, features described herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more processor core(s) may undertake one or more features described herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of the features described herein. As mentioned previously, in another form, a non-transitory article, such as a non-transitory computer readable medium, may be used with any of the examples mentioned above or other examples except that it does not include a transitory signal per se. It does include those elements other than a signal per se that may hold data temporarily in a “transitory” fashion such as RAM and so forth.

As used in any implementation described herein, the term “module” refers to any combination of software logic, firmware logic and/or hardware logic configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, and/or firmware that stores instructions executed by programmable circuitry. The modules may, collectively or individually, be embodied as circuitry that forms part of a larger system, for example, an integrated circuit (IC), system on-chip (SoC), and so forth. For example, a module may be embodied in logic circuitry for the implementation via software, firmware, or hardware of the coding systems discussed herein.

As used in any implementation described herein, the term “logic unit” refers to any combination of firmware logic and/or hardware logic configured to provide the functionality described herein. The “hardware”, as used in any implementation described herein, may include, for example, singly or in any combination, hardwired circuitry, programmable circuitry, state machine circuitry, and/or firmware that stores instructions executed by programmable circuitry. The logic units may, collectively or individually, be embodied as circuitry that forms part of a larger system, for example, an integrated circuit (IC), system on-chip (SoC), and so forth. For example, a logic unit may be embodied in logic circuitry for the implementation firmware or hardware of the coding systems discussed herein. One of ordinary skill in the art will appreciate that operations performed by hardware and/or firmware may alternatively be implemented via software, which may be embodied as a software package, code and/or instruction set or instructions, and also appreciate that logic unit may also utilize a portion of software to implement its functionality.

Referring to FIG. 22, an example video coding system 2200 for providing adaptive quality restoration (AQR) filtering of reconstructed frames of a video sequence may be arranged in accordance with at least some implementations of the present disclosure. In the illustrated implementation, system 2200 may include one or more central processing units or processors 2203, a display device 2205, and one or more memory stores 2204. Central processing units 2203, memory store 2204, and/or display device 2205 may be capable of communication with one another, via, for example, a bus, wires, or other access. In various implementations, display device 2205 may be integrated in system 2200 or implemented separately from system 2200.

As shown in FIG. 22, and discussed above, the processing unit 2220 may have logic circuitry 2250 with an encoder 100 and/or a decoder 200. Either or both coders may have an AQR filter 2252 or 2254, and optionally an AQR filter codebook 2256 and to provide many of the functions described herein and as explained with the processes described herein.

As will be appreciated, the modules illustrated in FIG. 22 may include a variety of software and/or hardware modules and/or modules that may be implemented via software or hardware or combinations thereof. For example, the modules may be implemented as software via processing units 2220 or the modules may be implemented via a dedicated hardware portion. Furthermore, the shown memory stores 2204 may be shared memory for processing units 2220, for example. AQR filter data may be stored on any of the options mentioned above, or may be stored on a combination of these options, or may be stored elsewhere. Also, system 2200 may be implemented in a variety of ways. For example, system 2200 (excluding display device 2205) may be implemented as a single chip or device having a graphics processor, a quad-core central processing unit, and/or a memory controller input/output (I/O) module. In other examples, system 2200 (again excluding display device 2205) may be implemented as a chipset.

Processor(s) 2203 may include any suitable implementation including, for example, microprocessor(s), multicore processors, application specific integrated circuits, chip(s), chipsets, programmable logic devices, graphics cards, integrated graphics, general purpose graphics processing unit(s), or the like. In addition, memory stores 2204 may be any type of memory such as volatile memory (e.g., Static Random Access Memory (SRAM), Dynamic Random Access Memory (DRAM), etc.) or non-volatile memory (e.g., flash memory, etc.), and so forth. In a non-limiting example, memory stores 2204 also may be implemented via cache memory. In various examples, system 2200 may be implemented as a chipset or as a system on a chip.

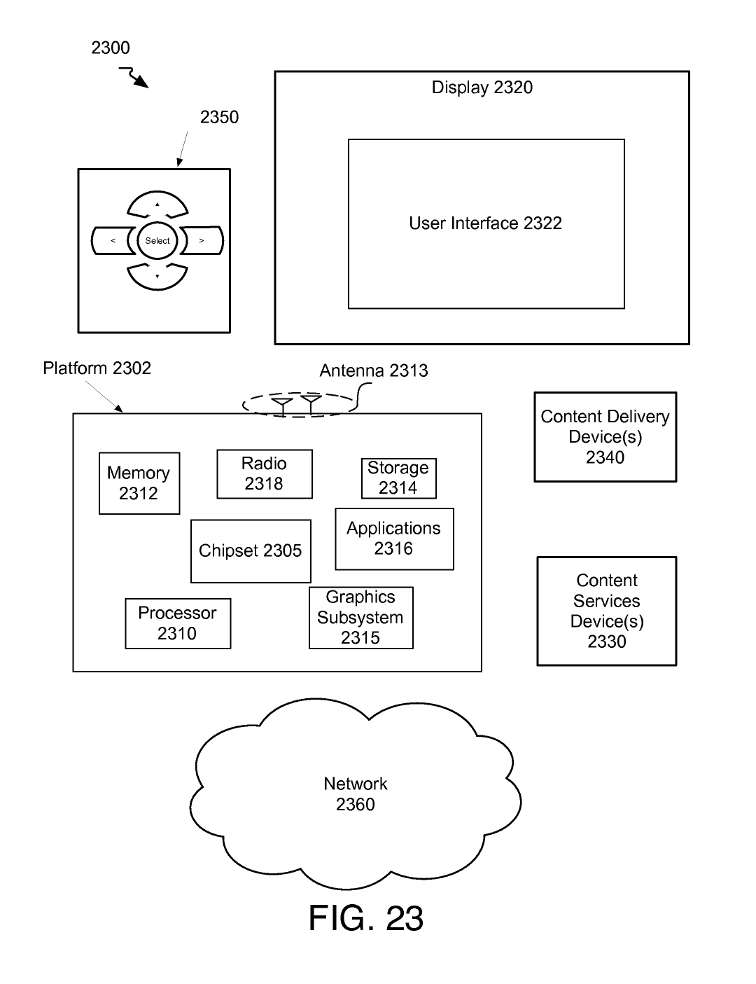

Referring to FIG. 23, an example system 2300 in accordance with the present disclosure and various implementations, may be a media system although system 2300 is not limited to this context. For example, system 2300 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In various implementations, system 2300 includes a platform 2302 communicatively coupled to a display 2320. Platform 2302 may receive content from a content device such as content services device(s) 2330 or content delivery device(s) 2340 or other similar content sources. A navigation controller 2350 including one or more navigation features may be used to interact with, for example, platform 2302 and/or display 2320. Each of these components is described in greater detail below.

In various implementations, platform 2302 may include any combination of a chipset 2305, processor 2310, memory 2312, storage 2314, graphics subsystem 2315, applications 2316 and/or radio 2318. Chipset 2305 may provide intercommunication among processor 2310, memory 2312, storage 2314, graphics subsystem 2315, applications 2316 and/or radio 2318. For example, chipset 2305 may include a storage adapter (not depicted) capable of providing intercommunication with storage 2314.

Processor 2310 may be implemented as a Complex Instruction Set Computer (CISC) or Reduced Instruction Set Computer (RISC) processors; x86 instruction set compatible processors, multi-core, or any other microprocessor or central processing unit (CPU). In various implementations, processor 2310 may be dual-core processor(s), dual-core mobile processor(s), and so forth.

Memory 2312 may be implemented as a volatile memory device such as, but not limited to, a Random Access Memory (RAM), Dynamic Random Access Memory (DRAM), or Static RAM (SRAM).

Storage 2314 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 2314 may include technology to increase the storage performance enhanced protection for valuable digital media when multiple hard drives are included, for example.

Graphics subsystem 2315 may perform processing of images such as still or video for display. Graphics subsystem 2315 may be a graphics processing unit (GPU) or a visual processing unit (VPU), for example. An analog or digital interface may be used to communicatively couple graphics subsystem 2315 and display 2320. For example, the interface may be any of a High-Definition Multimedia Interface, Display Port, wireless HDMI, and/or wireless HD compliant techniques. Graphics subsystem 2315 may be integrated into processor 2310 or chipset 2305. In some implementations, graphics subsystem 2315 may be a stand-alone card communicatively coupled to chipset 2305.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In other implementations, the functions may be implemented in a consumer electronics device.

Radio 2318 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 2318 may operate in accordance with one or more applicable standards in any version.

In various implementations, display 2320 may include any television type monitor or display. Display 2320 may include, for example, a computer display screen, touch screen display, video monitor, television-like device, and/or a television. Display 2320 may be digital and/or analog. In various implementations, display 2320 may be a holographic display. Also, display 2320 may be a transparent surface that may receive a visual projection. Such projections may convey various forms of information, images, and/or objects. For example, such projections may be a visual overlay for a mobile augmented reality (MAR) application. Under the control of one or more software applications 2316, platform 2302 may display user interface 2322 on display 2320.

In various implementations, content services device(s) 2330 may be hosted by any national, international and/or independent service and thus accessible to platform 2302 via the Internet, for example. Content services device(s) 2330 may be coupled to platform 2302 and/or to display 2320. Platform 2302 and/or content services device(s) 2330 may be coupled to a network 2360 to communicate (e.g., send and/or receive) media information to and from network 2360. Content delivery device(s) 2340 also may be coupled to platform 2302 and/or to display 2320.

In various implementations, content services device(s) 2330 may include a cable television box, personal computer, network, telephone, Internet enabled devices or appliance capable of delivering digital information and/or content, and any other similar device capable of unidirectionally or bidirectionally communicating content between content providers and platform 2302 and/display 2320, via network 2360 or directly. It will be appreciated that the content may be communicated unidirectionally and/or bidirectionally to and from any one of the components in system 2300 and a content provider via network 2360. Examples of content may include any media information including, for example, video, music, medical and gaming information, and so forth.

Content services device(s) 2330 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 2302 may receive control signals from navigation controller 2950 having one or more navigation features. The navigation features of controller 2950 may be used to interact with user interface 2922, for example. In implementations, navigation controller 2950 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 2950 may be replicated on a display (e.g., display 2920) by movements of a pointer, cursor, focus ring, or other visual indicators displayed on the display. For example, under the control of software applications 2916, the navigation features located on navigation controller 2950 may be mapped to virtual navigation features displayed on user interface 2922, for example. In implementations, controller 2950 may not be a separate component but may be integrated into platform 2902 and/or display 2920. The present disclosure, however, is not limited to the elements or in the context shown or described herein.

In various implementations, drivers (not shown) may include technology to enable users to instantly turn on and off platform 2302 like a television with the touch of a button after initial boot-up, when enabled, for example. Program logic may allow platform 2302 to stream content to media adaptors or other content services device(s) 2330 or content delivery device(s) 2340 even when the platform is turned “off” In addition, chipset 2305 may include hardware and/or software support for 7.1 surround sound audio and/or high definition (7.1) surround sound audio, for example. Drivers may include a graphics driver for integrated graphics platforms. In implementations, the graphics driver may comprise a peripheral component interconnect (PCI) Express graphics card.

In various implementations, any one or more of the components shown in system 2300 may be integrated. For example, platform 2302 and content services device(s) 2330 may be integrated, or platform 2302 and content delivery device(s) 2340 may be integrated, or platform 2302, content services device(s) 2330, and content delivery device(s) 2340 may be integrated, for example. In various implementations, platform 2302 and display 2320 may be an integrated unit. Display 2320 and content service device(s) 2330 may be integrated, or display 2320 and content delivery device(s) 2340 may be integrated, for example. These examples are not meant to limit the present disclosure.

In various implementations, system 2300 may be implemented as a wireless system, a wired system, or a combination of both. When implemented as a wireless system, system 2300 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 2300 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 2302 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The implementations, however, are not limited to the elements or in the context shown or described in FIG. 23.

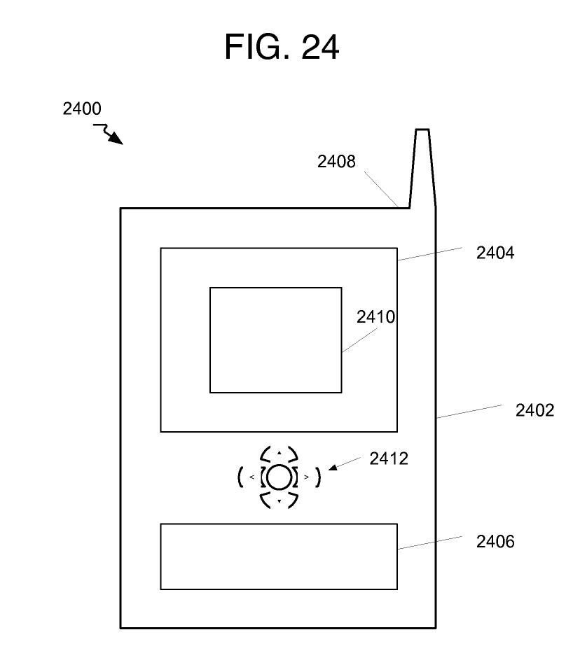

As described above, system 2200 or 2300 may be implemented in varying physical styles or form factors. FIG. 24 illustrates implementations of a small form factor device 2400 in which system 2200 or 2300 may be implemented. In implementations, for example, device 2400 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In various implementations, for example, a mobile computing device may be implemented as a smart phone capable of executing computer applications, as well as voice communications and/or data communications. Although some implementations may be described with a mobile computing device implemented as a smart phone by way of example, it may be appreciated that other implementations may be implemented using other wireless mobile computing devices as well. The implementations are not limited in this context.

As shown in FIG. 24, device 2400 may include a housing 2402, a display 2404, an input/output (I/O) device 2406, and an antenna 2408. Device 2400 also may include navigation features 2412. Display 2404 may include any suitable display unit for displaying information appropriate for a mobile computing device. I/O device 2406 may include any suitable I/O device for entering information into a mobile computing device. Examples for I/O device 2406 may include an alphanumeric keyboard, a numeric keypad, a touch pad, input keys, buttons, switches, rocker switches, microphones, speakers, voice recognition device and software, and so forth. Information also may be entered into device 2400 by way of microphone (not shown). Such information may be digitized by a voice recognition device (not shown). The implementations are not limited in this context.

Various implementations may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an implementation is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects described above may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following examples pertain to additional implementations.

A computer-implemented method of adaptive quality restoration filtering comprises: obtaining video data of reconstructed frames; generating a plurality of alternative block-region adaptation combinations for a reconstructed frame of the video data. This generating comprises: dividing a reconstructed frame into a plurality of regions, associating a region filter with each region where the region filter has a set of filter coefficients associated with pixel values within the corresponding region, classifying blocks forming the reconstructed frame and into classifications that are associated with different gradients of pixel value within a block, and associating a block filter for individual classifications and of sets of filter coefficients associated with pixel values of blocks assigned to the classification, The method also comprises using both region filters and block filters on the reconstructed frame to modify the pixel values of the reconstructed frame.

By other approaches, the method comprises using the region filters on the reconstructed frame except at openings formed at blocks on the reconstructed frame that are excluded from region filter calculations and are in one or more block classifications selected to be part of the combination, wherein the block filters are used with block data at the openings; and the method comprises modifying the block-region arrangement in the combinations by forming iterations where each iteration of a combination has a different number of: (1) block classifications that share a filter, or (2) regions that share a filter, or any combination of (1) and (2). The method may also comprise determining which iteration of a plurality of the combinations results in the lowest rate distortion for use to modify the pixel values of the reconstructed frame, wherein an initial arrangement of the combinations establish a maximum limitation as to the number of regions and block classifications that may form an iteration of the combination.

The method also comprising alternative combinations of at least one of, or both: region-based filtering being performed without block-based filtering, and block-based filtering being performed without region-based filtering. For this method, rate distortion comprises a lagangarian value associated with an error value, a constant lambda value, and a count of filter coefficient bits, wherein at least one of the combinations is limited to less than all of the available block classifications, wherein the region or block iterations are associated with a different number of filters for the entire frame and vary by increments of one between a maximum number of filters and one filter, wherein the alternative combinations include alternatives using different block sizes for the block-based filtering, wherein at least one alternative combination is based on 4×4 block analysis and at least one other alternative combination is based on 8×8 block analysis, wherein the frame is initially divided into sixteen regions that are optionally associated with up to 16 filters, and wherein up to sixteen block classifications are available to classify the blocks, wherein each alternative combination has a number of different region filters plus a number of included different block classification filters that equal a predetermined total, wherein the total is sixteen, and wherein of 16 available region filters and 16 available numbered block classifications 0 to 15 wherein the higher the classification number the higher the gradient of pixel values within a block, the plurality of combinations at least initially comprises at least one combination of: (1) 12 region filters and block classifications 12-15, (2) 8 region filters and block classifications 8-15, and (3) 4 region filters and block classifications 4-15, wherein the reconstructed frame is defined with 16 regions in a 4×4 arrangement, and wherein the region filters are numbered so each number refers to the same filter, wherein, referring to left to right and top to bottom of the rows of the reconstructed frame, the plurality of combinations at least initially comprises at least one of:

0, 1, 4, 5, 11, 2, 3, 5, 10, 9, 8, 6, 10, 7, 7, 6 for a total of 12 region filters in the 16 regions,

0, 0, 2, 2, 7, 1, 1, 3, 7, 5, 5, 3, 6, 6, 4, 4 for a total of 8 region filters in the 16 regions, and

0, 0, 0, 1, 3, 0, 1, 1, 3, 3, 2, 1, 3, 2, 2, 2 for a total of 4 region filters in the 16 regions.

The method also comprising: using a filter with a pattern of coefficients comprising symmetric coefficients, non-symmetric coefficients, and holes without a coefficient and being adjacent coefficient locations above, below, right, and left of the hole location, wherein the filter has 19 coefficient locations including 10 unique coefficients, wherein the filter is a diamond shape with a 9×9 cross, a 3×3 rectangle, and three coefficient locations forming the diagonal edges of the filter, and locating the holes between the diagonal edges and the cross and rectangle; encoding or decoding codebook values that correspond to pre-stored filters having pre-stored filter coefficient values instead of encoding or decoding filter coefficient values; encoding the filter coefficients comprising adaptively selecting at least one of a plurality of variable length coding tables having codes that are shorter the more often a value is used for a filter coefficient, wherein the codes of the same coefficient value change depending on which filter coefficient position of the same filter is being coded, comprising using cover coding comprising coding a single code when a filter coefficient value falls within a cover range of values for a filter coefficient position, and coding an escape code and a truncated golomb code when the filter coefficient value falls outside of the cover range of values for the filter coefficient position; and selecting the VLC table that results in the least number of bits relative to the results from the other tables.

A system comprises a display; a memory; at least one processor communicatively coupled to the memory and display, and being arranged to perform: obtaining video data of reconstructed frames; generating a plurality of alternative block-region adaptation combinations for a reconstructed frame of the video data comprising: dividing a reconstructed frame into a plurality of regions, associating a region filter with each region wherein the region filter has a set of filter coefficients associated with pixel values within the corresponding region, classifying blocks forming the reconstructed frame and into classifications that are associated with different gradients of pixel value within a block, associating a block filter for individual classifications and of sets of filter coefficients associated with pixel values of blocks assigned to the classification; and using both region filters and block filters on the reconstructed frame to modify the pixel values of the reconstructed frame.

By other approaches for this system, the processor may be arranged also to perform using the region filters on the reconstructed frame except at openings formed at blocks on the reconstructed frame that are excluded from region filter calculations and are in one or more block classifications selected to be part of the combination, wherein the block filters are used with block data at the openings; and to perform modifying the block-region arrangement in the combinations by forming iterations where each iteration of a combination has a different number of: (1) block classifications that share a filter, or (2) regions that share a filter, or any combination of (1) and (2). The system to perform determining which iteration of a plurality of the combinations results in the lowest rate distortion for use to modify the pixel values of the reconstructed frame, wherein an initial arrangement of the combinations establish a maximum limitation as to the number of regions and block classifications that may form an iteration of the combination.

The system also comprising alternative combinations of at least one of, or both: region-based filtering being performed without block-based filtering, and block-based filtering being performed without region-based filtering. For this system, rate distortion comprises a lagangarian value associated with an error value, a constant lambda value, and a count of filter coefficient bits, wherein at least one of the combinations is limited to less than all of the available block classifications, wherein the region or block iterations are associated with a different number of filters for the entire frame and vary by increments of one between a maximum number of filters and one filter, wherein the alternative combinations include alternatives using different block sizes for the block-based filtering, wherein at least one alternative combination is based on 4×4 block analysis and at least one other alternative combination is based on 8×8 block analysis, wherein the frame is initially divided into sixteen regions that are optionally associated with up to 16 filters, and wherein up to sixteen block classifications are available to classify the blocks, wherein each alternative combination has a number of different region filters plus a number of included different block classification filters that equal a predetermined total, wherein the total is sixteen, and wherein of 16 available region filters and 16 available numbered block classifications 0 to 15 wherein the higher the classification number the higher the gradient of pixel values within a block, the plurality of combinations at least initially comprises at least one combination of: (1) 12 region filters and block classifications 12-15, (2) 8 region filters and block classifications 8-15, and (3) 4 region filters and block classifications 4-15, wherein the reconstructed frame is defined with 16 regions in a 4×4 arrangement, and wherein the region filters are numbered so each number refers to the same filter, wherein, referring to left to right and top to bottom of the rows of the reconstructed frame, the plurality of combinations at least initially comprises at least one of:

0, 1, 4, 5, 11, 2, 3, 5, 10, 9, 8, 6, 10, 7, 7, 6 for a total of 12 region filters in the 16 regions,

0, 0, 2, 2, 7, 1, 1, 3, 7, 5, 5, 3, 6, 6, 4, 4 for a total of 8 region filters in the 16 regions, and

0, 0, 0, 1, 3, 0, 1, 1, 3, 3, 2, 1, 3, 2, 2, 2 for a total of 4 region filters in the 16 regions.

The system also having the processor(s) arranged to perform using a filter with a pattern of coefficients comprising symmetric coefficients, non-symmetric coefficients, and holes without a coefficient and being adjacent coefficient locations above, below, right, and left of the hole location, wherein the filter has 19 coefficient locations including 10 unique coefficients, wherein the filter is a diamond shape with a 9×9 cross, a 3×3 rectangle, and three coefficient locations forming the diagonal edges of the filter, and locating the holes between the diagonal edges and the cross and rectangle; encoding or decoding codebook values that correspond to pre-stored filters having pre-stored filter coefficient values instead of encoding or decoding filter coefficient values; encoding the filter coefficients comprising adaptively selecting at least one of a plurality of variable length coding tables having codes that are shorter the more often a value is used for a filter coefficient, wherein the codes of the same coefficient value change depending on which filter coefficient position of the same filter is being coded, comprising using cover coding comprising coding a single code when a filter coefficient value falls within a cover range of values for a filter coefficient position, and coding an escape code and a truncated golomb code when the filter coefficient value falls outside of the cover range of values for the filter coefficient position; and selecting the VLC table that results in the least number of bits relative to the results from the other tables.

A computer readable memory comprising instructions, that when executed by a computing device, cause the computing device to: obtain video data of reconstructed frames; generate a plurality of alternative block-region adaptation combinations for a reconstructed frame of the video data comprising: dividing a reconstructed frame into a plurality of regions, associating a region filter with each region wherein the region filter has a set of filter coefficients associated with pixel values within the corresponding region, classifying blocks forming the reconstructed frame and into classifications that are associated with different gradients of pixel value within a block, associating a block filter for individual classifications and of sets of filter coefficients associated with pixel values of blocks assigned to the classification; and use both region filters and block filters on the reconstructed frame to modify the pixel values of the reconstructed frame.

The article may also have instructions that cause the computing device to use the region filters on the reconstructed frame except at openings formed at blocks on the reconstructed frame that are excluded from region filter calculations and are in one or more block classifications selected to be part of the combination, wherein the block filters are used with block data at the openings; modify the block-region arrangement in the combinations by forming iterations where each iteration of a combination has a different number of: (1) block classifications that share a filter, or (2) regions that share a filter, or any combination of (1) and (2).

The instructions causing the computing device to determine which iteration of a plurality of the combinations results in the lowest rate distortion for use to modify the pixel values of the reconstructed frame, wherein an initial arrangement of the combinations establish a maximum limitation as to the number of regions and block classifications that may form an iteration of the combination; the combinations comprising alternatives of at least one of, or both: region-based filtering being performed without block-based filtering, and block-based filtering being performed without region-based filtering; wherein rate distortion comprises a lagangarian value associated with an error value, a constant lambda value, and a count of filter coefficient bits; wherein at least one of the combinations is limited to less than all of the available block classifications; wherein the region or block iterations are associated with a different number of filters for the entire frame and vary by increments of one between a maximum number of filters and one filter; wherein the alternative combinations include alternatives using different block sizes for the block-based filtering, wherein at least one alternative combination is based on 4×4 block analysis and at least one other alternative combination is based on 8×8 block analysis; wherein the frame is initially divided into sixteen regions that are optionally associated with up to 16 filters, and wherein up to sixteen block classifications are available to classify the blocks; wherein each alternative combination has a number of different region filters plus a number of included different block classification filters that equal a predetermined total, wherein the total is sixteen; wherein of 16 available region filters and 16 available numbered block classifications 0 to 15 wherein the higher the classification number the higher the gradient of pixel values within a block, the plurality of combinations at least initially comprises at least one combination of: (1) 12 region filters and block classifications 12-15, (2) 8 region filters and block classifications 8-15, and (3) 4 region filters and block classifications 4-15.

For the instructions, the reconstructed frame is defined with 16 regions in a 4×4 arrangement, and wherein the region filters are numbered so each number refers to the same filter, wherein, referring to left to right and top to bottom of the rows of the reconstructed frame, the plurality of combinations at least initially comprises at least one of:

0, 1, 4, 5, 11, 2, 3, 5, 10, 9, 8, 6, 10, 7, 7, 6 for a total of 12 region filters in the 16 regions,

0, 0, 2, 2, 7, 1, 1, 3, 7, 5, 5, 3, 6, 6, 4, 4 for a total of 8 region filters in the 16 regions, and

0, 0, 0, 1, 3, 0, 1, 1, 3, 3, 2, 1, 3, 2, 2, 2 for a total of 4 region filters in the 16 regions.

The instructions causing the computing device to use a filter with a pattern of coefficients comprising symmetric coefficients, non-symmetric coefficients, and holes without a coefficient and being adjacent coefficient locations above, below, right, and left of the hole location, wherein the filter has 19 coefficient locations including 10 unique coefficients, wherein the filter is a diamond shape with a 9×9 cross, a 3×3 rectangle, and three coefficient locations forming the diagonal edges of the filter, and locating the holes between the diagonal edges and the cross and rectangle; encode or decoding codebook values that correspond to pre-stored filters having pre-stored filter coefficient values instead of encoding or decoding filter coefficient values; encode the filter coefficients comprising adaptively selecting at least one of a plurality of variable length coding tables having codes that are shorter the more often a value is used for a filter coefficient, wherein the codes of the same coefficient value change depending on which filter coefficient position of the same filter is being coded, comprising using cover coding comprising coding a single code when a filter coefficient value falls within a cover range of values for a filter coefficient position, and coding an escape code and a truncated golomb code when the filter coefficient value falls outside of the cover range of values for the filter coefficient position; and select the VLC table that results in the least number of bits relative to the results from the other tables.

A coder comprises a decoding loop reconstructing frames and comprising an adaptive quality restoration filter comprising a plurality of filters each with a pattern of coefficients associated with a region of a frame, wherein at least one of the filter patterns comprises: a diamond shape symmetrical coefficients, non-symmetrical coefficients, at least one hole without a coefficient and adjacent to an above, below, left, and right coefficient, a cross shape of the coefficients having ends forming the corners of the diamond shape, a rectangle of the coefficients overlapping the cross shape, and diagonal edges formed by coefficients and forming edges of the diamond shape.

The coder may also have wherein the coefficients forming the corners of the rectangle are non-symmetrical coefficients; wherein the filter has 19 coefficient locations including 10 unique coefficients, and wherein the filter is a diamond shape with a 9×9 cross, a 3×3 rectangle, and three coefficient locations forming the diagonal edges of the filter, and locating the holes between the diagonal edges and the cross and rectangle.

The coder comprising an adaptive quality restoration filter arranged to: use the region filters on the reconstructed frame except at openings formed at blocks on the reconstructed frame that are excluded from region filter calculations and are in one or more block classifications selected to be part of the combination, wherein the block filters are used with block data at the openings; modify the block-region arrangement in the combinations by forming iterations where each iteration of a combination has a different number of: (1) block classifications that share a filter, or (2) regions that share a filter, or any combination of (1) and (2).

The filter also arranged to determine which iteration of a plurality of the combinations results in the lowest rate distortion for use to modify the pixel values of the reconstructed frame, wherein an initial arrangement of the combinations establish a maximum limitation as to the number of regions and block classifications that may form an iteration of the combination; the combinations including an alternative of at least one of, or both: region-based filtering being performed without block-based filtering, and block-based filtering being performed without region-based filtering; wherein rate distortion comprises a lagangarian value associated with an error value, a constant lambda value, and a count of filter coefficient bits; wherein at least one of the combinations is limited to less than all of the available block classifications; wherein the region or block iterations are associated with a different number of filters for the entire frame and vary by increments of one between a maximum number of filters and one filter; wherein the alternative combinations include alternatives using different block sizes for the block-based filtering, wherein at least one alternative combination is based on 4×4 block analysis and at least one other alternative combination is based on 8×8 block analysis; wherein the frame is initially divided into sixteen regions that are optionally associated with up to 16 filters, and wherein up to sixteen block classifications are available to classify the blocks; wherein each alternative combination has a number of different region filters plus a number of included different block classification filters that equal a predetermined total, wherein the total is sixteen; wherein of 16 available region filters and 16 available numbered block classifications 0 to 15 wherein the higher the classification number the higher the gradient of pixel values within a block, the plurality of combinations at least initially comprises at least one combination of: (1) 12 region filters and block classifications 12-15, (2) 8 region filters and block classifications 8-15, and (3) 4 region filters and block classifications 4-15.

Also for the filter, the reconstructed frame is defined with 16 regions in a 4×4 arrangement, and wherein the region filters are numbered so each number refers to the same filter, wherein, referring to left to right and top to bottom of the rows of the reconstructed frame, the plurality of combinations at least initially comprises at least one of:

0, 1, 4, 5, 11, 2, 3, 5, 10, 9, 8, 6, 10, 7, 7, 6 for a total of 12 region filters in the 16 regions,

0, 0, 2, 2, 7, 1, 1, 3, 7, 5, 5, 3, 6, 6, 4, 4 for a total of 8 region filters in the 16 regions, and

0, 0, 0, 1, 3, 0, 1, 1, 3, 3, 2, 1, 3, 2, 2, 2 for a total of 4 region filters in the 16 regions.

The coder also arranged to encode or decode codebook values that correspond to pre-stored filters having pre-stored filter coefficient values instead of encoding or decoding filter coefficient values; encode the filter coefficients comprising adaptively selecting at least one of a plurality of variable length coding tables having codes that are shorter the more often a value is used for a filter coefficient, wherein the codes of the same coefficient value change depending on which filter coefficient position of the same filter is being coded, comprising using cover coding comprising coding a single code when a filter coefficient value falls within a cover range of values for a filter coefficient position, and coding an escape code and a truncated golomb code when the filter coefficient value falls outside of the cover range of values for the filter coefficient position; and select the VLC table that results in the least number of bits relative to the results from the other tables.

In another example, at least one machine readable medium may include a plurality of instructions that in response to being executed on a computing device, cause the computing device to perform the method according to any one of the above examples.

In yet another example, an apparatus may include means for performing the methods according to any one of the above examples.

The above examples may include specific combination of features. However, the above examples are not limited in this regard and, in various implementations, the above examples may include undertaking only a subset of such features, undertaking a different order of such features, undertaking a different combination of such features, and/or undertaking additional features than those features explicitly listed. For example, all features described with respect to the example methods may be implemented with respect to the example apparatus, the example systems, and/or the example articles, and vice versa.

APPENDIX A
Sample C programming language for formation of the cover VLC coding tables:

(VLC_TAB_1 refers to VLC Table 4 (FIGS. 17D-1 and 17D-2).
////////////////////////////////////////////////////////////////
//VLC Tables for Cover QR Coding
////////////////////////////////////////////////////////////////
//VLC_TAB_1
char *vlc1_c0 [ ] = {
″1100000000″,″11000001″,″1100001″,″11001″,″1000″,″111″,″00″,″01″,″101″,″1001″,
″1101″,″110001″,″110000001″,″1100000001″ };
int vlc1_lens_c0 [ ] = { 10,8,7,5,4,3,2,2,3,4,4,6,9,10 };
int k1_lo_c0 = −6, k1_hi_c0 = 6;
char *vlc1_c1 [ ] = {
″0000000000″,″0000000001″,″000000001″,″00000001″,″0000001″,″000011″,″0001″,″01″,
″1″,″001″,″000001″,″0000101″,″00001000″,″00001001″ };
int vlc1_lens_c1 [ ] = { 10,10,9,8,7,6,4,2,1, 3,6,7,8,8 };
int k1_lo_c1 = −8, k1_hi_c1 = 4;
char *vlc1_c2 [ ] =
″00000000010″,″000000001″,″00000001″,″1000010″,″110000″,″110001″,″010000″,″000001″,
″10001″,″1101″,″0101″,″0001″,″111″,″011″,″001″,″101″,″1001″,″00001″,″01001″,
″11001″,″010001″,″0000001″,″1000001″,″1000011″,″10000001″,″100000000″,″00000000000″,
″00000000001″,″00000000011″,″100000001″ };
int vlc1_lens_c2 [ ] = {
11,9,8,7,6,6,6,6,5,4,4,4,3,3,3,3,4,5,5,5,6,7,7,7,8,9,11,11,11,9 };
int k1_lo_c2 = −15, k1_hi_c2 = 13;
char *vlc1_c3 [ ] = {
″00001001000″,″0000100101″,″000010011″,″000010001″,″000000000″,″0000101″,″000011″,
″001″,″1″,″01″,″0001″,″000001″,″0000001″,″00000001″,″000000001″,″0000100000″,
″00001001001″,″0000100001″ };
int vlc1_lens_c3[ ] = { 11,10,9,9,9,7,6,3,1,2,4,6,7,8,9,10,11,10 };
int k1_lo_c3 = −8, k1_hi_c3 = 8;
char *vlc1_c4 [ ] = {
″000000000000″,″000000000001″,″10000000000″,″1000000001″,″0010000100″,″0000000001″,
″001000000″,″001000001″,″10000001″,″00001000″,″00000001″,″0010001″,″0000101″,
″100100″,″100001″,″000011″,″000001″,″10001″,″00101″,″0011″,″0001″,″101″,
″111″,″0100″,″0101″,″0111″,″1100″,″1101″,″01101″,″10011″,″001001″,″011001″,″100101″,
″0000001″,″0110000″,″0110001″,″1000001″,″00001001″,″000000001″,″001000011″,
″100000001″,″0010000101″,″10000000001″,″00000000001″ };
int vlc1_lens_c4 [ ] = {
12,12,11,10,10,10,9,9,8,8,8,7,7,6,6,6,6,5,5,4,4,3,3,4,4,4,4,4,5,5,6,6,6,7,7,7,7,8,9,9,9,10,11,11 };
intk1_lo_c4 = −19, k1_hi_c4 = 23;
char *vlc1_c5 [ ] = {
″00000010010″,″00000010011″,″00000010000″,″0000100100″,″000010000″,″000010001″,
″00000011″,″00000000″,″0000101″,″000011″,″000001″,″0001″,″01″,″1″,″001″,″00000001″,
″000000101″,″00000010001″,″0000100101″,″000010011″ };
int vlc1_lens_c5 [ ] = { 11,11,11,10,9,9,8,8,7,6,6,4,2,1,3,8,9,11,10,9 };
int k1_lo_c5 = −13, k1_hi_c5 = 5;
char *vlc1_c6 [ ] = {
″00000000010″,″00000000011″,″100000011″,″000000001″,″10000101″,″00001001″,
″1000001″,″0000001″,″000011″,″10001″,″1001″,″101″,″11″,″01″,″001″,″0001″,″000001″,
″0000101″,″1000011″,″000010000″,″000010001″,″100001001″,″1000000010″,″1000000011″,
″1000000001″,″1000010000″,″1000010001″,″00000000000″,″00000000001″,
″10000000000″,″10000000001″,″10000001010″,″10000001011″,″10000001000″,″10000001001″,
″00000001″ };
int vlc1_lens_c6 [ ] = {
11,11,9,9,8,8,7,7,6,5,4,3,2,2,3,4,6,7,7,9,9,9,10,10,10,10,10,11,11,11,11,11,11,
11,11,8 };
int k1_lo_c6 = −13, k1_hi_c6 = 21;
char *vlc1_c7 [ ] = {
″00010000100″,″00010000101″,″1101000000″,″110100001″,″001101010″,″001100100″,
″11010001″,″00110000″,″00010001″,″1010110″,″1000100″,″1000101″,″0110001″,″111000″,
″111001″,″100011″,″010000″,″11011″,″11000″,″01101″,″00111″,″00100″,″00011″,
″00000″,″00001″,″1111″,″1011″,″0111″,″0101″,″1001″,″00101″,″01001″,″11001″,
″11101″,″010001″,″011001″,″101000″,″101001″,″0001010″,″0001011″,″0001001″,″011011″,
″1000001″,″1000010″,″1000011″,″1010111″,″1010101″,″1101001″,″00110011″,
″10000001″,″01100000″,″01100001″,″10101001″,″11010110″,″11010111″,″11010100″,
″11010101″,″001100101″,″001101011″,″001101000″,″001101001″,″101010000″,″100000001″,
″101010001″,″0001000011″,″0001000001″,″1101000001″,″00010000000″,″00010000001″,
″1000000001″,″10000000000″,″10000000001″,″00110001″ };
int vlc1_lens_c7 [ ] = {
11,11,10,9,9,9,8,8,8,7,7,7,7,6,6,6,6,5,5,5,5,5,5,5,5,4,4,4,4,4,5,5,5,5,6,6,6,
6,7,7,7,7,7,7,7,7,7,7,8,8,8,8,8,8,8,8,8,9,9,9,9,9,9,9,10,10,10,11,11,10,11,11,8 };
int k1_lo_c7 = −31, k1_hi_c7 = 40;
char *vlc1_c8 [ ] = {
″10001000000″,″00010001000″,″1000100010″,″1000100011″,″1000100001″,″0001000110″,
″0001000111″,″0001000101″,″0001000000″,″000100001″,″000000100″,″000000000″ ,
″10001001″,″10000000″,″10000001″,″00000011″,″00000001″,″1000001″,″0001001″,″100011″,
″100001″,″000001″,″00011″,″1001″,″101″,″11″,″01″,″001″,″00001″,″000101″,
″1000101″,″000000101″,″0001000001″,″00010001001″,″10001000001″,″000000001″ };
int vlc1_lens_c8 [ ] = {
11,11,10,10,10,10,10,10,10,9,9,9,8,8,8,8,8,7,7,6,6,6,5,4,3,2,2,3,5,6,7,9,10,11,11,9 };
int k1_lo_c8 = −26, k1_hi_c8 = 8;
char *vlc1 c9 [ ] = {
″00011000000″,″0001100001″,″00011001″,″000111″,″000100″,″00000″,″100″,″11″,″01″,
″001″,″101″,″00001″,″000101″,″0001101″,″000110001″,″00011000001″ };
int vlc1_lens_c9 [ ] = { 11,10,8,6,6,5,3,2,2,3,3,5,6,7,9,11 };
int k1_lo_c9 = −7, k1_hi_c9 = 7;
char *vlc1_c10 [ ] = {
″11000100000″,″1100010010″,″010000000″,″000000001″,″01000001″,″00000001″,″0000001″,
″010001″,″000001″,″01001″,″00001″,″0111″,″0101″,″0011″,″100″,″101″,″111″,
″0001″,″1101″,″00101″,″01101″,″11001″,″001001″,″011000″,″011001″,″0010001″,
″1100000″,″1100001″,″1100011″,″00100001″,″01000010″,″01000011″,″010000001″,
″001000000″,″001000001″,″0000000000″,″1100010001″,″0000000001″,″1100010011″,
″11000100001″,″11000101″ };
int vlc1_lens_c10 [ ] = {
11,10,9,9,8,8,7,6,6,5,5,4,4,4,3,3,3,4,4,5,5,5,6,6,6,7,7,7,7,8,8,8,9,9,9,10,10,10,10,11,8 };
int k1_lo_c10 = −17, k1_hi_c10 = 22;
char *vlc1_c11 [ ] = {
″10010000000″,″1001000001″,″111001001″,″111000000″,″001000000″,″10010001″,
″00100001″,″00000000″,″1110011″,″0010001″,″0000001″,″110000″,″100000″,″001001″,
″11101″,″10001″,″1111″,″0001″,″0110″,″0111″,″0100″,″0101″,″0011″,″1010″,″1011″,
″1101″,″00001″,″00101″,″10011″,″11001″,″000001″,″100001″,″100101″,″110001″,
″1001001″,″1110001″,″00000001″,″11100001″,″001000001″,″100100001″,″111000001″,
″10010000001″,″1110010000″,″1110010001″,″11100101″ };
int vlc1_lens_c11 [ ] = {
11,10,9,9,9,8,8,8,7,7,7,6,6,6,5,5,4,4,4,4,4,4,4,4,4,4,5,5,5,5,6,6,6,6,7,7,8,8,9,9,9,11,10,10,8 };
int k1_lo_c11 = 17, k1_hi_c11 = 26;
char *vlc1_c12 [ ] = {
″010001001000″,″01000100101″,″01000100000″,″01000100001″,″1001000000″,″1001000001″,
″011100000″,″011100001″,″011101010″,″10010001″,″01000101″,″01000000″,″1000000″,
″0111001″,″0100011″,″110001″,″100001″,″010111″,″010100″,″11001″,″10011″,
″10001″,″01100″,″01101″,″00111″,″00100″,″00000″,″00001″,″1110″,″1111″,″1101″,
″1011″,″00010″,″00011″,″00101″,″01001″,″01111″,″10101″,″001101″,″010101″,
″101000″,″101001″,″0011001″,″0100001″,″0101100″,″0101101″,″1000001″,″0111011″,
″1001001″,″00110001″,″1100001″,″01000001″,″01110001″,″10010111″,″10010101″,
″11000000″,″11000001″,″011101011″,″011101000″,″011101001″,″100101000″,″100101001″,
″100100001″,″0100010011″,″0100010001″,″1001011000″,″1001011001″,″00110000000″,
″00110000001″,″00110000011″,″10010110110″,″10010110111″,″10010110100″,
″10010110101″,″001100000100″,″001100000101″,″001100001″ };
int vlc1_lens_c12 [ ] = {
12,11,11,11,10,10,9,9,9,8,8,8,7,7,7,6,6,6,6,5,5,5,5,5,5,5,5,5,4,4,4,4,5,5,5,5,
5,5,6,6,6,6,7,7,7,7,7,7,7,8,7,8,8,8,8,8,8,9,9,9,9,9,9,10,10,10,10,11,11,11,11,11,11,11,12,12,9 };
int k1_lo_c12 = −35, k1_hi_c12 = 40;
char *vlc1_c14 [ ] = {
″1100000010″,″1100000000″,″100000000″,″10000001″,″1000001″,″100001″,″10001″,
″1001″,″101″,″000″,″01″,″001″,″111″,″1101″,″11001″,″110001″,″1100001″,″11000001″,
″1100000001″,″1100000011″,″100000001″ };
int vlc1_lens_c14 [ ] = { 10,10,9,8,7,6,5,4,3,3,2,3,3,4,5,6,7,8,10,10,9 };
int k1_lo_c14 = −10, k1_hi_c14 = 9;
char *vlc1_c15 [ ] = {
″01000001000″,″01000001001″,″0100000101″,″010000001″,″01000010″,″0100010″,″010010″,
″01010″,″0110″,″100″,″000″,″11″,″001″,″101″,″0111″,″01011″,″010011″,″0100011″,
″01000011″,″010000011″,″0100000001″,″01000000000″,″01000000001″ };
int vlc1_lens_c15 [ ] = { 11,11,10,9,8,7,6,5,4,3,3,2,3,3,4,5,6,7,8,9,10,11,11 };
in tk1_lo_c15 = −11, k1_hi_c15 = 10;
////////////////////////////////////////////////////////////////
Coding then continues similarly for VLC_TAB_2 to VLC_TAB_8 (Tables 5 to 11)

What is claimed is:

1. A computer-implemented method of adaptive quality restoration filtering comprising:
obtaining video data of reconstructed frames;
generating a plurality of alternative block-region adaptation combinations for a reconstructed frame of the video data comprising:
dividing a reconstructed frame into a plurality of regions,
associating a region filter with each region wherein the region filter has a set of filter coefficients associated with pixel values within the corresponding region,
classifying blocks forming the reconstructed frame and into classifications that are associated with different gradients of pixel value within a block, and
associating a block filter for individual classifications and of sets of filter coefficients associated with pixel values of blocks assigned to the classification; and
using both region filters and block filters on the reconstructed frame to modify the pixel values of the reconstructed frame.

2. The method of claim 1 comprising using the region filters on the reconstructed frame except at openings formed at blocks on the reconstructed frame that are excluded from region filter calculations and are in one or more block classifications selected to be part of the combination, wherein the block filters are used with block data at the openings.

3. The method of claim 1 comprising modifying the block-region arrangement in the combinations by forming iterations where each iteration of a combination has a different number of:
(1) block classifications that share a filter, or
(2) regions that share a filter, or
any combination of (1) and (2); and
determining which iteration of a plurality of the combinations results in the lowest rate distortion for use to modify the pixel values of the reconstructed frame.

4. The method of claim 3 wherein an initial arrangement of the combinations establish a maximum limitation as to the number of regions and block classifications that may form an iteration of the combination.

5. The method of claim 1 further comprising alternative combinations of at least one of, or both:
region-based filtering being performed without block-based filtering, and
block-based filtering being performed without region-based filtering.

6. The method of claim 1 wherein rate distortion comprises a lagangarian value associated with an error value, a constant lambda value, and a count of filter coefficient bits.

7. The method of claim 1 wherein at least one of the combinations is limited to less than all of the available block classifications.

8. The method of claim 1 wherein the region or block iterations are associated with a different number of filters for the entire frame and vary by increments of one between a maximum number of filters and one filter.

9. The method of claim 1 wherein the alternative combinations include alternatives using different block sizes for the block-based filtering.

10. The method of claim 8 wherein at least one alternative combination is based on 4×4 block analysis and at least one other alternative combination is based on 8×8 block analysis.

11. The method of claim 1 wherein the frame is initially divided into sixteen regions that are optionally associated with up to 16 filters, and wherein up to sixteen block classifications are available to classify the blocks.

12. The method of claim 1 wherein each alternative combination has a number of different region filters plus a number of included different block classification filters that equal a predetermined total.

13. The method of claim 12 wherein the total is sixteen.

14. The method of claim 1 wherein of 16 available region filters and 16 available numbered block classifications 0 to 15 wherein the higher the classification number the higher the gradient of pixel values within a block, the plurality of combinations at least initially comprises at least one combination of:
12 region filters and block classifications 12-15,
8 region filters and block classifications 8-15, and
4 region filters and block classifications 4-15.

15. The method of claim 1 wherein the reconstructed frame is defined with 16 regions in a 4×4 arrangement, and wherein the region filters are numbered so each number refers to the same filter, wherein, referring to left to right and top to bottom of the rows of the reconstructed frame, the plurality of combinations at least initially comprises at least one of:
0, 1, 4, 5, 11, 2, 3, 5, 10, 9, 8, 6, 10, 7, 7, 6 for a total of 12 region filters in the 16 regions,
0, 0, 2, 2, 7, 1, 1, 3, 7, 5, 5, 3, 6, 6, 4, 4 for a total of 8 region filters in the 16 regions, and
0, 0, 0, 1, 3, 0, 1, 1, 3, 3, 2, 1, 3, 2, 2, 2 for a total of 4 region filters in the 16 regions.

16. The method of claim 1 comprising using a filter with a pattern of coefficients comprising symmetric coefficients, non-symmetric coefficients, and holes without a coefficient and being adjacent coefficient locations above, below, right, and left of the hole location.

17. The method of claim 16 wherein the filter has 19 coefficient locations including 10 unique coefficients.

18. The method of claim 16 wherein the filter is a diamond shape with a 9×9 cross, a 3×3 rectangle, and three coefficient locations forming the diagonal edges of the filter, and locating the holes between the diagonal edges and the cross and rectangle.

19. The method of claim 1 comprising encoding or decoding codebook values that correspond to pre-stored filters having pre-stored filter coefficient values instead of encoding or decoding filter coefficient values.

20. The method of claim 1 comprising encoding the filter coefficients comprising adaptively selecting at least one of a plurality of variable length coding tables having codes that are shorter the more often a value is used for a filter coefficient, wherein the codes of the same coefficient value change depending on which filter coefficient position of the same filter is being coded.

21. The method of claim 20 comprising using cover coding comprising coding a single code when a filter coefficient value falls within a cover range of values for a filter coefficient position, and coding an escape code and a truncated golomb code when the filter coefficient value falls outside of the cover range of values for the filter coefficient position.

22. The method of claim 20 comprising selecting the VLC table that results in the least number of bits relative to the results from the other tables.

23. The method of claim 1 comprising using the region filters on the reconstructed frame except at openings formed at blocks on the reconstructed frame that are excluded from region filter calculations and are in one or more block classifications selected to be part of the combination, wherein the block filters are used with block data at the openings;
the method comprising modifying the block-region arrangement in the combinations by forming iterations where each iteration of a combination has a different number of:
(1) block classifications that share a filter, or
(2) regions that share a filter, or
any combination of (1) and (2); and
determining which iteration of a plurality of the combinations results in the lowest rate distortion for use to modify the pixel values of the reconstructed frame, wherein an initial arrangement of the combinations establish a maximum limitation as to the number of regions and block classifications that may form an iteration of the combination;
the method comprising alternative combinations of at least one of, or both:
region-based filtering being performed without block-based filtering, and
block-based filtering being performed without region-based filtering;
wherein rate distortion comprises a lagangarian value associated with an error value, a constant lambda value, and a count of filter coefficient bits;
wherein at least one of the combinations is limited to less than all of the available block classifications;
wherein the region or block iterations are associated with a different number of filters for the entire frame and vary by increments of one between a maximum number of filters and one filter;
wherein the alternative combinations include alternatives using different block sizes for the block-based filtering, wherein at least one alternative combination is based on 4×4 block analysis and at least one other alternative combination is based on 8×8 block analysis;
wherein the frame is initially divided into sixteen regions that are optionally associated with up to 16 filters, and wherein up to sixteen block classifications are available to classify the blocks;
wherein each alternative combination has a number of different region filters plus a number of included different block classification filters that equal a predetermined total, wherein the total is sixteen;
wherein of 16 available region filters and 16 available numbered block classifications 0 to 15 wherein the higher the classification number the higher the gradient of pixel values within a block, the plurality of combinations at least initially comprises at least one combination of:
12 region filters and block classifications 12-15,
8 region filters and block classifications 8-15, and
4 region filters and block classifications 4-15;
wherein the reconstructed frame is defined with 16 regions in a 4×4 arrangement, and wherein the region filters are numbered so each number refers to the same filter, wherein, referring to left to right and top to bottom of the rows of the reconstructed frame, the plurality of combinations at least initially comprises at least one of:
0, 1, 4, 5, 11, 2, 3, 5, 10, 9, 8, 6, 10, 7, 7, 6 for a total of 12 region filters in the 16 regions,
0, 0, 2, 2, 7, 1, 1, 3, 7, 5, 5, 3, 6, 6, 4, 4 for a total of 8 region filters in the 16 regions, and
0, 0, 0, 1, 3, 0, 1, 1, 3, 3, 2, 1, 3, 2, 2, 2 for a total of 4 region filters in the 16 regions;
the method comprising:
using a filter with a pattern of coefficients comprising symmetric coefficients, non-symmetric coefficients, and holes without a coefficient and being adjacent coefficient locations above, below, right, and left of the hole location, wherein the filter has 19 coefficient locations including 10 unique coefficients, wherein the filter is a diamond shape with a 9×9 cross, a 3×3 rectangle, and three coefficient locations forming the diagonal edges of the filter, and locating the holes between the diagonal edges and the cross and rectangle;
encoding or decoding codebook values that correspond to pre-stored filters having pre-stored filter coefficient values instead of encoding or decoding filter coefficient values;
encoding the filter coefficients comprising adaptively selecting at least one of a plurality of variable length coding tables having codes that are shorter the more often a value is used for a filter coefficient, wherein the codes of the same coefficient value change depending on which filter coefficient position of the same filter is being coded, comprising using cover coding comprising coding a single code when a filter coefficient value falls within a cover range of values for a filter coefficient position, and coding an escape code and a truncated golomb code when the filter coefficient value falls outside of the cover range of values for the filter coefficient position; and
selecting the VLC table that results in the least number of bits relative to the results from the other tables.

24. A system comprising:
a display;
a memory;
at least one processor communicatively coupled to the memory and display, and being arranged to perform:
obtaining video data of reconstructed frames;
generating a plurality of alternative block-region adaptation combinations for a reconstructed frame of the video data comprising:
dividing a reconstructed frame into a plurality of regions,
associating a region filter with each region wherein the region filter has a set of filter coefficients associated with pixel values within the corresponding region,
classifying blocks forming the reconstructed frame and into classifications that are associated with different gradients of pixel value within a block,
associating a block filter for individual classifications and of sets of filter coefficients associated with pixel values of blocks assigned to the classification; and
using both region filters and block filters on the reconstructed frame to modify the pixel values of the reconstructed frame.

25. The system of claim 24, wherein the at least one processor further being arranged to perform:
using the region filters on the reconstructed frame except at openings formed at blocks on the reconstructed frame that are excluded from region filter calculations and are in one or more block classifications selected to be part of the combination, wherein the block filters are used with block data at the openings;
modifying the block-region arrangement in the combinations by forming iterations where each iteration of a combination has a different number of:
(1) block classifications that share a filter, or
(2) regions that share a filter, or
any combination of (1) and (2); and
determining which iteration of a plurality of the combinations results in the lowest rate distortion for use to modify the pixel values of the reconstructed frame, wherein an initial arrangement of the combinations establish a maximum limitation as to the number of regions and block classifications that may form an iteration of the combination;
the combinations comprising alternatives of at least one of, or both:
region-based filtering being performed without block-based filtering, and
block-based filtering being performed without region-based filtering;
wherein rate distortion comprises a lagangarian value associated with an error value, a constant lambda value, and a count of filter coefficient bits;
wherein at least one of the combinations is limited to less than all of the available block classifications;
wherein the region or block iterations are associated with a different number of filters for the entire frame and vary by increments of one between a maximum number of filters and one filter;
wherein the alternative combinations include alternatives using different block sizes for the block-based filtering, wherein at least one alternative combination is based on 4×4 block analysis and at least one other alternative combination is based on 8×8 block analysis;
wherein the frame is initially divided into sixteen regions that are optionally associated with up to 16 filters, and wherein up to sixteen block classifications are available to classify the blocks;
wherein each alternative combination has a number of different region filters plus a number of included different block classification filters that equal a predetermined total, wherein the total is sixteen;
wherein of 16 available region filters and 16 available numbered block classifications 0 to 15 wherein the higher the classification number the higher the gradient of pixel values within a block, the plurality of combinations at least initially comprises at least one combination of:
12 region filters and block classifications 12-15,
8 region filters and block classifications 8-15, and
4 region filters and block classifications 4-15;
wherein the reconstructed frame is defined with 16 regions in a 4×4 arrangement, and wherein the region filters are numbered so each number refers to the same filter, wherein, referring to left to right and top to bottom of the rows of the reconstructed frame, the plurality of combinations at least initially comprises at least one of:
0, 1, 4, 5, 11, 2, 3, 5, 10, 9, 8, 6, 10, 7, 7, 6 for a total of 12 region filters in the 16 regions,
0, 0, 2, 2, 7, 1, 1, 3, 7, 5, 5, 3, 6, 6, 4, 4 for a total of 8 region filters in the 16 regions, and
10, 0, 0, 1, 3, 0, 1, 1, 3, 3, 2, 1, 3, 2, 2, 2 for a total of 4 region filters in the 16 regions;
using a filter with a pattern of coefficients comprising symmetric coefficients, non-symmetric coefficients, and holes without a coefficient and being adjacent coefficient locations above, below, right, and left of the hole location, wherein the filter has 19 coefficient locations including 10 unique coefficients, wherein the filter is a diamond shape with a 9×9 cross, a 3×3 rectangle, and three coefficient locations forming the diagonal edges of the filter, and locating the holes between the diagonal edges and the cross and rectangle;
encoding or decoding codebook values that correspond to pre-stored filters having pre-stored filter coefficient values instead of encoding or decoding filter coefficient values;
encoding the filter coefficients comprising adaptively selecting at least one of a plurality of variable length coding tables having codes that are shorter the more often a value is used for a filter coefficient, wherein the codes of the same coefficient value change depending on which filter coefficient position of the same filter is being coded, comprising using cover coding comprising coding a single code when a filter coefficient value falls within a cover range of values for a filter coefficient position, and coding an escape code and a truncated golomb code when the filter coefficient value falls outside of the cover range of values for the filter coefficient position; and
selecting the VLC table that results in the least number of bits relative to the results from the other tables.

26. At least one computer readable memory comprising instructions, that when executed by a computing device, cause the computing device to:
obtain video data of reconstructed frames;
generate a plurality of alternative block-region adaptation combinations for a reconstructed frame of the video data comprising:
dividing a reconstructed frame into a plurality of regions,
associating a region filter with each region wherein the region filter has a set of filter coefficients associated with pixel values within the corresponding region,
classifying blocks forming the reconstructed frame and into classifications that are associated with different gradients of pixel value within a block,
associating a block filter for individual classifications and of sets of filter coefficients associated with pixel values of blocks assigned to the classification; and
use both region filters and block filters on the reconstructed frame to modify the pixel values of the reconstructed frame.

27. The article of claim 26, the instructions causing the computing device to:
use the region filters on the reconstructed frame except at openings formed at blocks on the reconstructed frame that are excluded from region filter calculations and are in one or more block classifications selected to be part of the combination, wherein the block filters are used with block data at the openings;
modify the block-region arrangement in the combinations by forming iterations where each iteration of a combination has a different number of:
(1) block classifications that share a filter, or
(2) regions that share a filter, or
any combination of (1) and (2); and
determine which iteration of a plurality of the combinations results in the lowest rate distortion for use to modify the pixel values of the reconstructed frame, wherein an initial arrangement of the combinations establish a maximum limitation as to the number of regions and block classifications that may form an iteration of the combination;
alternative combinations of at least one of, or both:
region-based filtering being performed without block-based filtering, and
block-based filtering being performed without region-based filtering;
wherein rate distortion comprises a lagangarian value associated with an error value, a constant lambda value, and a count of filter coefficient bits;
wherein at least one of the combinations is limited to less than all of the available block classifications;
wherein the region or block iterations are associated with a different number of filters for the entire frame and vary by increments of one between a maximum number of filters and one filter;
wherein the alternative combinations include alternatives using different block sizes for the block-based filtering, wherein at least one alternative combination is based on 4×4 block analysis and at least one other alternative combination is based on 8×8 block analysis;
wherein the frame is initially divided into sixteen regions that are optionally associated with up to 16 filters, and wherein up to sixteen block classifications are available to classify the blocks;
wherein each alternative combination has a number of different region filters plus a number of included different block classification filters that equal a predetermined total, wherein the total is sixteen;
wherein of 16 available region filters and 16 available numbered block classifications 0 to 15 wherein the higher the classification number the higher the gradient of pixel values within a block, the plurality of combinations at least initially comprises at least one combination of:
12 region filters and block classifications 12-15,
8 region filters and block classifications 8-15, and
4 region filters and block classifications 4-15;
wherein the reconstructed frame is defined with 16 regions in a 4×4 arrangement, and wherein the region filters are numbered so each number refers to the same filter, wherein, referring to left to right and top to bottom of the rows of the reconstructed frame, the plurality of combinations at least initially comprises at least one of:
0, 1, 4, 5, 11, 2, 3, 5, 10, 9, 8, 6, 10, 7, 7, 6 for a total of 12 region filters in the 16 regions,
0, 0, 2, 2, 7, 1, 1, 3, 7, 5, 5, 3, 6, 6, 4, 4 for a total of 8 region filters in the 16 regions, and
0, 0, 0, 1, 3, 0, 1, 1, 3, 3, 2, 1, 3, 2, 2, 2 for a total of 4 region filters in the 16 regions;
use a filter with a pattern of coefficients comprising symmetric coefficients, non-symmetric coefficients, and holes without a coefficient and being adjacent coefficient locations above, below, right, and left of the hole location, wherein the filter has 19 coefficient locations including 10 unique coefficients, wherein the filter is a diamond shape with a 9×9 cross, a 3×3 rectangle, and three coefficient locations forming the diagonal edges of the filter, and locating the holes between the diagonal edges and the cross and rectangle;
encode or decoding codebook values that correspond to pre-stored filters having pre-stored filter coefficient values instead of encoding or decoding filter coefficient values;
encode the filter coefficients comprising adaptively selecting at least one of a plurality of variable length coding tables having codes that are shorter the more often a value is used for a filter coefficient, wherein the codes of the same coefficient value change depending on which filter coefficient position of the same filter is being coded, comprising using cover coding comprising coding a single code when a filter coefficient value falls within a cover range of values for a filter coefficient position, and coding an escape code and a truncated golomb code when the filter coefficient value falls outside of the cover range of values for the filter coefficient position; and
select the VLC table that results in the least number of bits relative to the results from the other tables.

28. A coder comprising:
a decoding loop reconstructing frames and comprising an adaptive quality restoration filter comprising a plurality of filters each with a pattern of coefficients associated with a region of a frame, wherein at least one of the filter patterns comprises:
a diamond shape
symmetrical coefficients,
non-symmetrical coefficients,
at least one hole without a coefficient and adjacent to an above, below, left, and right coefficient,
a cross shape of the coefficients having ends forming the corners of the diamond shape,
a rectangle of the coefficients overlapping the cross shape, and
diagonal edges formed by coefficients and forming edges of the diamond shape.

29. The coder of claim 28 wherein the coefficients forming the corners of the rectangle are non-symmetrical coefficients;
wherein the filter has 19 coefficient locations including 10 unique coefficients, wherein the filter is a diamond shape with a 9×9 cross, a 3×3 rectangle, and three coefficient locations forming the diagonal edges of the filter, and locating the holes between the diagonal edges and the cross and rectangle;
the coder comprising an adaptive quality restoration filter begin arranged to:
use the region filters on the reconstructed frame except at openings formed at blocks on the reconstructed frame that are excluded from region filter calculations and are in one or more block classifications selected to be part of the combination, wherein the block filters are used with block data at the openings;
modify the block-region arrangement in the combinations by forming iterations where each iteration of a combination has a different number of:
(1) block classifications that share a filter, or
(2) regions that share a filter, or
any combination of (1) and (2); and
determine which iteration of a plurality of the combinations results in the lowest rate distortion for use to modify the pixel values of the reconstructed frame, wherein an initial arrangement of the combinations establish a maximum limitation as to the number of regions and block classifications that may form an iteration of the combination;
alternative combinations of at least one of, or both:
region-based filtering being performed without block-based filtering, and
block-based filtering being performed without region-based filtering;
wherein rate distortion comprises a lagangarian value associated with an error value, a constant lambda value, and a count of filter coefficient bits;
wherein at least one of the combinations is limited to less than all of the available block classifications;
wherein the region or block iterations are associated with a different number of filters for the entire frame and vary by increments of one between a maximum number of filters and one filter;
wherein the alternative combinations include alternatives using different block sizes for the block-based filtering, wherein at least one alternative combination is based on 4×4 block analysis and at least one other alternative combination is based on 8×8 block analysis;
wherein the frame is initially divided into sixteen regions that are optionally associated with up to 16 filters, and wherein up to sixteen block classifications are available to classify the blocks;
wherein each alternative combination has a number of different region filters plus a number of included different block classification filters that equal a predetermined total, wherein the total is sixteen;
wherein of 16 available region filters and 16 available numbered block classifications 0 to 15 wherein the higher the classification number the higher the gradient of pixel values within a block, the plurality of combinations at least initially comprises at least one combination of:
12 region filters and block classifications 12-15,
8 region filters and block classifications 8-15, and
4 region filters and block classifications 4-15;
wherein the reconstructed frame is defined with 16 regions in a 4×4 arrangement, and wherein the region filters are numbered so each number refers to the same filter, wherein, referring to left to right and top to bottom of the rows of the reconstructed frame, the plurality of combinations at least initially comprises at least one of:
0, 1, 4, 5, 11, 2, 3, 5, 10, 9, 8, 6, 10, 7, 7, 6 for a total of 12 region filters in the 16 regions,
0, 0, 2, 2, 7, 1, 1, 3, 7, 5, 5, 3, 6, 6, 4, 4 for a total of 8 region filters in the 16 regions, and
0, 0, 0, 1, 3, 0, 1, 1, 3, 3, 2, 1, 3, 2, 2, 2 for a total of 4 region filters in the 16 regions;
encode or decode codebook values that correspond to pre-stored filters having pre-stored filter coefficient values instead of encoding or decoding filter coefficient values;
encode the filter coefficients comprising adaptively selecting at least one of a plurality of variable length coding tables having codes that are shorter the more often a value is used for a filter coefficient, wherein the codes of the same coefficient value change depending on which filter coefficient position of the same filter is being coded, comprising using cover coding comprising coding a single code when a filter coefficient value falls within a cover range of values for a filter coefficient position, and coding an escape code and a truncated golomb code when the filter coefficient value falls outside of the cover range of values for the filter coefficient position; and
select the VLC table that results in the least number of bits relative to the results from the other tables.
